(19) United States
(12) Patent Application Publication
(10) Pub. No.: US 2025/0355230 A1
(43) Pub. Date: Nov. 20, 2025

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 18/872,639

(22) PCT Filed: Jun. 9, 2023
(86) PCT No.: PCT/KR2023/007962

§ 371 Date: Dec. 6, 2024

(30) Foreign Application Priority Data
Jun. 9, 2022 (KR) 10-2022-0070409
Jun. 9, 2022 (KR) 10-2022-0070411

(51) Int. Cl. G02B 13/18; G02B 9/64

(52) U.S. Cl. CPC G02B 13/18; G02B 9/64

(57) ABSTRACT

An optical system according to an embodiment of the present invention includes first to seventh lenses arranged along an optical axis, wherein the first lens has a negative (−) refractive power, the composite refractive power of the second to seventh lenses is a positive (+) power, the second lens among the first to third lenses has a smallest effective diameter, and the effective diameter of the sixth and seventh lenses are smaller than the effective diameter of the fifth lens.

### TECHNICAL FIELD

The teachings in accordance with exemplary and non-limiting embodiments of this invention relate generally to a camera module.

### BACKGROUND ART

An ADAS (Advanced Driving Assistance System) is an advanced driver assistance system that is intended to assist the driver in driving and consists of sensing the situation in front of the vehicle, making a situational judgment based on the sensed results, and controlling the behavior of the vehicle based on the situational judgment. For example, an ADAS sensor device detects a vehicle in front of it and recognizes its lane. Then, when the target lane, target speed, and target in front of the vehicle are determined, the electrical stability control (ESC), engine management system (EMS), motor-driven power steering (MDPS), etc. of the vehicle are controlled. For example, ADAS can be implemented as an automatic parking system, low-speed city driving assistance system, blind spot warning system, etc.

In ADAS, sensor devices for detecting the situation in front of the vehicle may include GPS sensors, laser scanners, forward-facing radar, Lidar, etc., and most representative device may be a camera for photographing a front, a rear and sides of the vehicle.

Such cameras may be arranged on the exterior or interior of the vehicle to detect the surrounding situation of the vehicle. Further, the cameras may be disposed inside the vehicle to detect the situation of the driver and passengers. For example, the camera may film the driver from a position adjacent to the driver, and may detect the driver's health status, whether the driver is drowsy, whether the driver is intoxicated, etc. Further, the camera may photograph the passenger from a position adjacent to the passenger and may detect whether the passenger is sleeping, in good health, or otherwise, and may provide the driver with information about the passenger.

In particular, the most important element for obtaining an image in a camera is an imaging lens that converges the image. Recently, interest in high performance, such as high definition and high resolution, is increasing, and research is being conducted on optical systems comprising a plurality of lenses to achieve such high performance. However, there is a problem that the characteristics of the optical system change when the camera is exposed to a harsh environment, such as high temperature, low temperature, moisture, high humidity, etc. outside or inside a vehicle. In this case, the camera has a problem that it is difficult to obtain excellent optical characteristics and aberration characteristics uniformly. Therefore, there is a need for a new optical system and camera that can solve the above problems.

### DETAILED DESCRIPTION OF THE INVENTION

### Technical Problems

Embodiments seek to provide optical systems and camera modules with improved optical properties.

Embodiments seek to provide optical systems and camera modules that have superior optical performance in low to high temperature environments.

Embodiments seek to provide optical systems and camera modules that can prevent or minimize changes in optical properties over a range of temperatures.

### Technical Solutions

In one general aspect of the present invention, there may be provided an optical system, comprising first to seventh lenses arranged along an optical axis wherein the first lens has a negative (−) refractive power, the composite refractive power of the second to seventh lenses is a positive (+) power, the second lens among the first to third lenses has a smallest effective diameter, and the effective diameter of the sixth and seventh lenses are smaller than the effective diameter of the fifth lens.

Preferably, but not necessarily, the second lens, the sixth lens and the seventh lens may be made of plastic, and at least one of the first lens and the third lens to the fifth lens may be made of glass.

Preferably, but not necessarily, among the first lens to the seventh lens, the third lens may have the largest effective diameter.

Preferably, but not necessarily, the second lens may have a meniscus shape that is convex towards the sensor.

Preferably, but not necessarily, the lens having the smallest absolute value of the focal length among the first lens to the seventh lens may be one of the third lens to the fifth lens.

Preferably, but not necessarily, the absolute value of the focal length of the third lens to the fifth lens may satisfy the following conditional expression.

### <Conditional Expression>

|F3|≥F4|≥|F5|(In the above Conditional Expression, F3 is the focal length of the third lens, F4 is the focal length of the fourth lens, and F5 is the focal length of the fifth lens).

In another general aspect of the present invention, there may be provided an optical system, comprising first lens to seventh lens disposed along the optical axis, wherein the first lens has a negative (−)refractive power, wherein the composite refractive power of the second lens to the seventh lens has a positive (+) refractive power, and wherein among the first lens to the seventh lens, the absolute value of the focal length of the fifth lens is the smallest and the absolute value of the focal length of the second lens is the largest.

Preferably, but not necessarily, the first lens may be made of glass, and the sixth lens and the seventh lens may be made of plastic.

Preferably, but not necessarily, the optical system may comprise a cemented lens in which a lens having a positive (+) refractive power and a lens having a negative (−) refractive power are cemented, wherein at least one of the lens disposed on the object side of the cemented lens and disposed closest to the cemented lens and the lens disposed on the sensor side of the cemented lens and disposed closest to the cemented lens may have a convex shape on both sides.

Preferably, but not necessarily, the absolute value of the radius of curvature of the sensor side surface of the cemented lens may be less than the absolute value of the radius of curvature of the object side surface of the cemented lens and greater than the absolute value of the radius of curvature of the remaining lenses.

Preferably, but not necessarily, the object side of the cemented lens may have a convex shape and the sensor side of the cemented lens may have a concave shape.

Preferably, but not necessarily, the cemented lens may comprise two lenses continuously arranged back-to-back of the third lens to the fifth lens.

In still another aspect of the present invention, there may be provided an optical system, comprising: first to seventh lenses disposed along the optical axis, wherein, among the first to seventh lenses, the absolute value of the focal length of the second lens is the largest and the absolute value of the focal length of the fifth lens is the smallest, and the ratio of the absolute values of the focal lengths of the second lens and the fifth lens may be greater than 210 times and less than 220 times.

The ratio of the absolute values of the focal lengths of the second lens and the third lens may be greater than 100 times and less than 110 times.

The absolute value of the focal length of the third lens to the fifth lens may satisfy the following Conditional Expression.

### <Conditional Expression>

|F3|≥F4|≥IF5|(In the above Conditional Expression, F3 is the focal length of the third lens, F4 is the focal length of the fourth lens, and F5 is the focal length of the fifth lens).

Preferably, but not necessarily, in the optical axis, the first lens may have the smallest thickness among the first to seventh lenses, and in the optical axis, one of the third to fifth lenses may have the largest thickness among the first to seventh lenses.

Preferably, but not necessarily, the thickness of the second lens in the optical axis may be smaller than the thickness of the third lens and the fourth lens.

Preferably, but not necessarily, among the first to seventh lenses, the absolute value of the radius of curvature of the sensor side of the sixth lens may be the largest, and the absolute value of the radius of curvature of the sensor side of the fifth lens may be the smallest.

Preferably, but not necessarily, the third lens may have a convex shape on both sides.

Preferably, but not necessarily, the first lens, the second lens, the fifth lens, and the seventh lens may have a negative (−) refractive power, and the third lens, the fourth lens, and the sixth lens may have a positive (+) refractive power.

In still further aspect of the present invention, there may be provided an optical system, comprising: a first lens to a seventh lens disposed along an optical axis, wherein the first lens has a negative (−) refractive power, wherein the composite refractive power of the second lens to the seventh lens has a positive (+) refractive power, wherein the effective diameter of the second lens is the smallest among the first lens to the third lens, and wherein the thickness of the first lens along the optical axis is greater than the thickness of the second lens.

Preferably, but not necessarily, the first lens, the second lens, the sixth lens and the seventh lens are made of plastic, and at least one of the third lens to the fifth lens may be made of glass.

Preferably, but not necessarily, the effective diameters of the sixth lens and the seventh lens may be smaller than the effective diameter of the fifth lens, and the effective diameter of the third lens may be the largest among the first lens to the seventh lens.

Preferably, but not necessarily, the second lens may have a convex meniscus shape towards the sensor.

Preferably, but not necessarily, the lens having the smallest absolute value of the focal length among the first lens to the seventh lens may be one of the third lens to the fifth lens.

Preferably, but not necessarily, the absolute value of the focal length of the third lens to the fifth lens may satisfy the following Conditional Expression.

### <Conditional Expression>

|F3|≥F4|≥|F5|(In the above Conditional Expression, F3 is the focal length of the third lens, F4 is the focal length of the fourth lens, and F5 is the focal length of the fifth lens).

In still further aspect of the present invention, there may be provided an optical system, comprising: a first lens to a seventh lens disposed along an optical axis, wherein the first lens has a negative (−) refractive power, the composite refractive power of the second lens to the seventh lens has a positive (+) refractive power, and the thickness of the first lens along the optical axis may be greater than the distance between the first lens to the second lens.

Preferably, but not necessarily, among the first lens to the seventh lens, the absolute value of the focal length of the fifth lens may be the smallest and the absolute value of the focal length of the second lens may be the largest.

Preferably, but not necessarily, the first lens, the sixth lens, and the seventh lens may be made of plastic.

Preferably, but not necessarily, the optical system may comprise a cemented lens in which a lens having a positive (+) refractive power and a lens having a negative (−) refractive power are cemented, and at least one of the lens disposed most adjacent to the cemented lens on the object side of the cemented lens and the lens disposed most adjacent to the cemented lens on the sensor side of the cemented lens may have a convex shape on both sides.

Preferably, but not necessarily, the absolute value of the radius of curvature of the sensor side of the cemented lens may be smaller than the absolute value of the radius of curvature of the object side of the cemented lens.

Preferably, but not necessarily, the rear surface of object side of the cemented lens may have a convex shape and the rear surface of sensor side of the cemented lens may have a concave shape.

In still further aspect of the present invention, there may be provided an optical system, comprising: first to seventh lenses disposed along the optical axis, wherein, among the first to seventh lenses, the absolute value of the focal length of the second lens is the largest and the absolute value of the focal length of the fifth lens is the smallest, and the ratio of the absolute values of the focal lengths of the second lens and the fifth lens may be greater than 10 times and less than 15 times.

Preferably, but not necessarily, the ratio of the absolute values of the focal lengths of the second lens and the third lens may be greater than 5 times and less than 10 times.

Preferably, but not necessarily, the absolute value of the focal length of the third lens to the fifth lens may satisfy the following Conditional Expression.

### <Conditional Expression>

$$\vert F 3 \vert \geq \vert F 4 \vert \geq \vert F 5 \vert \qquad < Conditional Expression >$$

(In the above Conditional Expression, F3 is the focal length of the the third lens, F4 is the focal length of the the fourth lens, and F5 is the focal length of the the fifth lens).

Preferably, but not necessarily, in the optical axis, the fifth lens may have the smallest thickness among the first to seventh lenses, and in the optical axis, the fourth lens may have the largest thickness among the first to seventh lenses.

Preferably, but not necessarily, the thickness of the second lens in the optical axis may be smaller than the thickness of the third lens and the fourth lens.

Preferably, but not necessarily, among the first to seventh lenses, the fifth lens may have the largest absolute value of the radius of curvature of the object side of the fifth lens and the smallest absolute value of the radius of curvature of the sensor side of the fifth lens.

Preferably, but not necessarily, the third lens may have a convex shape on both sides.

Preferably, but not necessarily, the first lens, the fifth lens, and the seventh lens may have a negative (−) refractive power, and the second lens, the third lens, the fourth lens, and the sixth lens may have a positive (+) refractive power.

### Advantageous Effect

The optical system and camera module according to exemplary embodiments of the present invention may have improved optical properties. Specifically, in an optical system according to an embodiment, a plurality of lenses may have a set thickness, refractive power, and spacing from adjacent lenses. Accordingly, the optical system and camera module according to embodiments may have improved MTF characteristics, aberration control characteristics, resolution characteristics, and the like over a set field of view range, and may have good optical performance at the periphery of the field of view.

Further, the optical system and camera module according to an embodiment may have good optical performance in a temperature range from low to high (−40° C.˜105° C.). In detail, the plurality of lenses included in the optical system may have a set material, refractive power, and refractive index. Accordingly, if the refractive index of each lens changes with a change in temperature, and the focal length of each lens changes thereby, the plastic lens and the glass lens can compensate each other. In other words, the optical system can effectively perform an allocation of refractive powers in a temperature range from low to high temperatures, and can prevent or minimize changes in optical properties in a temperature range from low to high temperatures. Thus, the optical system and camera module according to embodiments can maintain improved optical properties over a wide range of temperatures.

Furthermore, the optical system and camera module according to an embodiment can satisfy a set angle of view and achieve excellent optical properties by mixing a plastic lens and a glass lens. As a result, the optical system can provide a slimmer automotive camera module. Accordingly, the optical system and camera module may be provided in various applications and devices, and may have excellent optical properties even in harsh temperature environments, for example, when exposed to the outside of a vehicle or inside a vehicle at high temperatures in summer.

### BRIEF DESCRIPTION OF DRAWINGS

FIG. 1 is a side cross-sectional view of an optical system according to a first exemplary embodiment and a camera module thereof.

FIG. 2 is a side cross-sectional view to illustrate the relationship of the nth and n-1st lenses according to FIG. 1.

FIG. 3 is a table showing lens characteristics of the optical system of FIG. 1.

FIG. 4 is a table showing the aspheric coefficients of the lenses in the optical system of FIG. 1.

FIG. 5 is a table showing the thickness of each lens of the optical system of FIG. 1 and the spacing between adjacent lenses.

FIG. 6 is a table showing the Sag values of the lens faces of the third to sixth lenses of the optical system of FIG. 1.

FIG. 7 is a table showing chief ray angle (CRA) data at room temperature, low temperature, and high temperature based on the position of the image sensor in the optical system of FIG. 1.

FIG. 8 is a graph showing data for the diffraction MTF (Modulation Transfer Function) at room temperature for the optical system of FIG. 1.

FIG. 9 is a graph showing data for the diffraction MTF at low temperature of the optical system of FIG. 1.

FIG. 10 is a graph showing data for the diffraction MTF at high temperature of the optical system of FIG. 1.

FIG. 11 is a graph showing data for the aberration characteristics at room temperature for the optical system of FIG. 1.

FIG. 12 is a graph showing data for the aberration characteristics at low temperature of the optical system of FIG. 1.

FIG. 13 is a graph showing data for the aberration characteristics at high temperature of the optical system of FIG. 1.

FIG. 14 is a graph showing relative illuminance based on height of the image sensor according to the first exemplary embodiment.

FIG. 15 is a side cross-sectional view of an optical system and a camera module thereof according to a second embodiment.

FIG. 16 is a side cross-sectional view to illustrate the relationship of the nth and n-1st lenses according to FIG. 15.

FIG. 17 is a table showing lens characteristics of the optical system of FIG. 15.

FIG. 18 is a table showing the aspheric coefficients of the lenses in the optical system of FIG. 15.

FIG. 19 is a table showing the thickness of each lens of the optical system of FIG. 15 and the spacing between adjacent lenses.

FIG. 20 is a table showing the Sag values of the lens faces of the third to sixth lenses of the optical system of FIG. 15.

FIG. 21 is a table showing data for the chief ray angle (CRA) at room temperature, low temperature, and high temperature based on the position of the image sensor in the optical system of FIG. 15.

FIG. 22 is a graph showing data for the diffraction MTF (Modulation Transfer Function) at room temperature for the optical system of FIG. 15.

FIG. 23 is a graph showing data for the diffraction MTF at low temperature for the optical system of FIG. 15.

FIG. 24 is a graph showing data for the diffraction MTF at high temperature of the optical system of FIG. 15.

FIG. 25 is a graph showing data for the aberration characteristics at room temperature of the optical system of FIG. 15.

FIG. 26 is a graph showing data for the aberration characteristics at low temperature of the optical system of FIG. 15.

FIG. 27 is a graph showing data for the aberration characteristics at high temperature of the optical system of FIG. 15.

FIG. 28 is a graph showing relative illuminance based on height of the image sensor according to a second exemplary embodiment.

FIG. 29 is an example of a vehicle having an optical system according to an exemplary embodiment of the invention.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

In the description of the invention, ‘object side’ may mean the surface of the lens facing the object side with respect to the optical axis (OA), and ‘sensor side’ may mean the surface of the lens facing the imaging surface (image sensor) with respect to the optical axis. The ‘object side surface’ may be the ‘object side’ and the ‘sensor side surface’ may be the ‘image side surface’. A convex face of a lens may mean a convex shape in the optical axis or paraxial region, and a concave face of a lens may mean a concave shape in the optical axis or paraxial region. The radius of curvature, center thickness, and optical axis spacing between lenses listed in the table for lens data may refer to values (in mm) along the optical axis. Vertical direction may mean a direction perpendicular to the optical axis, and a distal end of lens or lens face may mean the distal end of the effective area of the lens through which incident light passes. The size of the effective diameter of the lens surface may have a measurement error of up to 0.4 mm depending on the measurement method, etc. The term ‘paraxial region’ refers to a very narrow region near the optical axis, such that the distance at which the light rays fall from the optical axis (OA) is almost zero. Hereinafter, the meaning of optical axis may include the center of each lens or a very narrow area near the optical axis.

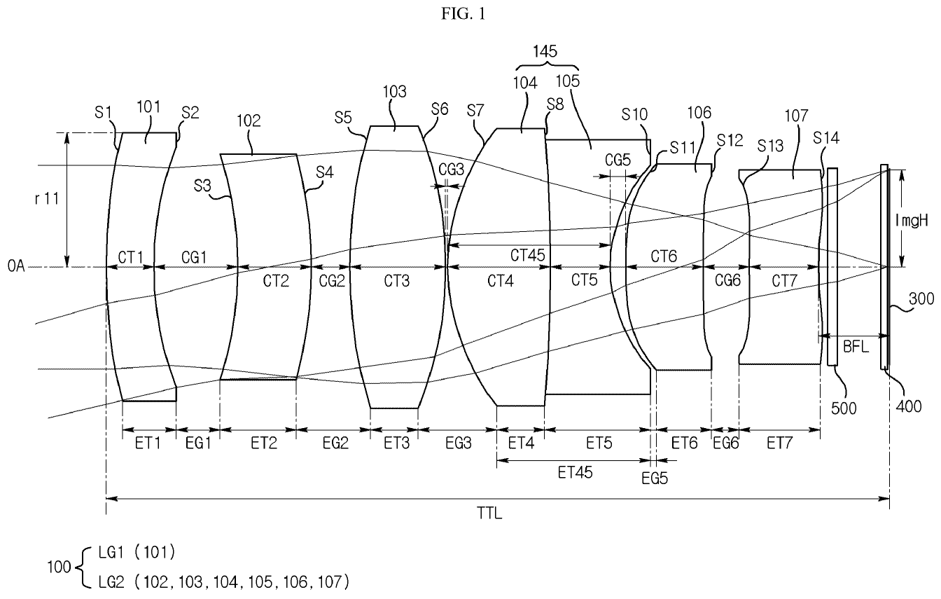

As shown in FIG. 1, the optical system (1000) according to a first exemplary embodiment of the present invention may comprise five or more sheets of lenses. The optical system (1000) and the camera module thereof may be mounted inside or outside a vehicle, for driver surveillance or for sensing external objects or lanes. The lenses may be made of glass or plastic, with glass having a smaller coefficient of linear expansion than plastic. Therefore, glass lenses are adopted to suppress the change of the focus image-forming position due to temperature changes. However, glass lenses are expensive compared to plastic lenses, and it is difficult to respond to the need for low cost. Therefore, the lenses in the optical system (1000) are required to be composed of a mixture of glass lenses and plastic lenses. By employing such plastic lenses, the optical system (1000) may provide light weight and low cost due to the reduced thickness of the plastic lenses, and the plastic lenses may provide good correction for various aberrations such as spherical aberration and chromatic aberration. The plastic lenses may also provide aspherical lenses, which may minimize distortion at the periphery.

The optical system (1000) may include n (sheets of) lenses, where the nth lens may be the last lens adjacent to an image sensor (300), and the n-1st lens may be the lens closest to the last lens. n may be an integer greater than or equal to 5, such as 5 to 8. The n lenses may have a ratio of lenses made of plastic to lenses made of glass in the range of 2:3 to 2:6, or in the range of 3:4 to 3:5.

The optical system (1000) may include a plurality of lens groups (LG1, LG2). More specifically, each of the plurality of lens groups (LG1,LG2) may include at least one lens. For example, the optical system (1000) may include a first lens group (LG1) and a second lens group (LG2) disposed sequentially along the optical axis (OA) from the object side towards the image sensor (300).

The number of lenses in each of the first lens group (LG1) and the second lens group (LG2) may be different. The number of lenses in the second lens group (LG2) may be greater than the number of lenses in the first lens group (LG1), for example, more than four times the number of lenses in the first lens group (LG1) or more than five times the number of lenses in the first lens group (LG1). The first lens group (LG1) may comprise at least one lens. The first lens group (LG1) may have three or fewer lenses. Preferably, the first lens group (LG1) may be a single lens. The second lens group (LG2) may comprise two or more lenses. The second lens group (LG2) may comprise between four and seven (sheets of) lenses. Preferably, the second lens group (LG2) may comprise six lenses.

The first lens group (LG1) may comprise at least one lens made of glass. The first lens group (LG1) may provide a lens closest to the object side as a lens made of glass. Such a glass material may be less prone to expansion and contraction due to changes in external temperature and may have a surface that is less prone to scratching, thereby preventing surface damage.

The lens material of the second lens group (LG2) may be a mixture of at least one glass lens and at least one plastic lens. In the second lens group (LG2), the at least one plastic lens may be disposed closer to the sensor than the glass lens. The second lens group (LG2) may comprise more than two glass lenses, such as between two and four glass lenses. The second lens group (LG2) may comprise, for example, between two and six lenses. As another example, the second lens group (LG2) may have at least one lens made of plastic. The second lens group (LG2) may comprise two or more plastic lenses, such as two to four plastic lenses.

The at least one lens closest to the object within the optical system (1000) may be made of glass material. Three or more sheets of lenses closest to the object, such as three to five lenses, may be of glass material. Since glass lenses have a smaller rate of change of contraction and expansion with temperature change than plastic lenses, glass lenses may be placed in externally adjacent areas within the lens barrel.

Within the optical system (1000), the at least one lens closest to the image sensor (300) may be made of plastic. For example, the at least two lenses closest to the image sensor (300) may be plastic, and preferably the at least two lenses adjacent to the image sensor (300) may be plastic. In other words, the nth and n-1st lenses in the optical system (1000) are disposed as plastic lenses, so that various aberrations can be corrected for light incident on the image sensor (300).

Within the optical system (1000), the plastic lenses may be continuously arranged in a row, and the glass lenses may be continuously arranged in a row (back-to-back). Within the optical system (1000), lenses made of plastic may be disposed between lenses made of glass. Within the optical system (1000), lenses made of glass may be disposed between lenses made of plastic.

Each lens (101-107) may have an object side surface and a sensor side surface. In an optical system, the number of lenses having an aspherical sensor side surface and an aspherical object side surface may be greater than the number of plastic lenses. The optical system may have a number of lenses having a spherical sensor side surface and a spherical object side surface that is smaller than the number of lenses that are aspherical on both sides. By having more aspherical lenses than spherical lenses, the optical system (1000) can compensate for a variety of aberrations.

Among the lenses of the optical system (1000), a lens having a maximum refractive index may be located in the first lens group (LG1) or adjacent to the object. The maximum refractive index may be 1.8 or greater. The chromatic dispersion of light incident on the lens with the maximum refractive index may be increased, and the center thickness may be thinner than the edge thickness. Also, since the lens having the maximum refractive index is disposed on the object side, it may be easy to change the radius of curvature of the second and subsequent lenses and increase the center thickness.

Within the optical system (1000), a lens with a maximum effective diameter may be disposed at the center of the object side and the sensor side. As the lens moves from the object side to the sensor side, the effective diameter of the lens may increase and then decrease. As the lens moves from the object side to the sensor side, the effective diameter of the lens may become smaller, then larger, then smaller again. This allows the optical system (1000) to form a stable optical path because the light incident on the optical system (1000) is directed away from the optical axis and then converges back to the optical axis.

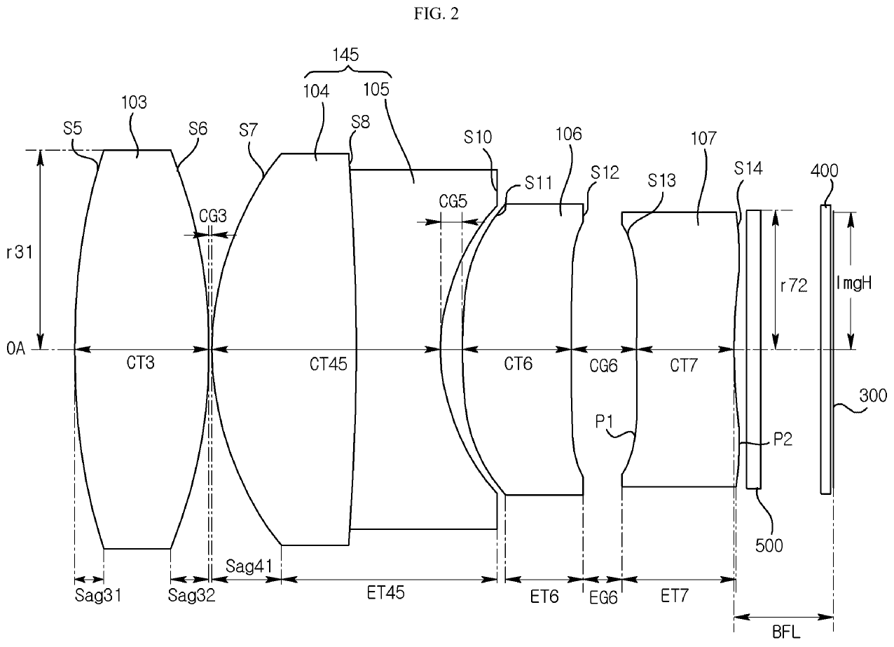

The effective diameter may be the diameter of the effective region of light incident on each lens. The effective diameter is the length in the direction (X,Y) orthogonal to the optical axis, and is an average of the effective diameter of the object side surface and the sensor side surface of each lens. ‘Diameter of the lens face (surface)’ may mean “effective diameter of the lens”. The ‘diameter of the lens’ may be the diameter of the entire lens, including the flange portion of the lens in addition to the effective area of the lens. Although the flange of the lens is not shown in FIGS. 1 and 2, the flange may be a portion projecting perpendicular to the optical axis from the side of the lens for coupling the lens to the barrel. The flange may not receive effective light. Additional spacers may be placed between the flanges of different lenses to allow the lenses to be coupled to the barrel.

Each of the lenses (101-107) may include an effective region and an ineffective region. The effective region may be an area through which light incident on each of the lenses passes, i.e., the effective region may be defined as the effective area or effective diameter through which the incident light is refracted to achieve the optical properties. The ineffective region may be disposed around the perimeter of the effective region. The ineffective region may be a region where no effective light is incident on the plurality of lenses, i.e., the ineffective region may be a region irrelevant to the optical properties. Further, a distal end of the ineffective region may be a region fixed to a lens barrel or the like that receives the lens.

Within the optical system (1000), the total top length (TTL) may be more than twice as long as the Imgh, such as more than four times as long and less than twelve times as long. The total track length (TTL) is the distance in the optical axis (OA) from the center of the object side of the first lens to the image (top) surface of the image sensor (300). Imgh is the distance in the optical axis (OA) to the diagonal end of the image sensor (300), or ½ of the maximum diagonal length. Within the optical system (1000), an effective focal length (EFL) of at least 10 mm and a field of view (FOV) of less than 45 degrees can be provided, which can be provided by standard optics in automotive camera modules. For example, an optical system and camera module according to an exemplary embodiment may be applied to a camera for an advanced driving assistance system (ADAS), either inside or outside of a vehicle.

The optical system (1000) may have a TTL/Imgh of at least 5 and at least 7.5, such as at least 6 and at least 7. The optical system (1000) may provide an automotive lens optical system by setting the TTL/Imgh to a value of at least 5 and no more than 7.5 times.

The total number of lenses in the first and second lens groups (LG1,LG2) is 8 or less. Accordingly, the optical system (1000) may provide an image that is free of exaggeration or distortion for the image being resolved.

The effective diameter of the at least one plastic lens in the optical system (1000) may be smaller than the length of the image sensor (300). The effective diameter is the diameter or length of the effective area through which light is incident. The length of the image sensor (300) is the maximum length of a diagonal in a direction orthogonal to the optical axis (OA). Within the optical system (1000), the number of lenses having an effective diameter greater than the length of the image sensor (300) may be greater than 50% or greater than 60%, and the number of lenses having an effective diameter less than the length of the image sensor (300) may be less than 50% or less than 40%.

The optical system (1000) may include at least one cemented lens (145) thereinside. The cemented lens (145) is a cementation of at least two lenses having different refractive powers, and the gap between the two lenses may be less than 0.01 mm. The cemented lens (145) may be a lens in which two lenses with different focal lengths are cemented. The joining of the two lenses may be bonded with an adhesive. The effective diameter of at least one lens or all of the lenses disposed on the object side relative to the cemented lens (145) may be greater than the length of the image sensor (300). The effective diameter of at least one lens disposed on the sensor side relative to the cemented lens (145) may be less than the length of the image sensor (300). Also, of the cemented lens (145), an object-side lens (103) may be larger than the length of the image sensor (300), and a sensor-side lens (104) may be larger than the length of the image sensor (300).

The lenses between the cemented lens (145) and a first lens (101) may be made of glass or plastic. The lenses disposed between the cemented lens (145) and the image sensor (300) may be made of plastic. The lenses between the cemented lens (145) and the first lens (101) may be spherical on both sides or aspherical on both sides. The lenses disposed between the cemented lens (145) and the image sensor (300) may be aspherical lenses on both sides. The two sides are the object side and the sensor side. Thus, by disposing the aspherical lenses between the cemented lens (145) and the image sensor (300), the optical performance can be improved by correcting curvature aberration and chromatic aberration.

In the optical axis (OA), the first lens group (LG1) and the second lens group (LG2) may have a set spacing. The optical axis spacing between the first lens group (LG1) and the second lens group (LG2) in the optical axis (OA) may be an optical axis spacing between the sensor side surface of the lens closest to the sensor side among the lenses in the first lens group (LG1) and the object side surface of the lens closest to the object side among the lenses in the second lens group (LG2). The optical axis spacing between the first lens group (LG1) and the second lens group (LG2) may be less than or equal to one times the optical axis distance of the first lens group (LG1), such as in the range of 0.1 times to 1 times the optical axis distance of the first lens group (LG1).

The optical axis distance between the first lens group (LG1) and the second lens group (LG2) may be less than or equal to 0.2 times the optical axis distance of the second lens group (LG2), such as in the range of 0.01 times to 0.2 times. The optical axis distance of the second lens group (LG2) is the optical axis distance between the object side surface of the lens closest to the object side of the second lens group (LG2) and the sensor side surface of the lens closest to the image sensor (300).

Here, two of the lens (surfaces) faces of the first lens group (LG1) and the second lens group (LG2) that face each other, for example, the sensor side surface of the object-side lens may be concave and the object side surface of the sensor-side lens may be concave, i.e., the sensor side surface closest to the sensor side in the first lens group (LG1) may be concave and the object side surface closest to the object side in the second lens group (LG2) may be concave. The first lens group (LG1) may diffuse the light incident through the object side, and the second lens group (LG2) may refract the light diffused through the first lens group (LG1) to the area of the image sensor (300).

The first lens group (LG1) may have a negative (−) refractive power and the second lens group (LG2) may have a positive (+) refractive power. Among the lenses of the first lens group (LG1), the lens closest to the object side may have a negative (−) refractive force, and among the lenses of the second lens group (LG2), the lens closest to the sensor side may have a negative (−) refractive force. Expressing the focal length as an absolute value, the focal length of the first lens group (LG1) may be greater than the focal length of the second lens group (LG2), such as more than 2 times, such as in the range of 2 to 10 times. The effective focal length (EFL) of the optical system (1000) may be less than an absolute value of the focal length of the first lens group (LG1). The effective focal length (EFL) of the optical system (1000) may be less than the absolute value of the focal length of the first lens group (LG1) and greater than the absolute value of the focal length of the second lens group (LG2).

Within the optical system (1000), the number of lenses with negative (−)refractive power may be equal to or greater than the number of lenses with positive (+) refractive power. The number of lenses with negative (−) refractive power may be 50% or more of the total number of lenses. The average refractive index of the lenses with negative (−) refractive power may be greater than the average of the lenses with positive (+) refractive power. Accordingly, the variance of the lenses having a positive (+) refractive power may be greater than the variance of the lenses having a negative (−) refractive power.

The lens part (100) may comprise a mixture of glass and plastic lenses. The number of plastic lenses may be 60% or less of the total number of lenses, and may be in the range of 30% to 60%, or in the range of 30% to 50%. Accordingly, when more plastic lenses are disposed in the camera module, the weight of the camera module can be reduced, and the plastic material can be easily polished, processed, and withstands external impact, and the price is competitive and the material is easy to secure. In addition, various aberrations can be corrected by plastic lenses, which can prevent optical performance degradation.

The first exemplary embodiment of the present invention may further incorporate plastic lenses within the optical system (1000), which can reduce the weight of the camera module, provide a lower cost of manufacture, suppress degradation of optical properties with temperature changes, allow different types of plastic lenses to replace glass lenses, and facilitate polishing and machining of lens faces, such as aspherical or free curved faces.

The lens part (100) may include lenses of a first material disposed along the optical axis (OA) and lenses of a second material. The first material may be glass, and the second material may be plastic. The first material lens may be disposed between the second material lenses. The lenses of the second material may be disposed between the lenses of the first material.

The lens part (100) may include a first material lens having an aspherical surface along the optical axis (OA), a first material lens having a spherical surface, and a second material lens having an aspherical surface. The first material may be glass, and the second material may be plastic. The first material lens having a spherical surface may be disposed between the second material lens having an aspherical surface. The lenses of the second material may be disposed between the lenses of the first material having an aspherical surface and the lenses of the first material having a spherical surface.

Within the lens part (100), the effective diameter of the lens closest to the object side may be larger than the effective diameter of the lens closest to the image sensor (300). Thus, the brightness of the optical system can be controlled. The effective diameter may be the average effective diameter of the object side surface and the sensor side surface of each lens. By controlling the effective diameter size of each lens, the optical system (1000) can control the incident light to compensate for degradation of optical properties due to changes in resolving power, temperature, improve chromatic aberration control characteristics, and improve vignetting characteristics of the optical system (1000).

The lens part (100) may include a first lens (101), a second lens (102), a third lens (103), a fourth lens (104), a fifth lens (105), a sixth lens (106), and a seventh lens (107) aligned along an optical axis from the object side toward the sensor side.

Within the lens part (100), the focal length of the lens closest to the object may be greater than the focal length of the plastic lens when the focal length is taken as an absolute value. Here, the plastic lens may be at least one lens disposed on the sensor side of the cemented lens, or at least one lens adjacent to the image sensor. The focal length (F1) of the first lens (101) may be the largest in the optical system, and may be larger than the focal length (absolute value) of the second lens group (LG2), that is, the condition of |FLG2|<F1 may be satisfied.

In the lens part (100), the lenses having an average effective diameter greater than the average effective diameter of the plastic lenses may be three or more, such as four or more. If the average effective diameter of the plastic lenses is PLca_Aver and the average effective diameter of the glass lenses is GLca_Aver, the condition of PLca_Aver<GLca_Aver may be satisfied. Also, the condition of 1<GLca_Aver/PLca_Aver<1.5 may be satisfied. Further, the relationship between the length of the image sensor (300) and the average effective diameter (PLca_Aver) of the plastic lens may satisfy the condition of 1≤PLca_Aver/(Imgh*2)<1.5. Further, the relationship between the average effective diameter of the glass material and the length of the image sensor (300) may satisfy the condition of 1.1<GLca_Aver/(Imgh*2)<1.5. The difference between the maximum length of the image sensor (300) and the effective diameter of the plastic lens may be arranged to be insignificant. Accordingly, by disposing a plastic lens having a small effective diameter adjacent to the image sensor (300), the plastic lens can distribute color from the center of the image sensor (300) to the periphery.

The glass material may have an average effective diameter of at least 10 mm, such as in the range of 10 mm to 15 mm. The plastic material may have an average effective diameter of at least 8 mm, such as in the range of 8 mm to 12 mm. The lens having the minimum effective diameter may be made of plastic, and the lens having the maximum effective diameter may be made of glass. Within the lens part (100), the minimum effective diameter may be in the range of 7 mm to 10 mm, and the maximum effective diameter may be in the range of 11 mm to 15 mm. A lens made of plastic may be designed with a smaller effective diameter than a lens made of glass so that it can be positioned away from the lens barrel, thereby minimizing changes in optical performance due to changes in temperature. In addition, the optical system (1000) may control the incident light to improve resolving power, chromatic aberration control characteristics, and improve vignetting characteristics of the optical system (1000).

The optical system (1000) or camera module may include an image sensor (300). The image sensor (300) can detect light and convert it into electrical signals. The image sensor (300) may detect light that has passed sequentially through the lens part (100). The image sensor (300) may include an element capable of detecting incident light, such as a charge coupled device (CCD) or a complementary metal oxide semiconductor (CMOS).

Here, the length of the image sensor (300) is a maximum length in a diagonal direction orthogonal to the optical axis (OA) and may be less than the effective diameter of the lens closest to the object within the first lens group (LG1) and greater than the effective diameter of the lens closest to the sensor within the second lens group (LG2). Here, the number of lenses having an effective diameter larger than the length of the image sensor (300) may be from 4 to 6, and the number of lenses having an effective diameter smaller than the length of the image sensor (300) may be from 1 to 3.

The optical system (1000) or camera module may include a filter (500). The filter (500) may be disposed between the second lens group (LG2) and the image sensor (300). The filter (500) may be disposed between the lens closest to the sensor side of the lenses of the lens part (100) and the image sensor (300). For example, the filter (500) may be disposed between the nth lens and the image sensor (300).

A cover glass (400) may be disposed between the filter (500) and the image sensor (300), and may protect the top of an image sensor (192) and prevent the image sensor (192) from degrading in reliability. The cover glass (400) may be removable. The cover glass (400) may be a protective glass.

The filter (500) may include an infrared filter or an infrared cut-off filter (IR cut-off). The filter (500) may allow light of a set wavelength band to pass through and filter out light of a different wavelength band. If the filter (500) includes an infrared filter, it can block radiant heat emitted from external light from reaching the image sensor (300). Furthermore, the filter (500) can transmit visible light and reflect infrared light.

The optical system (1000), according to an exemplary embodiment, may include an aperture (stop). The aperture can adjust the amount of light incident on the optical system (1000). For lenses disposed between the object and the aperture, the effective diameter of the lens face tends to increase from the object side toward the aperture. For lens faces disposed between the aperture and the sensor, the effective diameter of the lens faces (surfaces) tends to decrease as one moves from the aperture to the sensor side. The meaning that the effective diameters of the lens faces tend to increase or decrease does not mean that the effective diameters of the lens faces increase or decrease only. For example, the effective diameters of the lens faces may increase and then decrease as one moves from the aperture to the sensor side.

The aperture may be disposed at a predetermined location. For example, the aperture may be disposed on the periphery of the object side surface or sensor side surface of the lens closest to the object side of the lenses of the second lens group (LG2). Alternatively, the aperture may be disposed around the periphery of the object side surface or sensor side surface of the object side lens of the first lens group (LG1). Alternatively, at least one lens selected from the plurality of lenses may act as an aperture. More specifically, the object side surface or sensor side surface of the at least one lens selected from the plurality of lenses of the optical system (1000) may act as an aperture to regulate the amount of light.

In the optical system (1000) of the first exemplary embodiment, the sum of the refractive indices of the lenses of the lens part (100) may be at least 8, such as in the range of 8 to 15, and the average refractive index may be in the range of 1.58 to 1.7. The sum of the Abbe numbers of each of the lenses may be greater than or equal to 300, such as in the range of 310 to 350, and the average of the Abbe numbers may be less than or equal to 50, such as in the range of 35 to 47. The sum of the center thicknesses of all the lenses may be in the range of 18 mm or more, such as in the range of 20 mm to 25 mm, and the average of the center thicknesses may be in the range of 2.8 mm to 3.5 mm. The sum of the center spacing between the lenses on the optical axis (OA) may be at least 6 mm, such as in the range of 6.8 mm to 8 mm, and may be less than the sum of the center thicknesses of the lenses. Further, an average value of the effective diameter of each lens face (S1-S14) of the lens part (100) may be provided in a range of 8 mm or more, such as in a range of 8 mm to 15 mm.

In the optical system according to the first exemplary embodiment of the present invention, the field of view (diagonal) may be 50 degrees or less, such as in the range of 20 degrees to 50 degrees. The F-number of the optical system or camera module may be 2.4 or less, such as in the range of 1.4 to 2.4, or in the range of 1.5 to 1.8. In the optical system according to the first embodiment of the invention, the maximum field of view (diagonal) may be 50 degrees or less, such as in the range of 20 degrees to 50 degrees. In the automotive optical system, the horizontal field of view (FOV_H) in the Y-axis direction may be greater than 20 degrees and less than 40 degrees, such as in the range of 25 degrees to 35 degrees. In addition, the vertical field of view may be provided at a smaller angle than the horizontal field of view, and may be less than 20 degrees, such as in the range of 10 degrees to 20 degrees. In this case, the sensor length in the horizontal direction (Y) may be 8.064 mm ±0.5 mm, and the sensor height in the vertical direction (X) may be 4.54 mm ±0.5 mm. The horizontal field of view (FOV_H) is the angle of view based on the horizontal length of the sensor. Accordingly, the change of the focus imaging position due to temperature change can be suppressed, and a vehicle camera with good correction of various aberrations can be provided.

Since the first exemplary embodiment is an optical system applied to a vehicle camera, the first lens (101) may be provided with a glass material, although it can be designed using a combination of plastic and glass lenses. This has the advantage that the glass material is scratch-resistant and insensitive to external temperature compared to the plastic material. The first lens (101) may be a glass mold lens having an aspherical surface and made of glass. Glass mold lenses can be produced by heating and compressing an ingot of optical glass inside a mold to form an aspherical shape.

A glass lens may be used as the first lens (101) to more effectively prevent scratches from foreign objects placed inside the vehicle, and the object side surface of the first lens (101) may have a gently curved shape so that it is not in contact with the external structure. This minimizes the occurrence of scratches due to contact with external structures. The field of view may be greater than 20 degrees and less than 40 degrees, such as in the range of 25 degrees to 35 degrees, for driver surveillance during vehicle operation, front and rear views of the vehicle, or lane detection and detection of unexpected objects around the vehicle. Such a horizontal field of view may be a preset angle for an advanced driver assistance system (ADAD).

The optical system (1000) according to the first exemplary embodiment may further comprise a reflective member for rerouting the light path. The reflective member may be implemented as a prism that reflects incident light from the first lens group (LG1) in the direction of the lenses. In the following, the optical system according to an embodiment will be described in detail.

The optical system according to the first exemplary embodiment of the invention will now be described.

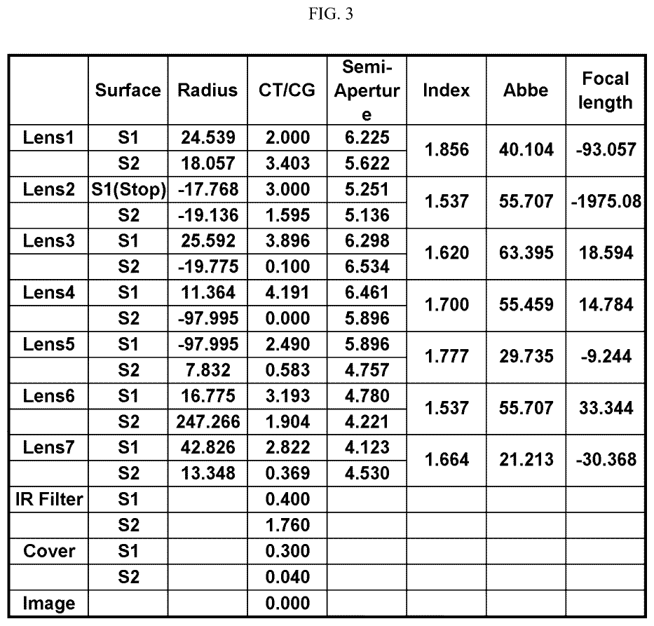

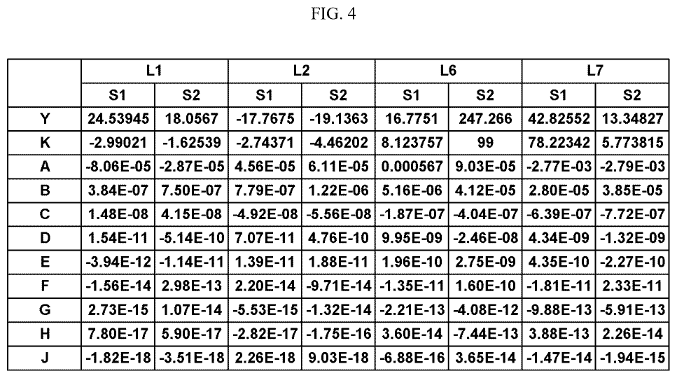

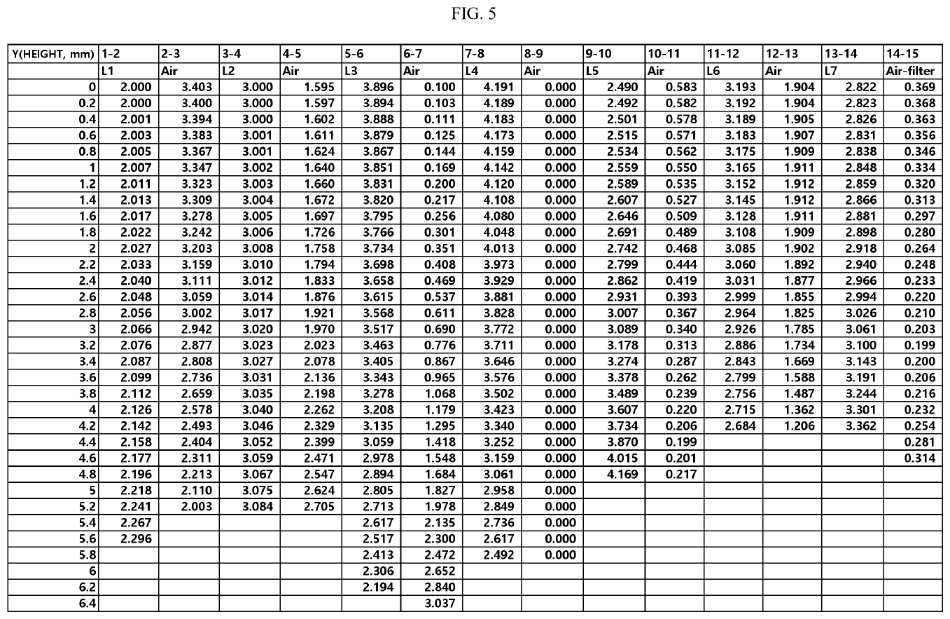

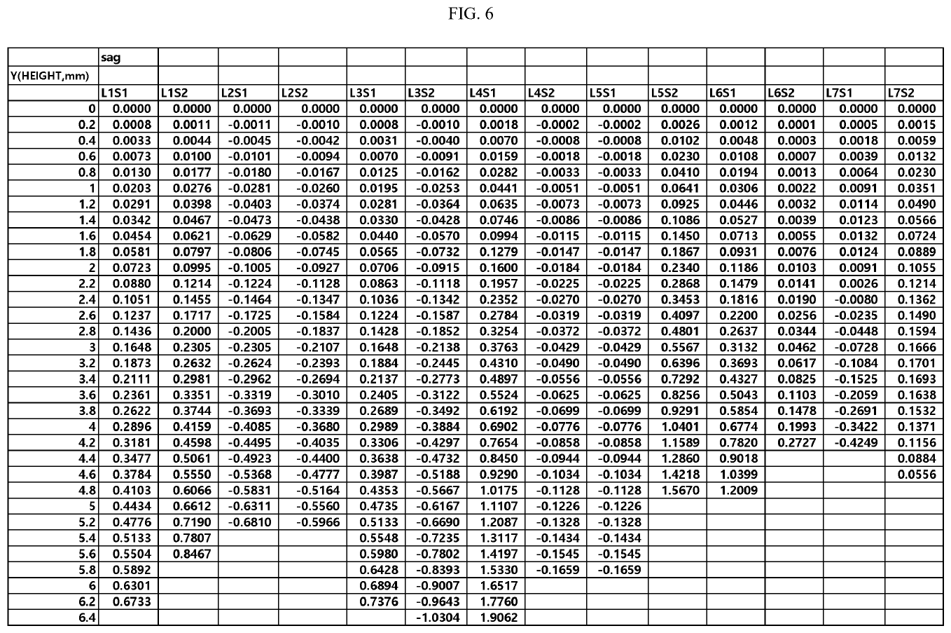

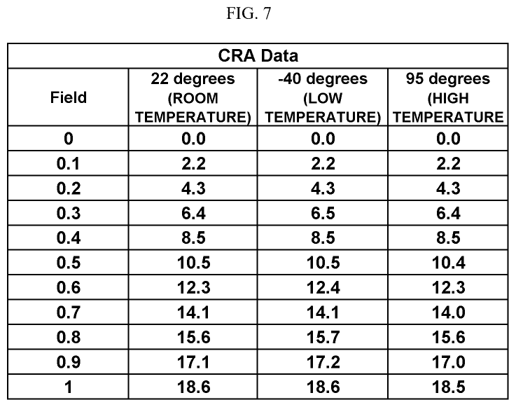

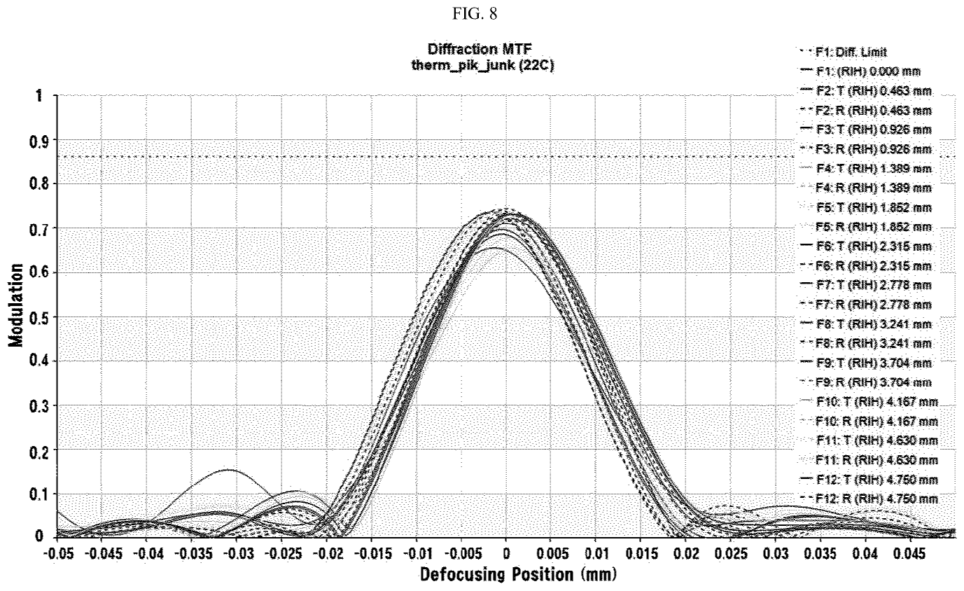

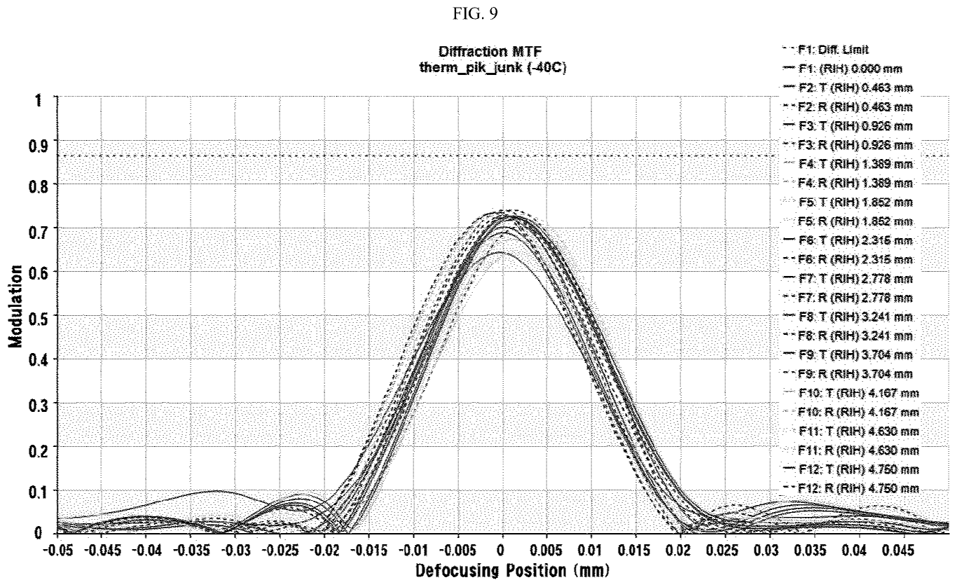

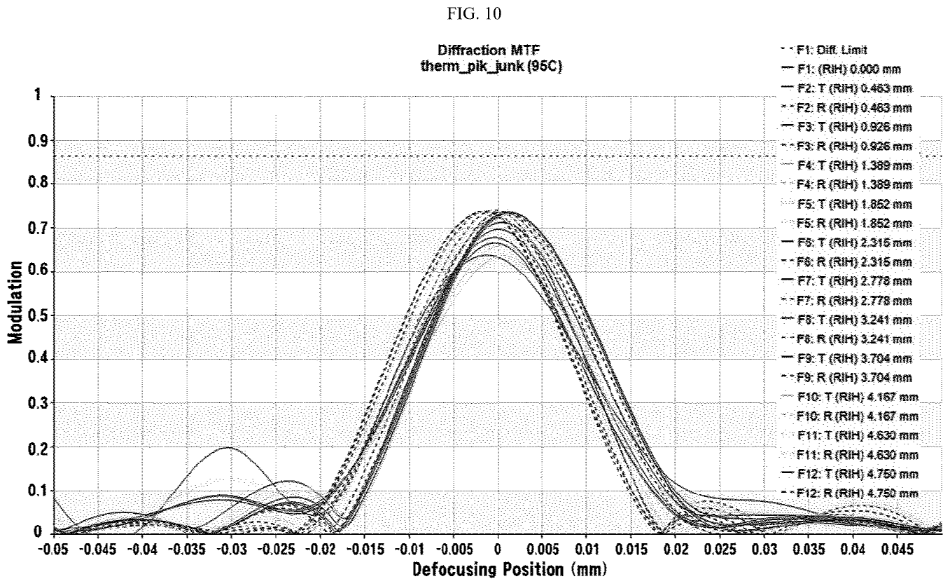

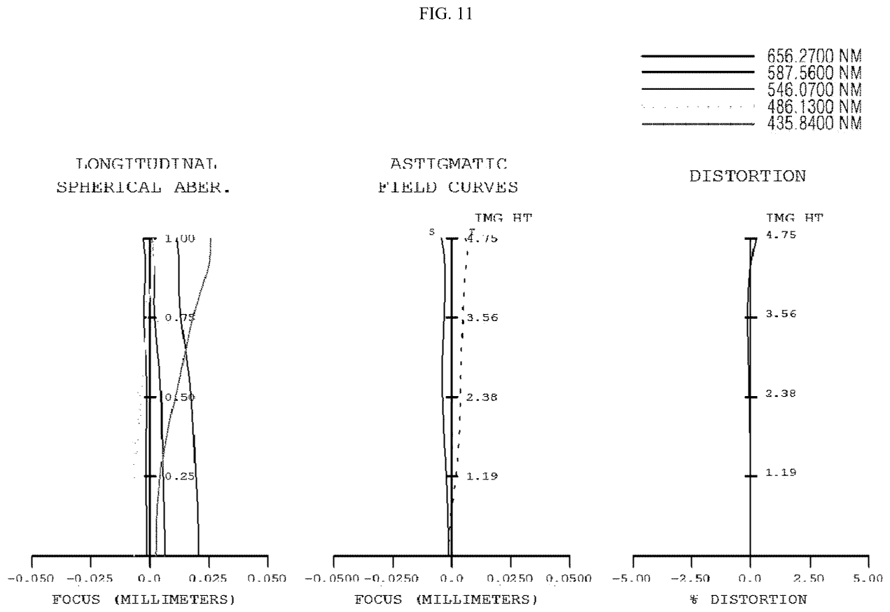

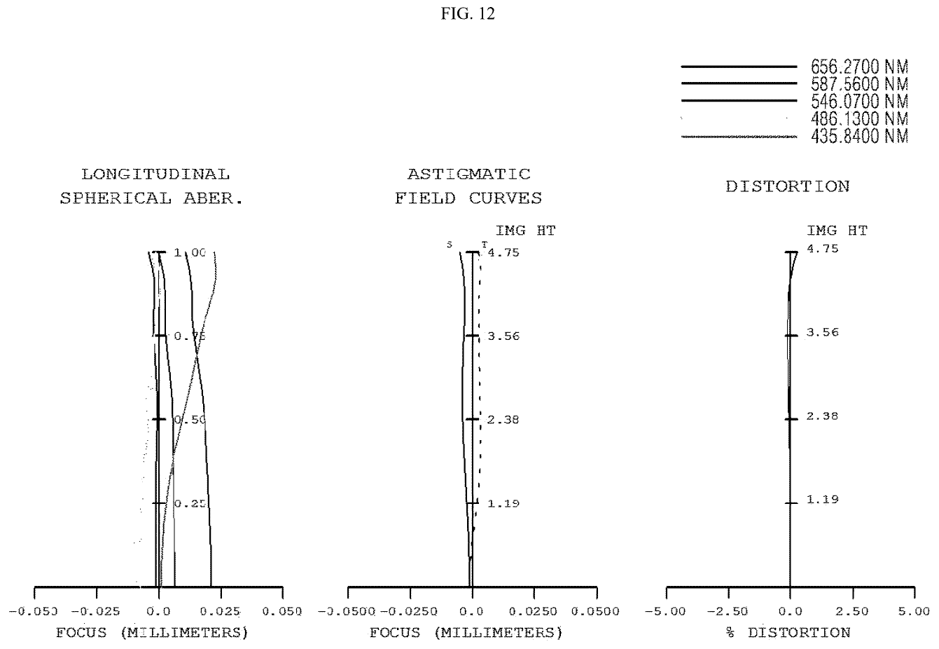

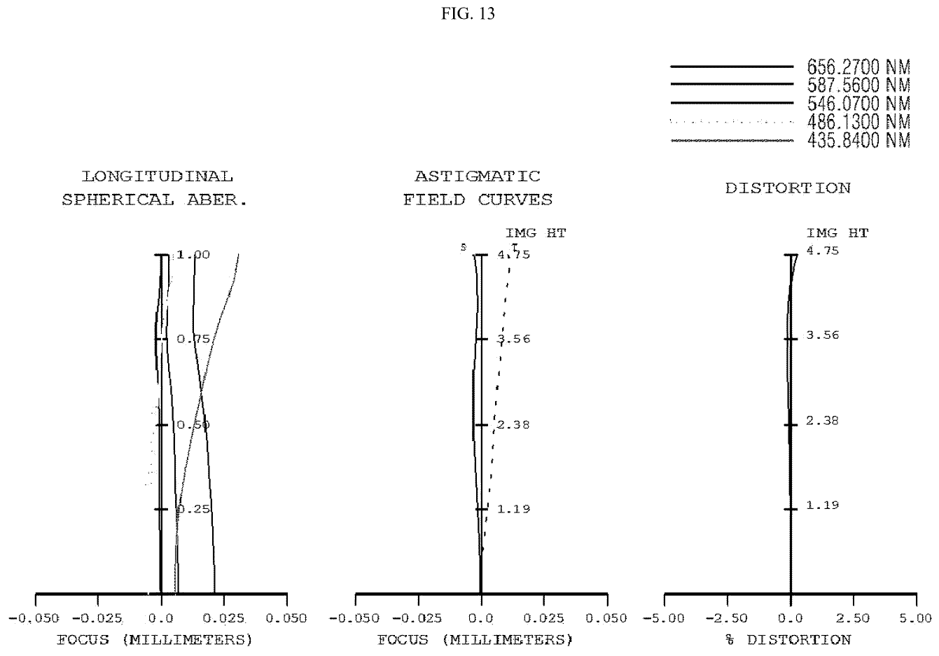

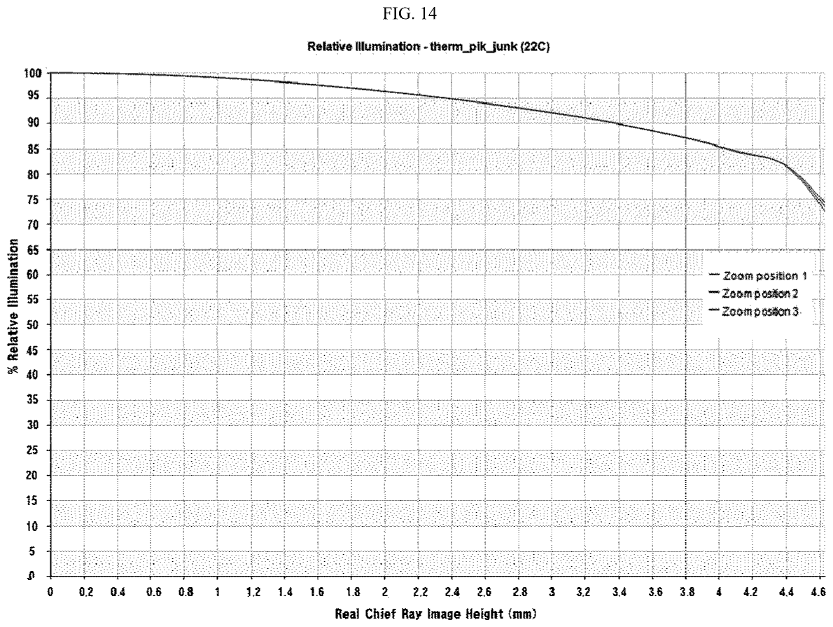

FIG. 1 is a side cross-sectional view of an optical system according to a first exemplary embodiment and a camera module thereof, FIG. 2 is a side cross-sectional view to illustrate the relationship of the nth and n-1st lenses according to FIG. 1, FIG. 3 is a table showing lens characteristics of the optical system of FIG. 1, FIG. 4 is a table showing the aspheric coefficients of the lenses in the optical system of FIG. 1, FIG. 5 is a table showing the thickness of each lens of the optical system of FIG. 1 and the spacing between adjacent lenses, FIG. 6 is a table showing the Sag values of the lens faces of the third to sixth lenses of the optical system of FIG. 1, FIG. 7 is a table showing chief ray angle (CRA) data at room temperature, low temperature, and high temperature based on the position of the image sensor in the optical system of FIG. 1, FIG. 8 is a graph showing data for the diffraction MTF (Modulation Transfer Function) at room temperature for the optical system of FIG. 1, FIG. 9 is a graph showing data for the diffraction MTF at low temperature of the optical system of FIG. 1, FIG. 10 is a graph showing data for the diffraction MTF at high temperature of the optical system of FIG. 1, FIG. 11 is a graph showing data for the aberration characteristics at room temperature for the optical system of FIG. 1, FIG. 12 is a graph showing data for the aberration characteristics at low temperature of the optical system of FIG. 1, FIG. 13 is a graph showing data for the aberration characteristics at high temperature of the optical system of FIG. 1, and FIG. 14 is a graph showing relative illuminance based on height of the image sensor according to the first exemplary embodiment.

Referring to FIGS. 1 to 4, the optical system (1000) may include a lens part (100), which may include a first lens (101) to a seventh lens (107). The first to seventh lenses (101 to 107) may be sequentially disposed along an optical axis (OA) of the optical system (1000). Light corresponding to information about an object may be incident on the image sensor (300) after passing through the first lens (101) to the seventh lens (107) and the filter (500).

The first lens (101) may be a lens closest to the object side in the first lens group (LG1). The seventh lens (107) may be a lens closest to the image sensor (107) in the second lens group (LG2) or lens part (100). The first lens (101) may be the first lens group (LG1), and the second to seventh lens (102, 103, 104, 105, 106, 107) may be the second lens group (LG2). An aperture may be disposed on either the periphery of the object side or sensor side surface of the first lens (101) or the periphery of the object side surface or sensor side surface of the second lens (102). For example, the aperture (stop) may be disposed on the periphery of the object side surface of the second lens (102).

The first lens (101) may be disposed closest to the object side. The first lens (101) may be disposed furthest from the sensor side. The first lens (101) may have a negative (−) refractive power in the optical axis (OA). The first lens (101) may comprise a plastic material or a glass material, for example, a glass material. The first lens (101) made of glass may reduce changes in the center position and radius of curvature due to temperature changes in the surrounding environment, and may protect the incident side surface of the optical system (1000).

The first surface (S1) of the object side of the first lens (101) may be convex and the second surface (S2) of the sensor side may be concave with respect to the optical axis. The first lens (101) may have a convex meniscus shape towards the object side. The first lens (101) may be made of glass and may have an aspherical surface. The aspheric coefficients of the first and second surfaces (faces) (S1,S2) may be given by L1S1,L1S2 in FIG. 4. Such a first lens (101) may be manufactured as a lens having an aspherical surface by injection molding a glass material. The first lens (101) may be a glass mold lens having an aspherical surface and made of glass material. A glass mold lens may be fabricated by placing an ingot of optical glass inside a mold to be shaped into an aspherical shape, and heating and compressing it.

The effective radius (R11) of the first lens (101) may be larger than the effective radius of the plastic lens. In contrast, at least one of the object side surface and the sensor side surface of the first lens (101) may have a free curved surface, i.e., a non-rotationally symmetrical curved surface.

Since the first surface (S1) is convex and the second surface (S2) is concave, it can refract the incident light in a direction away from the optical axis (OA) and reduce the gap between the first and second lenses (101, 102). Also, the effective diameter of the sensor side surface of the second lens (102) can be designed to be smaller than the effective diameter of the object side surface by the shape of the lens surface of the first lens (101). The first surface (S1) of the first lens (101) may be provided without a critical point from the optical axis (OA) to the distal end of the effective region, i.e., the edge. The second surface (S2) of the first lens (101) may be provided without a critical point.

The refractive index n1 of the first lens (101) may satisfy a condition of n1>1.8 or n1>1.82. Since the refractive index n1 of the first lens (101) is the largest in the lens part (100), the radius of curvature of the first and second lenses (101,102) may be large, and lens manufacturing may be easy. If the refractive index n1 of the first lens (101) is smaller than the condition, the lens surface needs to be sharply concave or convex to increase the refractive power of the first and second lenses (101,102), which may not be easy to manufacture lenses and may cause a high rate of lens defects and low yield.

The second lens (102) may be disposed second on the object side. The second lens (102) may be disposed sixth from the sensor side. The second lens (102) may be disposed between the first lens (101) and the third lens (103). The second lens (102) may have a negative (−) refractive power in the optical axis (OA). The second lens (102) may include a plastic or glass material. For example, the second lens (102) may be provided in a plastic material.

The object-side third surface (S3) of the second lens (102) may be concave and the sensor-side fourth surface (S4) may be convex with respect to the optical axis (OA). The second lens (102) may have a convex meniscus shape towards the sensor side. The second lens (102) may be made of plastic and may be aspherical. At least one or both of the third surface (S3) and the fourth surface (S4) may be aspherical. The asphericity coefficients of the third surface (S3) and the fourth surface (S4) may be provided as L2S1 and l2S2 in FIG. 4. At least one or both of the third surface (S3) and the fourth surface (S4) may be provided without a critical point from the optical axis (OA) to the distal end of the effective region.

The aperture (stop) may be disposed around the periphery of the object side third surface (S3) of the second lens (102). The composite focal length of the second to seventh lenses (102-107) disposed on the sensor side of the aperture may have a positive value, which may reduce the TTL within the field of view range and enable miniaturization of the optical system. Accordingly, it is possible to prevent a decrease in the yield by weight of the optical system and to improve production efficiency. Furthermore, the TTL can be reduced by reducing the horizontal field of view (FOV_H) from 25 degrees to 36 degrees to miniaturize the optical system.

The third lens (103) may be disposed third from the object side. The third lens (103) may be disposed fifth from the sensor side. The third lens (103) may be disposed between the second lens (102) and the fourth lens (104). The third lens (103) may have a positive (+) refractive power in the optical axis (OA). The third lens (103) may include a plastic or glass material. For example, the third lens (103) may be provided in a glass material.

The object-side fifth surface (S5) of the third lens (103) may be convex and the sensor-side sixth surface (S6) may be convex with respect to the optical axis. The third lens (103) may have a convex shape on both sides in the optical axis (OA). The third lens (103) may be made of glass and may be spherical. At least one or both of the fifth surface (S5) and the sixth surface (S6) may be spherical. At least one or both of the fifth surface (S5) and the sixth surface (S6) may be provided without a threshold point from the optical axis (OA) to the distal end of the effective region.

Since both sides of the third lens (103) are provided convexly, the TTL and lens number of the optical system can be minimized, and light can be effectively refracted. Furthermore, if the radius of curvature of the fifth surface (S5) of the third lens (103) is L3R1 and the radius of curvature of the sixth surface (S6) is L3R2, the condition of L3R1>|L3R2| can be satisfied. If this condition is satisfied, the light can be efficiently refracted by the fifth surface (S5) to guide the effective diameter of the fourth to seventh lens (104-107) not to increase, and the TTL can be reduced. If L3R1<|L3R2|, the third lens (103) may generate a large number of aberrations on the object side surface and the refractive efficiency of light on the sensor side surface may be reduced, and the effective diameters of the rear lenses may be increased and the TTL may be increased.

The fourth lens (104) may be disposed fourth from the object side. The fourth lens (104) may be disposed fourth from the sensor side. The fourth lens (104) may be disposed between the third lens (103) and the fifth lens (105). The fourth lens (104) may have a positive (+) or negative (−) refractive power in the optical axis (OA). The fourth lens (104) may have a positive (+) refractive power. The fourth lens (104) may have a positive (+) refractive power that is different from the refractive power of the fifth lens (105). The fourth lens (104) may include a plastic or glass material. For example, the fourth lens (104) may be provided in a glass material. The fourth lens (104) may be provided in the same material as that of the fifth lens (105).

The object-side 7th surface (S7) of the 4th lens (104) may be convex and the sensor-side 8th surface (S8) may be convex with respect to the optical axis. The fourth lens (104) may be convex on both sides. The fourth lens (104) may be made of glass and may have a spherical surface. At least one or both of the seventh surface (S7) and the eighth surface (S8) may be spherical. The seventh surface (S7) and the eighth surface (S8) may be provided without a threshold from the optical axis (OA) to the distal end of the effective region.

The fifth lens (105) may be disposed fifth from the object side. The fifth lens (105) may be disposed third from the sensor side. The fifth lens (105) may be disposed between the fourth lens (104) and the sixth lens (106). The fifth lens (105) may have a positive (+) or negative (−) refractive power in the optical axis (OA). The fifth lens (105) may have a negative (−) refractive power. The fifth lens (105) may have a negative (−) refractive power that is different from the refractive power of the fourth lens (104). The fifth lens (105) may include a plastic or glass material. For example, the fifth lens (105) may be provided in a glass material. The fifth lens (105) may be provided in the same material as that of the fourth lens (104).

With respect to the optical axis (OA), the fifth lens (105) may have a concave ninth object side surface (S9) and a concave tenth sensor side surface (S10). The fifth lens (105) may have a concave shape on both sides in the optical axis (OA). Alternatively, the fifth lens (105) may have a convex shape on both sides. The fifth lens (105) may be made of glass and may have a spherical surface. At least one of the ninth surface (S9) and the tenth surface (S10) may be spherical. For example, both the ninth surface (S9) and the tenth surface (S10) may be spherical. At least one or both of the ninth and tenth surfaces (S9, S10) of the fifth lens (105) may be provided without a threshold point from the optical axis (OA) to the distal end of the effective region.

The fourth lens (104) and the fifth lens (105) may be cemented. The joined surface between the fourth lens (104) and the fifth lens (105) may be defined as the eighth surface (S8). The eighth surface (S8) may be the same surface as that of the ninth surface of the fifth lens (105). The object side surface of the cemented lens (145) may be convex, and the sensor side surface may be concave. The gap between the fourth and fifth lenses (104, 105) may be less than 0.01 mm and may be bonded (cemented) with an adhesive. The spacing between the fourth and fifth lenses (104,105) may be less than 0.01 mm from the optical axis (OA) to the distal end of the effective region. The fourth and fifth lenses (104,105) may have opposing refractive powers. The composite refractive power of the fourth and fifth lenses (104,105) may have a positive (+) refractive power.

The value of the radius of curvature of the cemented surface (S8) of the cemented lens (145) may be greater than 30. For example, the value of the radius of curvature of the cemented surface (S8) of the cemented lens (145) may be greater than 50. The cemented surface (S8) of the cemented lens (145) may be formed in a gentle shape. Thus, the bonding (cementing) process of the fourth lens (104) and the fifth lens (105) forming the cemented lens (145) is advantageous, and the cemented (bonded) retention can be increased.

The product of the refractive power of the object side third lens (103) of the cemented lens (145) and the refractive power of the sensor side fourth lens (104) can be less than zero. The product of the focal length of the object-side third lens (103) of the cemented lens (145) and the focal length of the sensor-side fourth lens (104) may be less than zero. This may improve the aberration characteristics of the optical system. If the two lenses of the cemented lens (145) have the same refractive power, the aberration improvement is limited.

The composite refractive power of the cemented lens (145) may have a positive (+) refractive power, and the object side fourth lens (104) and the sensor side fifth lens (105) may have a positive (+) refractive power relative to the cemented lens (145). Accordingly, the fourth lens (104), the cemented lens (145), and the fifth lens (105) can refract some of the incident light in the optical axis direction, and can mutually compensate for chromatic aberrations. The focal length of the fourth lens (104) disposed on the object side relative to the cemented lens (145) may be smaller than the focal length of the fifth lens (105) disposed on the sensor side. The power of the fourth lens (104) disposed on the object side with respect to the cemented lens (145) may be greater than the power of the fifth lens (105) disposed on the sensor side.

The effective diameter of the fourth lens (104) may be larger than the diagonal length of the image sensor (300). The effective diameter of the fourth lens (104) is the average of the effective diameters of the seventh surface (S7) and the eighth surface (S8), and may be larger than the diagonal length of the image sensor (300). The effective diameter of the fifth lens (105) is smaller than the effective diameter of the fourth lens (104) and may be larger than the diagonal length of the image sensor (300).

When the effective diameter of the seventh surface (S7) of the fourth lens (104) is CA_L4S1 and the effective diameter of the eighth surface (S8) is CA_L4S2, the effective diameters of the seventh and eighth surfaces (S7,S8) may satisfy the condition of 1<CA_L4S1/CA_L4S2<1.5. If the effective diameter of the ninth surface (S9) of the fifth lens (105) is CA_L5S1 and the effective diameter of the tenth surface (S10) is CA_L5S2, the effective diameters of the ninth and tenth surfaces may satisfy the condition of 1<CA_L5S1/CA_L5S2<1.5.

The cemented lens (145) is cemented with glass lenses having different refractive indices, and has a spherical refractive surface, and the lenses disposed on the sensor side than the cemented lens (145) may compensate for spherical aberration if aspherical or plastic lenses are employed. Furthermore, if the lenses disposed on the sensor side of the cemented lens (145) are plastic lenses and have smaller effective diameters, they can be set to effectively guide light through the plastic lenses to the image sensor (300). The position of the cemented lens (145) may be located between or behind any two consecutive third to sixth lenses in the lens part (100), such that chromatic aberration correction may be more efficient.

The sixth lens (106) may be disposed sixth from the object side. The sixth lens (106) may be disposed second from the sensor side. The sixth lens (106) may be disposed between the fifth lens (105) and the seventh lens (107). The sixth lens (106) may have a positive (+) or negative (−) refractive power in the optical axis (OA). The sixth lens (106) may have a positive (+) refractive power. The sixth lens (106) may include a plastic or glass material. For example, the sixth lens (106) may be provided in a plastic material.

With respect to the optical axis (OA), the sixth lens (106) may have a convex object-side eleventh surface (S11) and a concave sensor-side twelfth surface (S12). The sixth lens (106) may have a meniscus shape that is convex from the optical axis (OA) to the object side. Alternatively, the sixth lens (106) may have a meniscus shape that is convex on both sides. At least one or both of the eleventh surface (S11) and the twelfth surface (S12) may be aspherical. The asphericity coefficients of the 11th and 12th surfaces (S11,S12) may be provided as L1 and L2 of L6 in FIG. 4.

The eleventh surface (S11) of the sixth lens (106) may be provided without a critical point from the optical axis (OA) to the distal end of the effective region. The 12th surface (S12) may be provided without at least one threshold point from the optical axis (OA) to the distal end of the effective region.

The seventh lens (107) may be disposed closest to the sensor side. The seventh lens (107) may be disposed farthest from the object side. The seventh lens (107) may have a positive (+) or negative (−) refractive power in the optical axis (OA). The seventh lens (107) may have a negative (−) refractive power. The seventh lens (107) may include a plastic or glass material. For example, the seventh lens (107) may be made of plastic.

In the optical axis, the object-side 13th surface (S13) of the seventh lens (107) may be convex and the sensor-side 14th surface (S14) may be concave. The seventh lens (107) may have an object-side convex meniscus shape. At least one of the thirteenth surface (S13) and the fourteenth surface (S14) may be aspherical. For example, both the thirteenth surface (S13) and the fourteenth surface (S14) may be aspherical. The asphericity coefficients of the 13th and 14th surfaces (S13,S14) may be provided as S1,S2 of L7 in FIG. 4.

The thirteenth surface (13) of the seventh lens (107) may have a critical point from the optical axis (OA) to the distal end of the effective region. If the thirteenth surface (S13) has a critical point, it may be located at more than 50% of the effective radius (r71) at the optical axis OA, or in the range of 52% to 70%, or in the range of 53% to 60%. If the 14th surface (S14) has a critical point, it may be located at more than 70% of the effective radius (r72) in the optical axis (OA), or may be located in a range of 70% to 90%, or may be located in a range of 75% to 85%.

The seventh lens (107) may be a plastic lens that is closest to the image sensor (300). Furthermore, by disposing two or more plastic lenses adjacent to the image sensor (300), aberrations such as spherical aberration and chromatic aberration can be improved by the lens surfaces having aspherical surfaces, and the effect on resolution can be controlled. Furthermore, by disposing a plastic lens as the lens adjacent to the image sensor (300), the lens may be insensitive to assembly tolerances compared to a lens made of glass, meaning that even if the lens is assembled with a slight deviation from the design at assembly, the optical performance may not be significantly affected. Furthermore, by providing the two lenses (106, 107) adjacent to the image sensor (300) in plastic, the optical performance can be improved by the aspherical lens surfaces, such as by improving aberration characteristics and avoiding resolution degradation.

The sixth and seventh lenses (106 and 107) are spaced apart, but may include features of a cemented lens. The sixth lens (106) and the seventh lens (107) may have opposite refractive powers. The product of the refractive power of the sixth lens (106) and the refractive power of the seventh lens (107) may be less than zero. The product of the focal length of the sixth lens (106) and the focal length of the seventh lens (107) may be less than zero. Accordingly, the aberration characteristics of the optical system may be improved. If the refractive power of the two lenses having the characteristics of a cemented lens is the same, the aberration improvement is limited.

The sixth lens (106) and the seventh lens (107) may be made of the same material. The sixth lens (106) and the seventh lens (107) may be made of plastic. The sixth lens (106) and the seventh lens (107) may be made of a different material than the zoom lens (145). While the cemented lens (145) is made of glass to improve spherical aberrations, the effectiveness of improving aspherical aberrations caused by plastic lenses is low. Therefore, it is possible to improve aberrations that are not improved by the cemented lens (145) by disposing two additional lenses comprising features of a cemented lens made of a material different from the cemented lens (145).

At least one or both of the thirteenth surface (S13) and the fourteenth surface (S14) of the seventh lens (107) may have critical points. The thirteenth surface (S13) of the seventh lens (107) may have a first critical point (P1) extending from the optical axis (OA) to the distal end of the effective region. The first critical point (P1) of the 13th surface (S13) may be at least 55% of the effective radius from the optical axis (OA), or may be in the range of 55% to 75%, or may be in the range of 60% to 70%. The first critical point of the 13th surface (S13) may be located at a distance of at least 2 mm from the optical axis (OA), such as a distance in the range of 2.1 mm to 2.5 mm, or a distance in the range of 2.2 mm to 2.3 mm. As another example, the thirteenth surface (S13) may be provided without a critical point. The thirteenth surface (S13) having such a first critical point (P1) can refract incident light to the center and periphery, and can improve aberrations. The first and second critical points (P1,P2) are points where the sign of the slope value with respect to the optical axis (OA) and the direction perpendicular to the optical axis (OA) changes from positive (+) to negative (−) or from negative (−) to positive(+), which may mean a point where the slope value is zero. Furthermore, the first and second critical points (P1, P2) may be points at which the slope value of the tangent line passing through the lens surface (plane) decreases from large to small or decreases from small to large.

The 14th surface (S14) of the seventh lens (107) may have at least one second critical point (P2) extending from the optical axis (OA) to the distal end of the effective region. The second critical point (P2) of the 14th surface (S14) may be located at a distance of at least 60% of the effective radius (r72) from the optical axis (OA), or in the range of 60% to 80%, or in the range of 65% to 75%. The second critical point (P2) of the 14th surface (S14) may be located at a distance of more than 2.9 mm from the optical axis (OA), such as in a range of 2.9 mm to 3.9 mm, or in a range of 3.1 mm to 3.7 mm. Accordingly, the second critical point (P2) is positioned closer to the edge than the first critical point (P1), so that the seventh lens (107) can refract the incident light to the periphery of the image sensor (300).

The average effective radius of the 13th and 14th surfaces (S13, S14) of the seventh lens (107) may be disposed to be smaller than Imgh, which is ½ of the diagonal length of the image sensor (300), so that the light can be refracted to the periphery of the image sensor (300) by the 14th surface (S14) having the second critical point (P2).

As shown in FIGS. 2 and 6, Sag41 represents the height from the center of the seventh surface (S7) of the fourth lens (104) to the lens surface in the direction (X, Y) orthogonal to the optical axis (OA), and the maximum value of Sag41 may be the height at the edge of the seventh surface (S7).

Sag42 indicates the height from the center of the eighth surface (S8) of the fourth lens (104) to the lens surface in the direction (X,Y) orthogonal to the optical axis (OA), and the maximum value of Sag42 may be the height at the edge of the eighth surface (S8). Sag52 indicates the height from the center of the ninth surface (S9) of the fifth lens (105) to the lens surface in the direction (X, Y) orthogonal to the optical axis (OA), and the maximum value of Sag52 may be the height at the edge of the ninth surface (S9).

Sag61 indicates a height from the center of the eleventh surface (S11) of the sixth lens (106) to the lens surface in the direction (X,Y) orthogonal to the optical axis (OA), and the maximum value of Sag61 may be a height at the edge of the eleventh surface (S11). Sag62 is the height from the center of the 12th surface (S12) of the 6th lens (106) to the lens surface in the direction (X, Y) orthogonal to the optical axis (OA), and the maximum value of Sag is the height at the edge.

The maximum Sag values can satisfy the following conditions

Max_Sag51<Max_Sag52<Max_Sag41 can be satisfied.

The difference between Max_Sag52 and Max_Sag61 can be 0.4 or less. By setting the Sag value between these adjacent glass and plastic lenses, the light loss between the glass and plastic lenses can be reduced.

In FIG. 6, if the Sag value is positive, the lens face (surface) is located on the sensor side with respect to a straight line orthogonal to the optical axis (OA), and if the Sag value is negative, the lens face is located on the object side with respect to a straight line orthogonal to the optical axis (OA). Furthermore, when comparing the object side and the sensor side of each lens, the object side surface and the sensor side surface of the seventh lens (107) may be the sides with the smallest difference between the maximum and minimum Sag values. This may be because the distance between the object side surface and the sensor side of the seventh lens (107) is constant, and the average of the radii of curvature may be larger than the average of the radii of curvature of the other lenses.

As shown in FIGS. 1 and 2, the center thicknesses of the first to seventh lenses (101 to 107) are denoted by CT1 to CT7, the edge thicknesses at the ends of the effective area of each lens are denoted by ET1 to ET7, the center gaps between two adjacent lenses are denoted by CG1 to CG6, and the edge gaps between the edges of each lens are denoted by EG1 to EG6. Here, the center thickness of the cemented lens (145) is CT45 and the edge thickness is ET45.

Referring to FIG. 2, BFL (back focal length) is the optical axis distance from the image sensor (300) to the center of the last lens. In FIG. 1, TTL is the optical axis distance from the center of the first surface (S1) of the first lens (101) to the top (upper) surface of the image sensor (300).

FIG. 3 is an example of lens data for the optical system of the first embodiment of FIG. 1. As shown in FIG. 3, a radius of curvature in the optical axis (OA) of the first to seventh lenses (101, 102, 103, 104, 105, 106, 107), a thickness of the lens, a distance between the centers of the lenses, a refractive index in the d-line, an Abbe's number, and a size of the clear aperture (CA) can be set.

As shown in FIG. 4, in the first exemplary embodiment, the lens faces of the first, second, sixth, and seventh lenses (101, 102, 106, and 107) of the lenses of the lens part (100) may include an aspherical surface having a 30th order aspheric coefficient. For example, the first, second, sixth, and seventh lenses (101,102,106,107) may include a lens face having a 30th order aspheric coefficient. As described above, an aspheric surface with a 30th order asphericity factor (a value other than ‘0’) can change the aspheric geometry of the periphery particularly significantly, thereby providing good correction of the optical performance of the periphery of the field of view (FOV).

As shown in FIG. 5, a thickness (T1-T7) of the first to seventh lens (101,102,103,104,105,106,107), and a spacing (G1-G6) between two adjacent lenses can be set. As shown in FIG. 5, every 0.1 mm or 0.2 mm or greater interval may be indicated for the thicknesses (T1-T7) of each lens in the y-axis direction, and every 0.1 mm or 0.2 mm or greater interval may be indicated for the spacing (G1-G6) between each lens.

Referring to FIGS. 3 and 5, when comparing the absolute values of the radii of curvature of each lens, the radius of curvature of the 12th surface (S12) of the 6th lens (106) in the optical axis (OA) may be the largest among the lenses, and the radius of curvature of the 10th surface (S10) of the 5th lens (105) may be the smallest among the lenses. The difference between the maximum and minimum radius of curvature may be in the range of 10 times or more, such as 15 times to 38 times.

Describing the center thicknesses of the lenses along the optical axis, the center thickness (CT4) of the fourth lens (104) is the maximum among the lenses, and the center thickness (CT1) of the first lens (101) is the minimum among the lenses. The difference between the maximum and minimum center thicknesses of the lenses may range from 1.5 mm to 2.5 mm or more.

Describing the center spacing (CG) between the lenses, the center spacing (CG6) between the sixth lens (106) and the seventh lens (107) may be a maximum, and the center spacing between the second and third lenses (102, 103) may be a minimum. Here, the minimum center spacing excludes the joined surface of the cemented lens (145). The difference between the maximum center spacing and the minimum center spacing of the spaced apart lenses may be at least 1.5 mm, such as in the range of 2 mm to 3.5 mm. Furthermore, by providing the maximum center spacing between the lenses to be less than or equal to 70% of the maximum center thickness, such as in the range of 30% to 70%, the thickness of the camera module with the plastic lenses having a thin thickness may not be increased without increasing the center spacing relative to the center thickness of each lens.

Describing the effective diameter, the lens with the maximum effective diameter may be disposed between the first lens (101) closest to the object and the seventh lens (107) closest to the image sensor (300). The lens with the maximum effective diameter may be a lens made of plastic. The lens with the maximum effective diameter may be disposed between the first lens (101) and the cemented lens (145). The lens with the maximum effective diameter may be the third lens (103). Here, the effective diameter is the average of the effective diameter of the object side surface of each lens and the effective diameter of the sensor side surface. The lens surface with the maximum effective diameter may be the sixth surface (S6) of the third lens (103) or the object side surface of the cemented lens (145).

The lens having the minimum effective diameter may be any one of the plastic lenses, such as the seventh lens (107) adjacent to the image sensor (300). For example, the effective diameter of the seventh lens (107) may be the minimum within the lens part (100). The lens surface having the minimum effective diameter may be a thirteenth surface (S13) of the seventh lens (107).

The effective diameter of each of the first to fourth lenses (101-104) adjacent to the object side may be larger than the effective diameter of the fifth, sixth, and seventh lenses (105,106,107) adjacent to the sensor side. The effective diameters of the first to fourth lenses (101-104) may be larger than the diagonal length of the image sensor (300). The average effective diameter of the seventh lens (107) may be less than the diagonal length of the image sensor (300). Accordingly, light incident through the plurality of lenses aligned along the optical axis can be guided to the image sensor (300).

In terms of refractive index, the first lens (101) has the maximum refractive index of the lenses, which may be greater than 1.8, such as greater than 1.82. Any or all of the second lens (102) and the sixth lens (106) may have a refractive index that is the minimum among the lenses. For example, it may be less than 1.6, such as less than 1.55. The difference between the maximum refractive index and the minimum refractive index may be greater than or equal to 0.2. By providing a glass material high refractive index lens closest to the object, and a plastic material low refractive index lens adjacent to the glass material lens and the lens adjacent to the image sensor (300), the incidence efficiency can be increased, and the refractive power between the glass material and plastic material lenses can be adjusted to guide light to the image sensor (300).

Comparing the Abbe numbers, the Abbe number of the third lens (103) is the largest of the lenses and may be greater than or equal to 60. The seventh lens has the lowest Abbe number of the lenses, which may be 25 or less. The difference between the maximum refractive index and the minimum Abbe number may be 40 or more. By providing the largest Abbe number for the third lens (103) adjacent to the cemented lens (145) and the smallest Abbe number for the low refractive index seventh lens (107) adjacent to the image sensor (300), the chromatic dispersion of light passing between the glass lenses can be controlled and guided to the image sensor (300) by increasing the chromatic dispersion between the glass and plastic lenses.

The focal lengths (F1,F2,F5,F7) of the first, second, fifth, and seventh lenses (101,102,105,107) may have a negative (−) sign. The first, second, fifth, and seventh lenses (101,102,105,107) may have a negative (−) refractive power. The focal lengths (F3,F4,F6) of the third, fourth, and sixth lenses (103,104,106) may have a positive (+) sign. The third, fourth, and sixth lenses (103,104,106) may have a positive (+) refractive power. On the sensor side of the first and second lenses (101, 102) having a negative (−) refractive power, the third and fourth lenses (103, 104) having a positive (+) refractive power may be disposed. This allows light incident from the object side to be diverted away from the optical axis direction and gathered back towards the optical axis direction, thus forming a stable light path.

Further, the adjacent lenses, the sixth lens (106) and the seventh lens (107), may satisfy the following conditions.
Condition 1: the refractive index of the lens with positive refractive power <the refractive index of the lens with negative refractive power
Condition 2: the variance of the lens with positive refractive power > the variance of the lens with negative refractive power

Here, among the plastic lenses, the sixth lens (106) has a positive refractive power and the seventh lens (107) has a negative refractive power, so that according to conditions 1 and 2, the refractive index of the sixth lens is smaller than the refractive index of the seventh lens, and the variance of the sixth lens is larger than the variance of the seventh lens. The chromatic aberration generated by the plastic lenses can be corrected by the plastic lenses. Furthermore, the chromatic aberration generated by the plastic lens can be compensated by the plastic lens by satisfying the refractive index difference of the sixth lens (106) and the seventh lens (107), which are plastic lenses arranged in succession, of 0.1 or more than 0.15 or less, and the Abbe number difference of 20 or more than 60 or less.

Optical systems are subject to chromatic aberration and compensate for chromatic aberration by using cemented lenses or by using two lenses placed in succession. As the temperature changes from low to high, the lens repeats to contract and expand. Since lenses of the same material have the same amount of change in lens properties as the temperature changes, it is effective to correct chromatic aberration between lenses of the same material even when the temperature changes. Therefore, in the first exemplary embodiment of the present invention, the fourth lens (104) and the fifth lens (105) are used to correct chromatic aberration generated by a lens made of glass, and the sixth lens (106) and the seventh lens (107) are used to correct chromatic aberration generated by a plastic lens.

The chromatic aberration caused by the glass lens can be compensated by the glass lens by satisfying a refractive index difference of at least 0.1 but not more than 0.15 and an Abbe number difference of at least 20 but not more than 60 when the fourth lens (104) and the fifth lens (105) are cemented. The refractive index difference is rounded to the third decimal place, and the Abbe number difference is rounded to the first decimal place to compare the values.

Furthermore, by placing glass lenses with a relatively high Abbe number on the object side of the plastic lenses, the color dispersion can be reduced by the glass lenses and increased by the plastic lenses.

Comparing the focal lengths in absolute value, the focal length of the second lens (102) is the largest among the lenses, and may be 55 or more or 100 or more. Among the lenses, the second lens (102), which is made of plastic, may have the largest focal length and the smallest refractive power. The lens with the largest focal length after the second lens (102) may be the first lens (101) made of glass.

Except for the first lens (101), the focal lengths of the second, sixth, and seventh lenses (102, 106, 107), which are made of plastic, may be larger than the focal lengths of the third, fourth, and fifth lenses (103, 104, and 105), which are made of glass. The focal length of the fifth lens (105) may be the smallest among the lenses, and may be 15 or less, or 10 or less. The fifth lens (105), which is made of glass, may have the smallest focal length and the largest refractive power among the lenses. On the sensor side of the fifth lens (105), a lens made of a plastic material having a small refractive power may be disposed, so that the refractive power of the fifth lens (105) may be increased.

Among the lenses other than the cemented lens (145), the lens having the minimum focal length may be the sixth lens (106). The difference between the maximum focal length and the minimum focal length may be 50 or more or 80 or more. Accordingly, the optical system may have improved MTF characteristics, aberration control characteristics, resolution characteristics, and the like in a set field of view range, and may have good optical performance at the periphery of the field of view.

There is a critical point on the sensor side surface of the seventh lens (107). The critical point is a point at which the trend of the sag value changes, i.e., a point at which the sag value increases and then decreases, or a point at which the sag value decreases and then increases. Referring to FIG. 6, it can be seen that a critical point exists between a point 1.7 mm apart and a point 2.0 mm apart in the direction perpendicular to the optical axis on the object side surface of the 7th lens (107). On the object side surface of the seventh lens (107), the sag value increases to a point 1.8 mm apart in the direction perpendicular to the optical axis, and then decreases from a point 1.8 mm apart in the direction perpendicular to the optical axis to a point 4.2 mm apart in the direction perpendicular to the optical axis.

On the sensor side surface of the seventh lens (107), it can be seen that a critical point exists between a point 3.3 mm apart and a point 3.9 mm apart in the direction perpendicular to the optical axis. On the sensor side surface of the seventh lens (107), the sag value increases to a point 3.4 mm apart in the direction perpendicular to the optical axis, and then decreases from a point 3.4 mm apart in the direction perpendicular to the optical axis to a point 4.6 mm apart in the direction perpendicular to the optical axis. The presence of a critical point on the sensor side surface of the seventh lens (107), i.e., the sensor side surface of the last lens, that is, the lens surface closest to the sensor, enables the TTL to be reduced, thereby facilitating miniaturization and light-weighting of the optical system.

The thickness (T1) of the first lens (101) may range from 1 to 1.2 times the difference between the maximum and minimum thicknesses, such as 1 to 1.2 times or more, with the center thickness (CT1) being the minimum and the edge thickness (ET1) being the maximum. The thickness (T2) of the second lens (102) may range from a maximum thickness of 1 to 1.2 times the minimum thickness. The second lens (102) may have a minimum center thickness (CT2) and a maximum edge thickness (ET2). The thickness (T3) of the third lens (103) may be maximum at the center and minimum at the edges, with the maximum thickness ranging from 1.5 times to 2 times the minimum thickness. The thickness (T4) of the fourth lens (104) may be maximum at the center and minimum at the edges, with the maximum thickness ranging from 1.9 times to 2.2 times the minimum thickness. The thickness (T5) of the fifth lens (105) can be minimum at the center and maximum at the edges, with the maximum thickness ranging from 1.6 times to 1.8 times the minimum thickness. The thickness (T6) of the sixth lens (106) can be maximum at the center and minimum at the edges, with the maximum thickness ranging from 1.4 times to 1.6 times the minimum thickness. The thickness (T7) of the seventh lens (107) may be minimum at the center and maximum at the edges, with the maximum thickness ranging from 1 to 1.2 times the minimum thickness.

The center thickness (CT45) of the cemented lens (145) may be greater than the edge thickness (ET45). The center thickness (CT45) of the cemented lens (145) is the distance from the center of the seventh surface (S7) on the object side of the fourth lens (104) to the center of the tenth surface (S10) of the fifth lens (105), and the edge thickness (ET45) is the distance from the distal end of the effective region of the seventh surface (S7) to the tenth surface (S10) in the optical axis direction. The maximum thickness of the cemented lens (145) is at the center, the minimum thickness is at the edges, and the maximum thickness may range from 1 to 1.2 times the minimum thickness.

Of the gaps (spacings) (G1-G6) between the lenses, the first gap (spacing) (G1) between the first and second lenses (101,102) may be maximum at the center and minimum at the edges. The second gap (G2) between the second and third lenses (102,103) may have a maximum at the edges and a minimum at the center. The third gap (G3) between the third and fourth lenses (103,104) may be maximum at the edges and minimum at the center. The fifth gap (G5) between the fifth and sixth lenses (105,106) may be maximum at the center and minimum at the edges. The sixth gap (G6) between the sixth and seventh lenses (106,107) may have a maximum center and a minimum edge.

As shown in FIG. 7, the chief ray angle (CRA) in the optical system and camera module of FIG. 1 may be in the range of 10 degrees or more, such as in the range of 10 degrees to 35 degrees, or in the range of 10 degrees to 25 degrees, at the 1-field, which is the distal end of the diagonal length of the image sensor. Further, the difference in the CRA from a low temperature (−40 degrees Celsius) to a high temperature (95 degrees C.) may be 1 degree or less. Accordingly, even if the temperature changes from a low temperature to a high temperature, the difference in CRA is not large and stable optical performance can be achieved. In the optical system according to the first exemplary embodiment, as shown in FIG. 14, a graph showing the ambient light ratio or relative illumination according to the image height, it can be seen that the ambient light ratio is 70% or more, such as 75% or more, from the center of the image sensor to the distal end of the diagonal. In other words, it can be seen that the difference between the ambient light ratio according to the temperature at normal temperature, low temperature, and high temperature (Zoom positions 1, 2, and 3) is almost no difference up to 4.5 mm or more from the optical axis.

FIGS. 8 to 10 are graphs of the diffraction modulation transfer function (MTF) at room temperature, low temperature, and high temperature in the optical system of FIG. 1, showing the luminance ratio (modulation) as a function of spatial frequency. As shown in FIGS. 8 to 10, in a first exemplary embodiment of the present invention, the deviation of the MTF from room temperature to low or high temperature may be less than 10%, such as 7% or less.

FIGS. 11 to 12 are graphs of aberration characteristics at room temperature, low temperature, and high temperature for the optical system of FIG. 1. In the aberration graphs of FIGS. 11 to 13, Longitudinal Spherical Aberration, Astigmatic Field Curves, and Distortion are measured from left to right. In FIGS. 11 to 13, the X-axis may represent the focal length (mm) and distortion (%), and the Y-axis may represent the height of the image. Furthermore, the graphs for spherical aberration are graphs for light in the wavelength band of about 435 nm, about 486 nm, about 546 nm, about 587 nm, and about 656 nm, and the graphs for astigmatism and distortion aberration are graphs for light in the wavelength band of about 546 nm. From the aberration diagrams of FIGS. 11 to 13, it can be interpreted that the closer each curve is to the Y-axis at room temperature, low temperature, and high temperature, the better the aberration correction capability, and it can be seen that the optical system (1000) according to the embodiment has measured values close to the Y-axis in almost all areas. In other words, the optical system (1000) according to the first embodiment has improved resolution and can have good optical performance not only in the center of the field of view (FOV) but also in the periphery. Here, the low temperature may be in the range of −20 degrees Celsius or less, such as in the range of −20 to −40 degrees Celsius, the room temperature may be in the range of 22 degrees Celsius ±5 degrees Celsius or in the range of 18 degrees Celsius to 27 degrees Celsius, and the high temperature may be in the range of 85 degrees Celsius or more, such as in the range of 85 degrees Celsius to 105 degrees Celsius. Accordingly, it can be seen that the degradation of the luminance ratio modulation from low temperature to high temperature of FIGS. 11 to 13 is less than 10%, such as 5% or less, or is virtually unchanged.

Table 1 compares the changes of optical properties such as EFL, BFL, F number (F #), TTL, and field of view (FOV) at room temperature, low temperature, and high temperature in an optical system according to the first embodiment, and it can be seen that the change rate of optical properties at low temperature is 5% or less, such as 3% or less, relative to room temperature, and the change rate of optical properties at high temperature is 5% or less, such as 3% or less, relative to room temperature.

TABLE 1

| | | | | Low | High |
|---|---|---|---|---|---|
| | | | | temper- | temper- |
| | Room | Low | High | ature/Room | ature/Room |
| | temper- | temper- | temper- | temper- | temper- |
| | ature | ature | ature | ature | ature |
| EFL(F) | 15.1 | 15.044 | 15.167 | 99.63% | 100.44% |
| BFL | 2.869 | 2.865 | 2.852 | 99.87% | 100.14% |
| F# | 1.600 | 1.594 | 1.607 | 99.63% | 100.44% |
| TTL | 32.045 | 31.990 | 32.109 | 99.82% | 100.20% |
| FOV | 34.039 | 34.160 | 33.896 | 100.35% | 99.57% |

Thus, as shown in Table 1, it can be seen that the change in optical properties, such as the change in effective focal length (EFL), TTL, BFL, F number, and field of view (FOV), due to a change in temperature from low to high temperature, is in the range of 0 to 5%, such as 5% or less. This enables the design of a temperature compensation for the plastic lens, even when at least one or more layers of plastic lenses are used, to prevent deterioration in the reliability of the optical properties.

The optical system of the first embodiment disclosed above can effectively control aberration characteristics such as chromatic aberration and distortion aberration, and can have good optical performance not only in the center of the field of view (FOV) but also in the periphery.

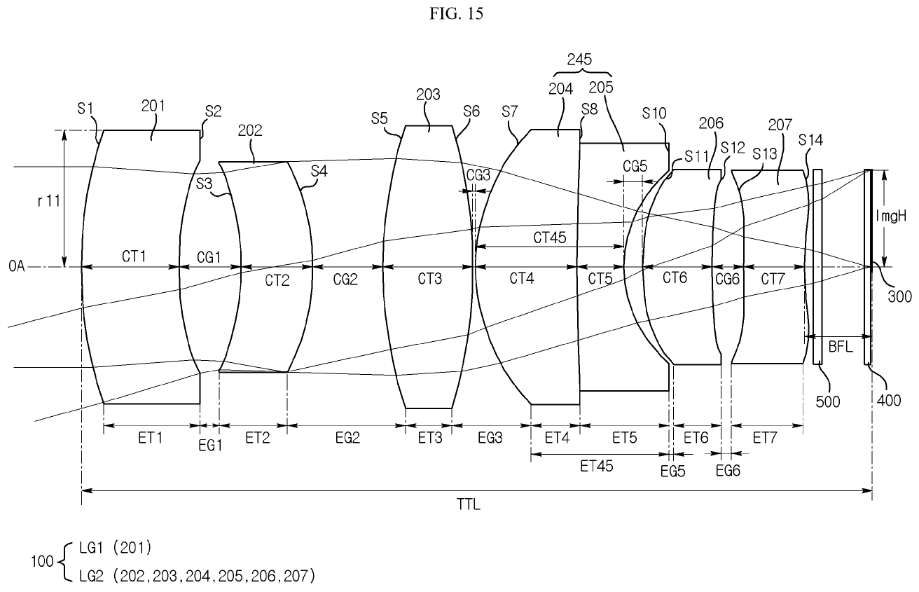

As shown in FIG. 15, the optical system (2000) according to a second exemplary embodiment of the present invention may comprise five or more lenses. The optical system (2000) and the camera module thereof may be mounted inside or outside a vehicle, for driver surveillance or for sensing external objects or lanes. The lenses may be made of glass or plastic, with glass having a smaller coefficient of linear expansion than plastic. Therefore, glass lenses are adopted to suppress the change of the focus image-forming position due to temperature changes. However, glass lenses are expensive compared to plastic lenses, and it is difficult to respond to the need for low cost. Therefore, lenses in the optical system (2000) are required to be composed of a mixture of glass and plastic lenses. By employing such plastic lenses, the optical system (2000) may provide light weight and low cost due to the reduced thickness of the plastic lenses, and the plastic lenses may provide good correction for various aberrations such as spherical aberration and chromatic aberration. The plastic lenses may also provide aspherical lenses, which may minimize distortion at the periphery.

The optical system (2000) may include n lenses, wherein the nth lens may be the last lens adjacent to the image sensor (300), and the n-1st lens may be the lens closest to the last lens. n may be an integer greater than or equal to 5, such as 5 to 8. The n lenses may have a ratio of lenses made of plastic to lenses made of glass in a range of 2:3 to 2:6, or in a range of 3:4 to 3:5.

The optical system (2000) may comprise a plurality of lens groups (LG1, LG2). More specifically, each of the plurality of lens groups (LG1,LG2) may include at least one lens. For example, the optical system (2000) may include a first lens group (LG1) and a second lens group (LG2) disposed sequentially along the optical axis (OA) from the object side towards the image sensor (300).

Each of the first lens group (LG1) and the second lens group (LG2) may have a different number of lenses. The number of lenses in the second lens group (LG2) may be greater than the number of lenses in the first lens group (LG1), for example, greater than four times the number of lenses in the first lens group (LG1) or greater than five times the number of lenses in the first lens group (LG1). The first lens group (LG1) may comprise at least one lens. The first lens group (LG1) may have three or fewer lenses. Preferably, the first lens group (LG1) may be a single lens. The second lens group (LG2) may comprise two or more lenses. The second lens group (LG2) may comprise between four and seven lenses. Preferably, the second lens group (LG2) may comprise six lenses.

The first lens group (LG1) may comprise at least one lens made of plastic. The first lens group (LG1) may comprise at least one lens made of glass. The first lens group (LG1) may comprise a lens made of plastic that is closest to the object side. By increasing the number of plastic lenses included in the optical system (2000), mass production can be increased, light weight can be reduced, and price competitiveness can be achieved.

The lens material of the second lens group (LG2) may be a mixture of at least one glass lens and at least one plastic lens. In the second lens group (LG2), the at least one plastic lens may be disposed closer to the sensor than the glass lens. The second lens group (LG2) may comprise more than two glass lenses, such as between two and four glass lenses. The second lens group (LG2) may comprise, for example, between two and six lenses. As another example, the second lens group (LG2) may have at least one lens made of plastic. The second lens group (LG2) may comprise more than two plastic lenses, such as two to four plastic lenses.

The at least 15 lenses closest to the object in the optical system (2000) may be made of glass. Three or more of the lenses closest to the object, such as three to five lenses, may be glass. Since glass lenses have a smaller rate of change of contraction and expansion with temperature change than plastic lenses, glass lenses may be placed in externally adjacent areas within the lens barrel.

The at least one lens closest to the image sensor (300) within the optical system (2000) may be made of plastic. For example, the at least two lenses closest to the image sensor (300) may be plastic, and preferably the at least two lenses adjacent to the image sensor (300) may be plastic. In other words, the nth and n-1st lenses in the optical system (2000) may be disposed as plastic lenses to compensate for various aberrations in the light incident on the image sensor (300).

Within the optical system (2000), the plastic lenses may be continuously arranged (back-to-back), and the glass lenses may be arranged continuously (back-to-back). Within the optical system (2000), lenses made of plastic may be disposed between lenses made of glass. Within the optical system (2000), the glass lenses may be disposed between the plastic lenses.

Each lens (201-207) may have an object side surface and a sensor side surface. In an optical system, the number of lenses having an aspherical sensor side surface and an aspherical object side surface may be greater than the number of plastic lenses. The optical system may have a spherical sensor side surface and a spherical object side surface, and the number of lenses may be less than the number of lenses that are aspherical on both sides. The optical system (2000) may have more aspherical lenses than spherical lenses to compensate for various aberrations.

Within the optical system (2000), the lenses with the largest effective diameters may be disposed at the center of the object side and the sensor side. From the object side to the sensor side, the effective diameter of the lens may increase and decrease. As the lens moves from the object side to the sensor side, the effective diameter of the lens may become smaller, then larger, then smaller again. This allows the optical system (2000) to form a stable optical path because the light incident on the optical system (2000) is directed away from the optical axis and then converges back to the optical axis.

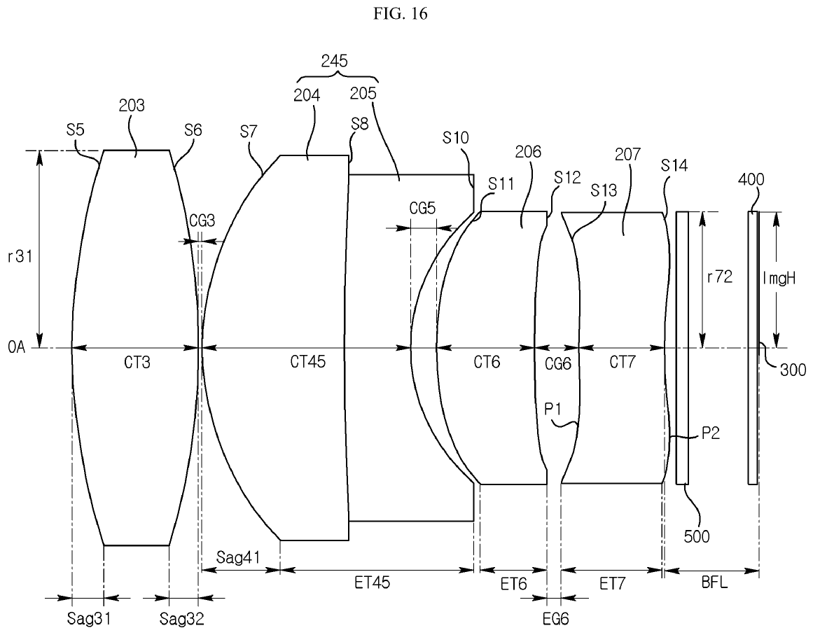

The effective diameter may be a diameter of the effective region in which light is incident on each lens. The effective diameter is the length in the direction (X,Y) orthogonal to the optical axis, and is the average of the effective diameter of the object side surface of each lens and the effective diameter of the sensor side surface. ‘Diameter of the lens (sur)face’ may mean “effective diameter of the lens”. The ‘diameter of the lens’ may be the diameter of the entire lens, including the flange portion of the lens in addition to the effective region of the lens. Although the flange of the lens is not shown in FIGS. 15 and 16, the flange may be a portion projecting perpendicular to the optical axis from the side of the lens for coupling the lens to the barrel. The flange may not receive effective light. Additional spacers may be disposed between the flanges of different lenses to allow the lenses to be coupled to the barrel.

Each of the lenses (201-207) may include an effective region and an ineffective region. The effective region may be a region through which light incident on each of the lenses passes, i.e., the effective region may be defined as the effective region or effective diameter through which the incident light is refracted to produce optical properties. The ineffective region may be disposed around the perimeter of the effective region. The ineffective region may be a region where no effective light is incident on the plurality of lenses, i.e., the ineffective region may be a region irrelevant to the optical properties. Further, a distal end of the ineffective region may be a region fixed to a lens barrel or the like that receives the lens.

Within the optical system (2000), the total top length (TTL) may be more than twice as long as the Imgh, such as more than four times as long and less than twelve times as long. The total track length (TTL) is the distance in the optical axis (OA) from the center of the object side surface of the first lens to the upper (top) surface of the image sensor 300. Imgh is the distance in the optical axis (OA) to the diagonal end of the image sensor (300), or ½ of the maximum diagonal length. Within the optical system (2000), an effective focal length (EFL) of at least 10 mm and a field of view (FOV) of less than 45 degrees can be provided, which can be provided by a standard optical system in an automotive camera module. For example, the optical system and camera module according to an embodiment may be applied to a camera for an Advanced Driving Assistance System (ADAS), either in the interior or exterior of a vehicle.

The optical system (2000) may have a TTL/Imgh condition of at least 5 and at least 7.5, such as at least 6 and at least 7. By allowing the optical system (2000) to set a value of TTL/Imgh to be greater than or equal to 5 and less than or equal to 7.5 times, an automotive lens optical system may be provided. The total number of lenses in the first and second lens groups (LG1,LG2) may be 8 or less. Accordingly, the optical system (2000) may provide an image that is free of exaggeration or distortion for the image being resolved.

The effective diameter of the at least one plastic lens in the optical system (2000) may be smaller than the length of the image sensor (300). The effective diameter is the diameter or length of the effective region through which light is incident. The length of the image sensor (300) is the maximum length of a diagonal in a direction orthogonal to the optical axis (OA). Within the optical system (2000), the number of lenses having an effective diameter greater than the length of the image sensor (300) may be greater than 50% or greater than 60%, and the number of lenses having an effective diameter less than the length of the image sensor (300) may be less than 50% or less than 40%.

The optical system (2000) may include at least one cemented lens (245) thereinside. The cemented lens (245) is a cementation of at least two lenses having different refractive powers, wherein the gap (spacing) between the two lenses may be less than 0.01 mm. The cemented lens 245 may be a lens in which two lenses with different focal lengths are laminated. The joining of the two lenses may be bonded with an adhesive. The effective diameter of at least one lens or all lenses disposed on the object side relative to the cemented lens (245) may be greater than the length of the image sensor (300). The effective diameter of at least one lens disposed on the sensor side relative to the cemented lens (245) may be less than the length of the image sensor (300). Also, the object-side lens (203) of the cemented lens (245) may be larger than the length of the image sensor (300), and the sensor-side lens (204) may be larger than the length of the image sensor (300).

The lenses between the cemented lens (245) and the first lens (201) may be made of glass or plastic. The lenses disposed between the cemented lens (245) and the image sensor (300) may be made of plastic. The lenses between the cemented lens (245) and the first lens (201) may be spherical on both surfaces or aspherical on both surfaces. The lenses disposed between the cemented lens (245) and the image sensor (300) may be aspherical lenses on both surfaces. The two surfaces are the object side surface and the sensor side surface. Thus, by disposing the aspherical lenses between the cemented lens (245) and the image sensor (300), the optical performance can be improved by correcting curvature aberrations and chromatic aberrations.

In the optical axis (OA), the first lens group (LG1) and the second lens group (LG2) may have a set spacing. The optical axis spacing between the first lens group (LG1) and the second lens group (LG2) in the optical axis (OA) may be an optical axis spacing between the sensor side surface of the lens closest to the sensor side among the lenses in the first lens group LG1 and the object side surface of the lens closest to the object side among the lenses in the second lens group (LG2). The optical axis spacing between the first lens group (LG1) and the second lens group (LG2) may be less than or equal to 1 times the optical axis distance of the first lens group (LG1), such as in a range of 0.1 times to 1 times the optical axis distance of the first lens group (LG1).

The optical axis distance between the first lens group (LG1) and the second lens group (LG2) may be less than or equal to 0.2 times the optical axis distance of the second lens group (LG2), such as in the range of 0.01 times to 0.2 times. The optical axis distance of the second lens group (LG2) is the optical axis distance between the object side surface of the lens closest to the object side of the second lens group (LG2) and the sensor side surface of the lens closest to the image sensor (300).

Here, among the lens surfaces of the first lens group (LG1) and the second lens group (LG2), two surfaces facing each other, for example, the sensor side surface of the object side lens may be concave and the object side surface of the sensor side lens may be concave, i.e., the sensor side surface closest to the sensor side in the first lens group (LG1) may be concave and the object side surface closest to the object side in the second lens group (LG2) may be concave. The first lens group (LG1) may diffuse the light incident through the object side, and the second lens group (LG2) may refract the light diffused through the first lens group (LG1) into a region of the image sensor (300).

The first lens group (LG1) may have a negative (−) refractive power and the second lens group (LG2) may have a positive (+) refractive power. Among the lenses of the first lens group (LG1), the lens closest to the object side may have a negative (−) refractive power, and among the lenses of the second lens group (LG2), the lens closest to the sensor side may have a negative (−) refractive power. Expressing the focal length in absolute value, the focal length of the first lens group (LG1) may be greater than the focal length of the second lens group (LG2), such as more than 2 times, such as in the range of 50 times to 100 times. The effective focal length (EFL) of the optical system (2000) may be less than an absolute value of the focal length of the first lens group (LG1). The effective focal length EFL of the optical system (2000) may be less than the absolute value of the focal length of the first lens group (LG1) and greater than the absolute value of the focal length of the second lens group (LG2).

Within the optical system (2000), the number of lenses having a positive (+) refractive power may be equal to or greater than the number of lenses having a negative (−) refractive power. The number of lenses with positive (+) refractive power may be 50% or more of the total number of lenses. The average refractive index of the lenses with negative (−) refractive power may be greater than the average of the lenses with positive (+) refractive power. As a result, the variance of the lenses with positive (+) refractive power may be greater than the variance of the lenses with negative (−) refractive power.

The lens portion (200) may comprise a mixture of glass and plastic lenses. The number of plastic lenses may be 60% or less of the total number of lenses, such as in a range of 30% to 60%, or in a range of 30% to 57%. Accordingly, when more plastic lenses are disposed in the camera module, the weight of the camera module can be reduced, and the plastic material can be easily polished, processed, and resistant to external impact, and the price is competitive and the material is easy to secure. Furthermore, various aberrations can be corrected by the plastic lens, thus preventing deterioration of optical performance.

Embodiments of the invention may further incorporate plastic lenses in the optical system (2000), which may reduce the weight of the camera module, may provide lower manufacturing costs, may suppress degradation of optical properties due to temperature changes, may allow various types of plastic lenses to replace glass lenses, and may facilitate polishing and processing of lens faces such as aspherical or free curved faces.

The lens part (200) may include lenses of a first material disposed along the optical axis (OA), and lenses of a second material. The first material may be glass, and the second material may be plastic. The first material lens may be disposed between the second material lenses. The lenses of the second material may be disposed between the lenses of the first material.

The lens part (200) may include a second material lens having an aspherical surface along the optical axis (OA), a first material lens having a spherical surface, and a second material lens having an aspherical surface. The first material may be a glass material and the second material may be a plastic material.

Within the lens part (200), the effective diameter of the lens closest to the object side may be larger than the effective diameter of the lens closest to the image sensor (300). Thus, the brightness of the optical system can be controlled. The effective diameter may be the average effective diameter of the object side surface and sensor side surface of each lens. By controlling the effective diameter size of each lens, the optical system (2000) can control the incident light to compensate for degradation of optical properties due to changes in resolving power, temperature, improve chromatic aberration control characteristics, and improve vignetting characteristics of the optical system (2000).

The lens part (200) may include a first lens 201, a second lens 202, a third lens 203, a fourth lens 204, a fifth lens 205, a sixth lens 206, and a seventh lens 207 aligned along an optical axis from the object side toward the sensor side.

The number of lenses in the lens part (200) that are larger than the average effective diameter of the plastic lenses may be three or more, such as four or more. If the average effective diameter of the plastic lenses is PLca_Aver and the average effective diameter of the glass lenses is GLca_Aver, the condition PLca_Aver<GLca_Aver may be satisfied. Also, the condition of 1<GLca_Aver/PLca_Aver<1.5 may be satisfied. Furthermore, the relationship between the length of the image sensor (300) and the average effective diameter (PLca_Aver) of the plastic lens may satisfy the condition of 1≤PLca_Aver/(Imgh*2)<1.5. Further, the relationship between the average effective diameter of the glass material and the length of the image sensor (300) may satisfy the condition of 1.1<GLca_Aver/(Imgh*2)<1.5. The difference between the maximum length of the image sensor (300) and the effective diameter of the plastic lens may be arranged to be insignificant. Accordingly, by disposing a plastic lens having a small effective diameter adjacent to the image sensor (300), the plastic lens can distribute color from the center of the image sensor (300) to the periphery.

The glass material may have an average effective diameter of at least 10 mm, such as in the range of 10 mm to 15 mm. The plastic material may have an average effective diameter of at least 8 mm, such as in the range of 8 mm to 12 mm. The lens having the minimum effective diameter may be made of plastic, and the lens having the maximum effective diameter may be made of glass. Within the lens part (200), the minimum effective diameter may be in the range of 7 mm to 10 mm, and the maximum effective diameter may be in the range of 11 mm to 15 mm. A lens made of plastic may be designed with a smaller effective diameter than a lens made of glass so that it can be positioned away from the lens barrel, thereby minimizing changes in optical performance due to changes in temperature. In addition, the optical system (2000) may control the incident light to improve the resolution, chromatic aberration control characteristics, and improve the vignetting characteristics of the optical system (2000).

The optical system (2000) or camera module may include an image sensor (300). The image sensor (300) can detect light and convert it into an electrical signal. The image sensor (300) may detect light that has passed sequentially through the lens part (200). The image sensor (300) may include an element capable of detecting incident light, such as a charge coupled device (CCD) or a complementary metal oxide semiconductor (CMOS).

Here, the length of the image sensor (300) is a maximum length in a diagonal direction orthogonal to the optical axis (OA) and may be less than the effective diameter of the lens closest to the object within the first lens group (LG1) and greater than the effective diameter of the lens closest to the sensor within the second lens group (LG2). Here, the number of lenses having an effective diameter larger than the length of the image sensor (300) may be from 4 to 6, and the number of lenses having an effective diameter smaller than the length of the image sensor (300) may be from 1 to 3.

The optical system (2000) or camera module may include a filter (500). The filter (500) may be disposed between the second lens group (LG2) and the image sensor (300). The filter (500) may be disposed between the lens closest to the sensor side of the lenses of the lens part (200) and the image sensor (300). For example, the filter (500) may be disposed between the nth lens and the image sensor (300).

The cover glass (400) may be disposed between the filter (500) and the image sensor (300), and may protect the top of the image sensor (192) and prevent the image sensor (192) from degrading in reliability. The cover glass (400) may be removable. The cover glass (400) may be a protective glass.

The filter (500) may include an infrared filter or an infrared cut-off filter (IR cut-off). The filter (500) may allow light of a set wavelength band to pass through and filter out light of a different wavelength band. If the filter (500) includes an infrared filter, it can block radiant heat emitted from external light from reaching the image sensor (300). Further, the filter (500) can transmit visible light and reflect infrared light.

The optical system (2000), according to an exemplary embodiment, may include an aperture. The aperture may adjust the amount of light incident on the optical system (2000). For lenses disposed between the object and the aperture, the effective diameter of the lens surface tends to increase from the object side toward the aperture. For lens surfaces placed between the aperture and the sensor, the effective diameter of the lens surfaces tends to decrease from the aperture to the sensor side. The meaning that the effective diameters of the lens surfaces tend to increase or decrease does not mean only that the effective diameters of the lens surfaces increase or decrease. For example, the effective diameter of the lens surfaces may increase and then decrease as one moves from the aperture to the sensor side.

The aperture may be disposed in a set position. For example, the aperture may be disposed around the perimeter of the object side surface or sensor side surface of the lens of the second lens group (LG2) that is closest to the object side. Alternatively, the aperture may be disposed around the periphery of the object side surface or sensor side surface of the object-facing lens of the first lens group (LG1). Alternatively, at least one lens selected from the plurality of lenses may act as an aperture. More specifically, the object-side surface or sensor-side surface of the at least one lens selected from the plurality of lenses of the optical system (2000) may act as an aperture to regulate the amount of light.

In the optical system (2000) according to the exemplary embodiment of the present invention, the sum of the refractive indices of the lenses of the lens part (200) may be at least 8, such as in the range of 8 to 15, and the average of the refractive indices may be in the range of 1.58 to 1.7. The sum of the Abbe numbers of each of the lenses may be greater than or equal to 300, such as in the range of 310 to 350, and the average of the Abbe numbers may be less than or equal to 50, such as in the range of 35 to 47. The sum of the center thicknesses of all the lenses may be in the range of 18 mm or more, such as in the range of 20 mm to 25 mm, and the average of the center thicknesses may be in the range of 2.8 mm to 3.5 mm. The sum of the center spacing (gap) between the lenses on the optical axis (OA) may be at least 6 mm, such as in the range of 6.8 mm to 8 mm, and may be less than the sum of the center thicknesses of the lenses. Further, an average value of the effective diameter of each lens surface (S1-S14) of the lens part (200) may be provided in a range of 8 mm or more, such as in a range of 8 mm to 15 mm.

In an optical system according to an embodiment of the present invention, the field of view (diagonal) may be 50 degrees or less, such as in the range of 20 degrees to 50 degrees. The F-number of the optical system or camera module may be 2.4 or less, such as in the range of 1.4 to 2.4, or in the range of 1.5 to 1.8. In an optical system according to an embodiment of the present invention, the maximum field of view (diagonal) may be 50 degrees or less, such as in the range of 20 degrees to 50 degrees.

In the automotive optical system, the horizontal field of view (FOV_H) in the Y-axis direction may be greater than 20 degrees and less than 40 degrees, such as in the range of 25 degrees to 35 degrees. In addition, the vertical field of view may be provided at a smaller angle than the horizontal field of view, and may be less than 20 degrees, such as in the range of 10 degrees to 20 degrees. In this case, the sensor length in the horizontal direction (Y) may be 8.064 mm ±0.5 mm, and the sensor height in the vertical direction (X) may be 4.54 mm ±0.5 mm. The horizontal field of view (FOV_H) is the field of view based on the horizontal length of the sensor. Accordingly, the change of the focus image-forming position due to a change in temperature can be suppressed, and a vehicle camera can be provided with good correction of various aberrations.

Since the embodiment is an optical system applied to a vehicle camera, the object side surface of the first lens (201) may have a gently curved surface shape to better prevent scratches caused by foreign objects placed inside the vehicle and to avoid contact with external structures. This may minimize the occurrence of scratches due to contact with external structures. The field of view may be greater than 20 degrees and less than 40 degrees, such as in the range of 25 degrees to 35 degrees, for driver surveillance during vehicle operation, front and rear views of the vehicle, or lane detection and detection of unexpected objects around the vehicle. Such a horizontal field of view may be a preset angle for an advanced driver assistance system (ADAD).

The optical system (2000), according to an embodiment, may further comprise a reflective member for rerouting light. The reflective member may be implemented as a prism that reflects incident light from the first lens group LG1 in the direction of the lenses. In the following, the optical system according to an exemplary embodiment will be described in detail.

The optical system according to a second exemplary embodiment of the present invention will be described.

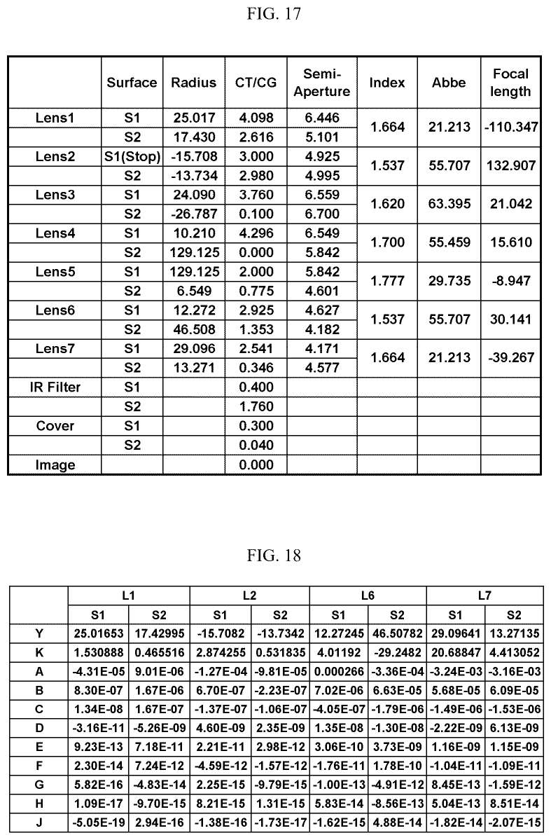

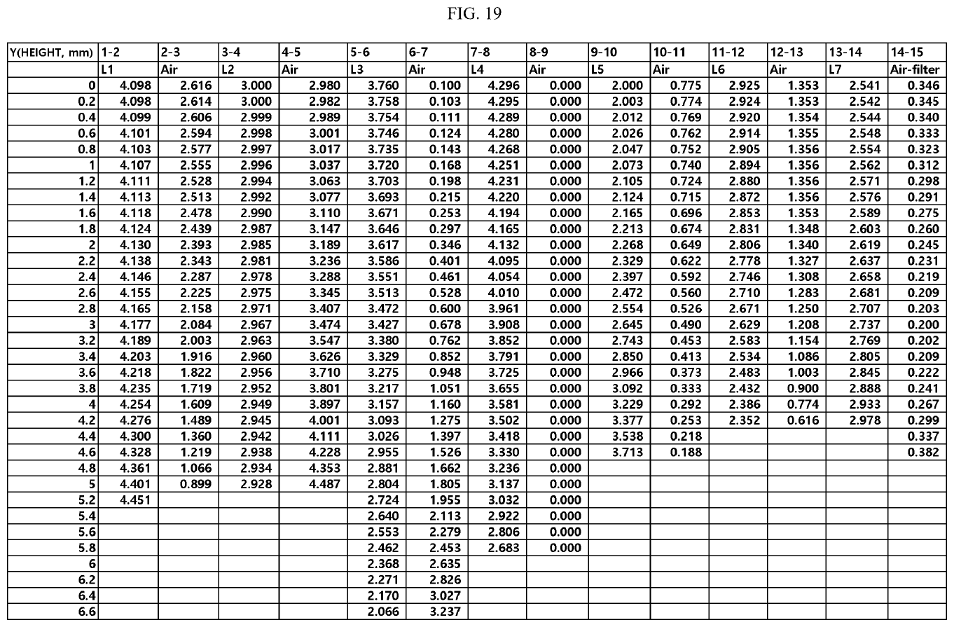

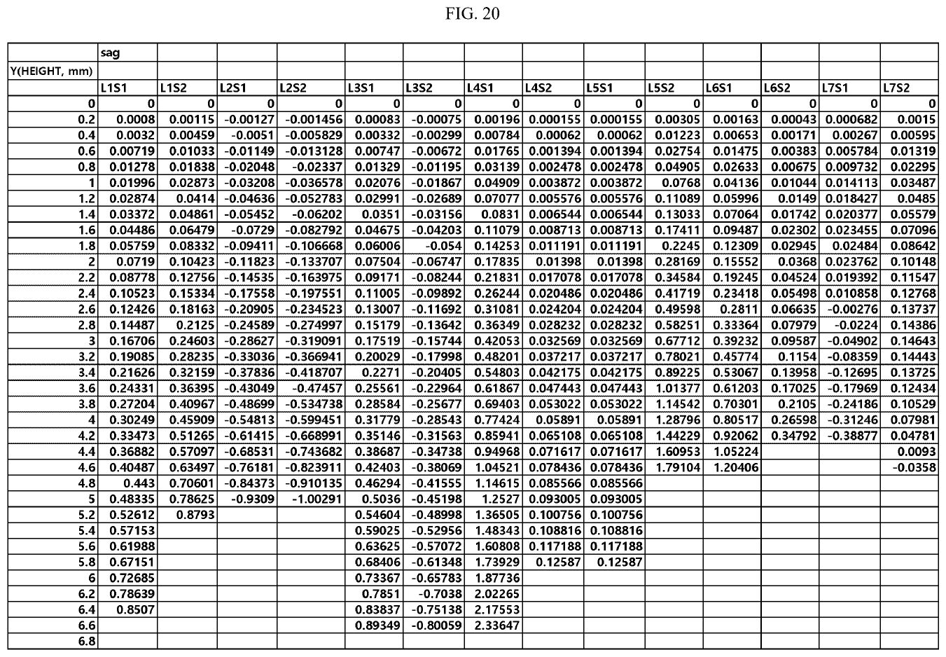

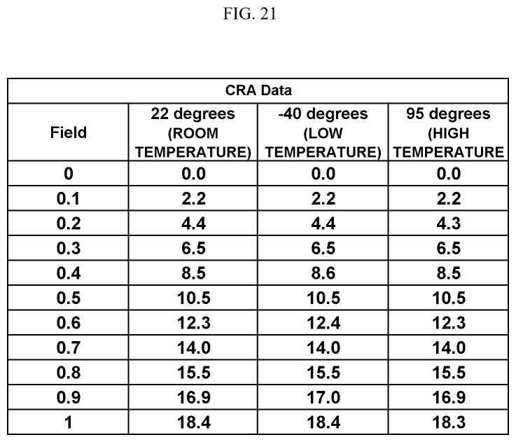

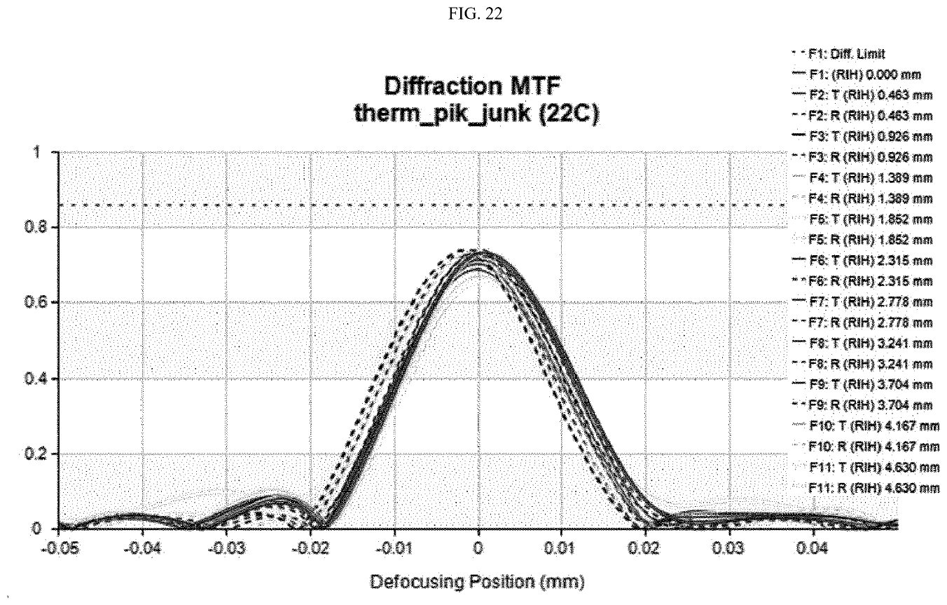

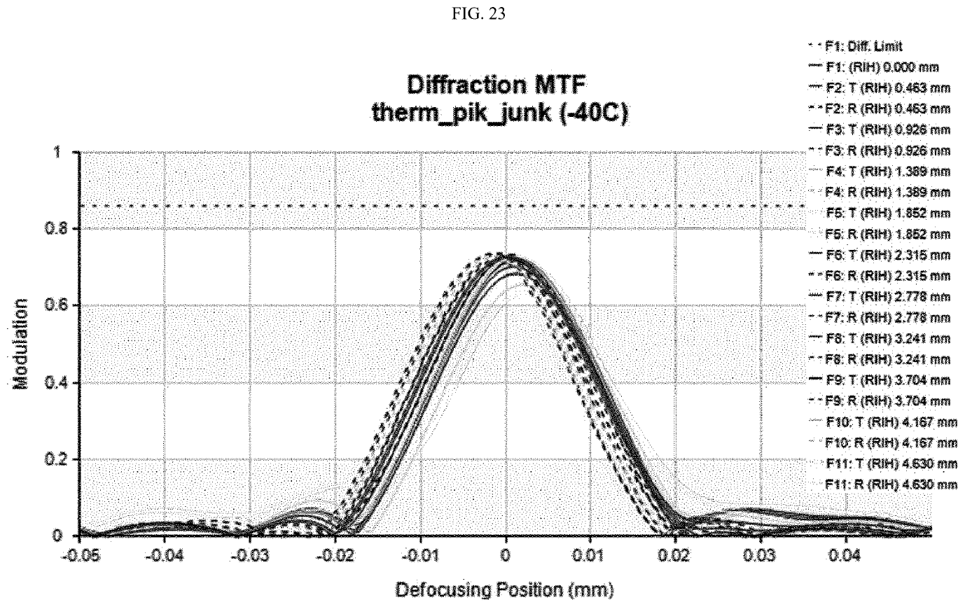

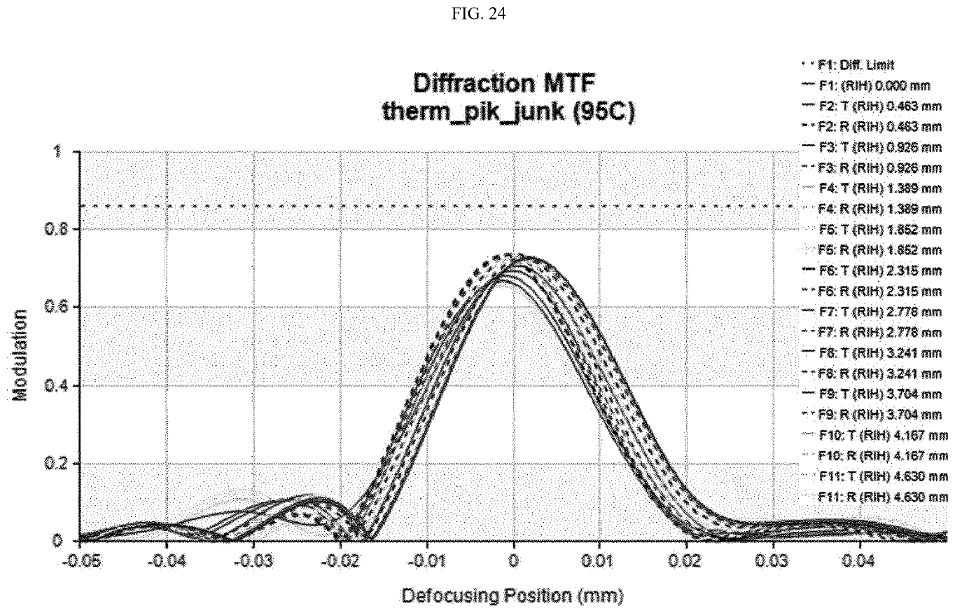

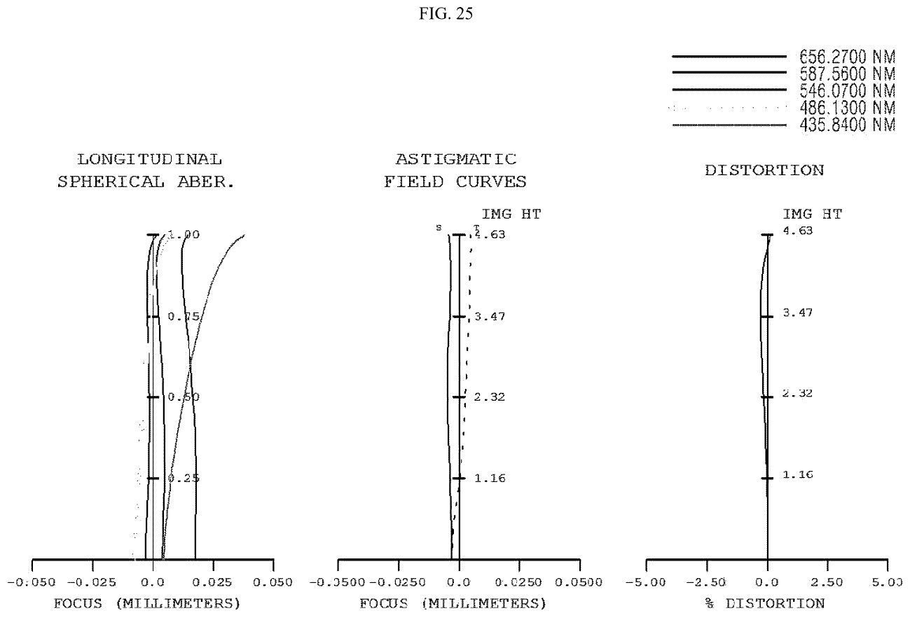

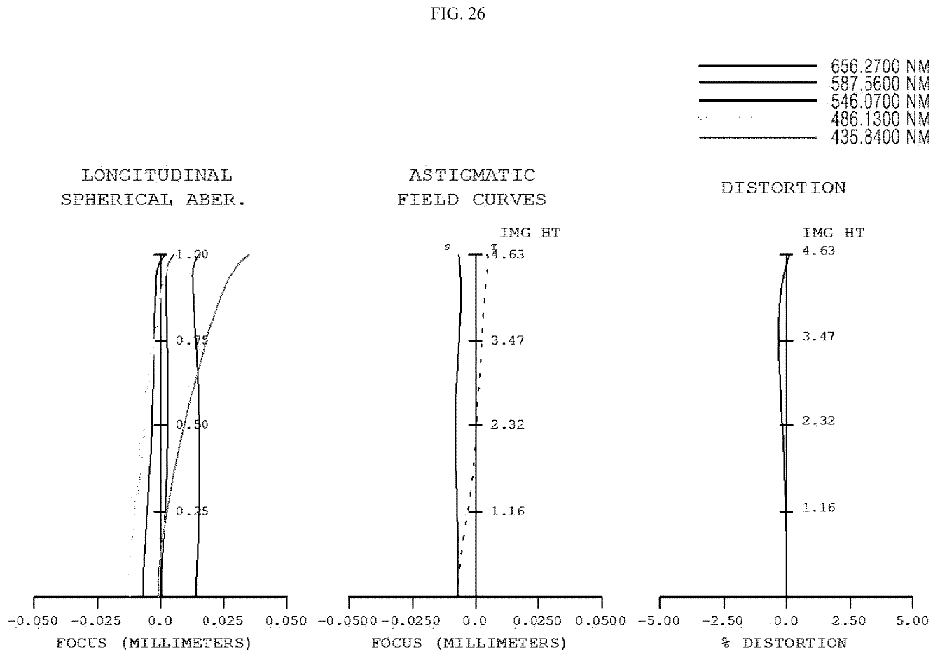

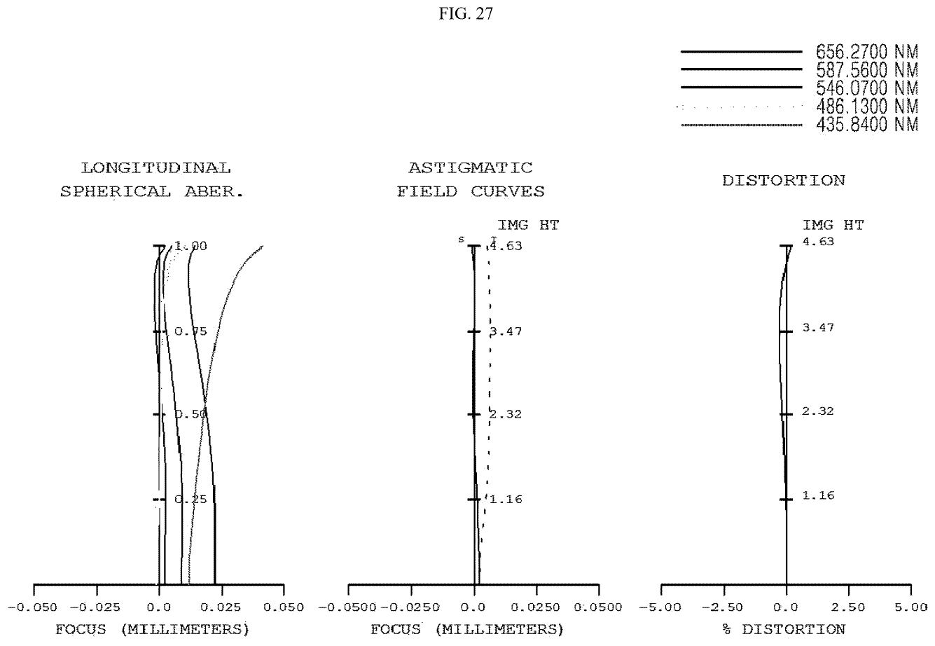

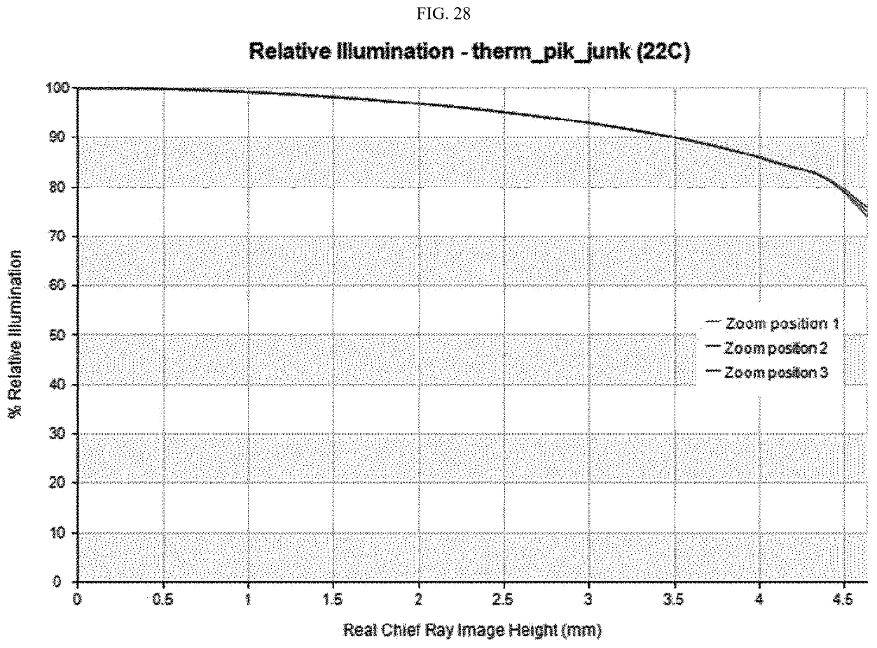

FIG. 15 is a side cross-sectional view of an optical system and a camera module thereof according to a second embodiment, FIG. 16 is a side cross-sectional view to illustrate the relationship of the nth and n-1st lenses according to FIG. 15, FIG. 17 is a table showing lens characteristics of the optical system of FIG. 15, FIG. 18 is a table showing the aspheric coefficients of the lenses in the optical system of FIG. 15, FIG. 19 is a table showing the thickness of each lens of the optical system of FIG. 15 and the spacing between adjacent lenses, FIG. 20 is a table showing the Sag values of the lens faces of the third to sixth lenses of the optical system of FIG. 15, FIG. 21 is a table showing data for the chief ray angle (CRA) at room temperature, low temperature, and high temperature based on the position of the image sensor in the optical system of FIG. 15, FIG. 22 is a graph showing data for the diffraction MTF (Modulation Transfer Function) at room temperature for the optical system of FIG. 15, FIG. 23 is a graph showing data for the diffraction MTF at low temperature for the optical system of FIG. 15, FIG. 24 is a graph showing data for the diffraction MTF at high temperature of the optical system of FIG. 15, FIG. 25 is a graph showing data for the aberration characteristics at room temperature of the optical system of FIG. 15, FIG. 26 is a graph showing data for the aberration characteristics at low temperature of the optical system of FIG. 15, FIG. 27 is a graph showing data for the aberration characteristics at high temperature of the optical system of FIG. 15, and FIG. 28 is a graph showing relative illuminance based on height of the image sensor according to a second exemplary embodiment.

Referring now to FIGS. 15 to 18, the optical system (2000) may include a lens part (200), which may include a first lens (201) to a seventh lens (207). The first to seventh lenses (201 to 207) may be sequentially disposed along an optical axis (OA) of the optical system (2000). Light corresponding to information about an object may be incident on the image sensor (300) after passing through the first lens (201) to the seventh lens (207) and the filter (500).

The first lens (201) may be the lens closest to the object side in the first lens group (LG1). The seventh lens (207) may be the lens closest to the image sensor (300) in the second lens group (LG2) or lens part (200). The first lens (201) may be the first lens group (LG1), and the second to seventh lens (202, 203, 204, 205, 206, 207) may be the second lens group (LG2). An aperture may be disposed on either the periphery of the object side or sensor side surface of the first lens (201) or the periphery of the object side surface or sensor side surface of the second lens (202). For example, the aperture (stop) may be disposed on the periphery of the object side surface of the second lens (202).

The first lens (201) may be disposed closest to the object side. The first lens (201) may be disposed furthest from the sensor side. The first lens (201) may have a negative (−) refractive power in the optical axis (OA). The first lens (201) may comprise a plastic material or a glass material, for example, a plastic material.

The object-side first surface (S1) of the first lens (201) may be convex and the sensor-side second surface (S2) may be concave with respect to the optical axis. The first lens (201) may have a convex meniscus shape towards the object side. The first lens (201) may be made of plastic and may have an aspherical surface. At least one or both of the first surface (S1) and the second surface (S2) may be aspherical. The asphericity coefficients of the first and second surfaces (S1,S2) may be given by L1S1,L1S2 in FIG. 18.

Since the first lens (201) has a negative (−) refractive power, it can refract the incident light in a direction away from the optical axis (OA) and reduce the gap between the first and second lenses (201,202). Also, the effective diameter of the sensor side surface of the second lens (202) can be designed to be smaller than the effective diameter of the object side surface by the shape of the lens surface of the first lens (201). The first surface (S1) of the first lens (201) may be provided without a critical point from the optical axis (OA) to the distal end of the effective region, i.e., the edge. The second surface (S2) of the first lens (201) may be provided without a critical point.

The second lens (202) may be disposed second from the object side. The second lens (202) may be disposed sixth from the sensor side. The second lens (202) may be disposed between the first lens (201) and the third lens (203). The second lens (202) may have a positive (+) refractive power in the optical axis (OA). The second lens (202) may include a plastic or glass material. For example, the second lens (202) may be provided in a plastic material.

The object-side third surface (S3) of the second lens (202) may be concave and the sensor-side fourth surface (S4) may be convex with respect to the optical axis (OA). The second lens (202) may have a convex meniscus shape towards the sensor side. The second lens (202) may be made of plastic and may be aspherical. At least one or both of the third surface (S3) and the fourth surface (S4) may be aspherical. The asphericity coefficients of the third surface (S3) and the fourth surface (S4) may be provided as L2S1 and l2S2 in FIG. 18. At least one or both of the third surface (S3) and the fourth surface (S4) may be provided without a critical point from the optical axis (OA) to the distal end of the effective region.

An aperture (stop) may be disposed around the periphery of the object-side third surface (S3) of the second lens (202). The composite focal length of the second to seventh lenses (202-207) disposed on the sensor side of the aperture may have a positive (+) value, which may reduce the TTL within the field of view range and enable miniaturization of the optical system. Accordingly, the yield by weight of the optical system can be prevented from deteriorating and production efficiency can be improved. Furthermore, the TTL can be reduced by reducing the horizontal field of view (FOV_H) from 25 degrees to 36 degrees to miniaturize the optical system.

The third lens (203) may be disposed third from the object side. The third lens (203) may be disposed fifth from the sensor side. The third lens (203) may be disposed between the second lens (202) and the fourth lens (204). The third lens (203) may have a positive (+) refractive power in the optical axis (OA). The third lens (203) may include a plastic or glass material. For example, the third lens (203) may be provided in a glass material.

The object-side fifth surface (S5) of the third lens (203) may be convex and the sensor-side sixth surface (S6) may be convex with respect to the optical axis. The third lens (203) may have a convex shape on both surfaces in the optical axis (OA). By providing convexity on both surfaces of the third lens (203), the TTL and number of lenses in the optical system can be minimized and light can be refracted effectively. The third lens (203) may be made of glass and may be spherical. At least one or both of the fifth surface (S5) and the sixth surface (S6) may be spherical. At least one or both of the fifth surface (S5) and the sixth surface (S6) may be provided without a critical point from the optical axis (OA) to the distal end of the effective region.

The fourth lens (204) may be disposed fourth on the object side. The fourth lens (204) may be disposed fourth on the sensor side. The fourth lens (204) may be disposed between the third lens (203) and the fifth lens (205). The fourth lens (204) may have a positive (+) or negative (−) refractive power in the optical axis (OA). The fourth lens (204) may have a positive (+) refractive power. The fourth lens (204) may have a positive (+) refractive power that is different from the refractive power of the fifth lens (205). The fourth lens (204) may include a plastic or glass material. For example, the fourth lens (204) may be provided in a glass material. The fourth lens (204) may be provided in the same material as that of the fifth lens (205).

The object-side 7th surface (S7) of the fourth lens (204) may be convex and the sensor-side 8th surface (S8) may be concave with respect to the optical axis. The fourth lens (204) may have a convex meniscus shape towards the object side. The fourth lens (204) may be made of glass and may have a spherical surface. At least one or both of the seventh surface (S7) and the eighth surface (S8) may be spherical. The seventh surface (S7) and the eighth surface (S8) may be provided without a critical point from the optical axis (OA) to the distal end of the effective region.

The fifth lens (205) may be disposed fifth from the object side. The fifth lens (205) may be disposed third from the sensor side. The fifth lens (205) may be disposed between the fourth lens (204) and the sixth lens (206). The fifth lens (205) may have a positive (+) or negative (−) refractive power in the optical axis (OA). The fifth lens (205) may have a negative (−) refractive power. The fifth lens (205) may have a negative (−) refractive power that is different from the refractive power of the fourth lens (204). The fifth lens (205) may include a plastic or glass material. For example, the fifth lens (205) may be provided in a glass material. The fifth lens (205) may be provided in the same material as that of the fourth lens (204).

With respect to the optical axis (OA), the fifth lens (205) may be convex on the object-side ninth surface (S9) and concave on the sensor-side tenth surface (S10). The fifth lens (205) may have a convex meniscus shape towards the object side. The fifth lens (205) may be made of glass and may have a spherical surface. At least one of the ninth surface (S9) and the tenth surface (S10) may be spherical. For example, both the ninth surface (S9) and the tenth surface (S10) may be spherical. At least one or both of the ninth and tenth surfaces (S9, S10) of the fifth lens (205) may be provided without a critical point from the optical axis (OA) to the distal end of the effective region.

The fourth lens (204) and the fifth lens (205) may be cemented. The joined surface between the fourth lens (204) and the fifth lens (205) may be defined as the eighth surface (S8). The eighth surface (S8) may be the same surface as the ninth surface (S9) of the fifth lens (205). The object side surface of the cemented lens (245) may be convex, and the sensor side surface may be concave. The spacing (gap) between the fourth and fifth lenses (204,205) may be less than 0.01 mm and may be bonded with an adhesive. The spacing between the fourth and fifth lenses (204,205) may be less than 0.01 mm from the optical axis (OA) to the distal end of the effective region. The fourth and fifth lenses (204,205) may have opposing refractive powers. The composite refractive power of the fourth and fifth lenses (204,205) may have a negative (−) refractive power.

The value of the radius of curvature of the cemented surface (S8) of the cemented lens (245) may be greater than 30. For example, the value of the radius of curvature of the cemented surface (S8) of the cemented lens (245) may be greater than 50. The cemented surface (S8) of the cemented lens (245) may be formed with a gentle shape. By this, the bonding process of the fourth lens (204) and the fifth lens (205) forming the cemented lens (245) is advantageous, and the bonding retention can be increased.

The product of the refractive power of the fourth lens (204) on the object side of cemented lens (155) and the refractive power of the fifth lens (205) on the sensor side can be less than zero. The product of the focal length of the fourth lens (204) on the object side of the cemented lens (155) and the focal length of the fifth lens (205) on the sensor side of the cemented lens (155) may be less than zero. This may improve the aberration characteristics of the optical system. If the two lenses of the cemented lens (155) have the same refractive power, the aberration improvement is limited.

With respect to cemented lens (245), the third lens (203) on the object side and the sixth lens (206) on the sensor side may have positive (+) refractive powers. As such, the third lens (203), the cemented lens (245), and the sixth lens (206) can refract some of the incident light in the optical axis direction and can mutually correct chromatic aberrations. The focal length of the third lens (203) disposed on the object side relative to the cemented lens (245) may be smaller than the focal length of the sixth lens (206) disposed on the sensor side. The power of the third lens (203) disposed on the object side with respect to the cemented lens (245) may be greater than the power of the sixth lens (206) disposed on the sensor side.

The effective diameter of the fourth lens (204) may be larger than the diagonal length of the image sensor (300). The effective diameter of the fourth lens (204) is the average of the effective diameters of the seventh surface (S7) and the eighth surface (S8), and may be larger than the diagonal length of the image sensor (300). The effective diameter of the fifth lens (205) is smaller than the effective diameter of the fourth lens (204) and may be larger than the diagonal length of the image sensor (300).

If the effective diameter of the seventh surface (S7) of the fourth lens (204) is CA_L4S1 and the effective diameter of the eighth surface (S8) is CA_L4S2, the effective diameters of the seventh and eighth surfaces (S7,S8) may satisfy the condition of 1<CA_L4S1/CA_L4S2<1.5. If the effective diameter of the ninth surface (S9) of the fifth lens (205) is CA_L5S1 and the effective diameter of the tenth surface (S10) is CA_L5S2, the effective diameters of the ninth and tenth surfaces (S9,S10) may satisfy the condition of 1<CA_L5S1/CA_L5S2<1.5.

The cemented lens (245) is cemented with glass lenses of mutually different refractive indices and has a spherical refractive surface, and the lenses disposed on the sensor side of the cemented lens (245) can compensate for spherical aberration if aspherical or plastic lenses are employed. Furthermore, if the lenses disposed on the sensor side of the cemented lens (245) are plastic lenses and have a smaller effective diameter, the plastic lenses can be configured to effectively guide light through the plastic lenses to the image sensor (300). The positioning of the cemented lens (245) may be in the middle or behind any two consecutive third or sixth lenses in the lens part (200), which may allow for more efficient chromatic aberration correction.

The sixth lens (206) may be disposed sixth from the object side. The sixth lens (206) may be dispose second from the sensor side. The sixth lens (206) may be disposed between the fifth lens (205) and the seventh lens (207). The sixth lens (206) may have a positive (+) or negative (−) refractive power in the optical axis (OA). The sixth lens (206) may have a positive (+) refractive power. The sixth lens (206) may include a plastic or glass material. For example, the sixth lens (206) may be provided in a plastic material.

With respect to the optical axis (OA), the sixth lens (206) may be convex on the object side 11th surface (S11) and concave on the sensor side 12th surface (S12). The sixth lens (206) may have a meniscus shape that is convex from the optical axis (OA) to the object side. Alternatively, the sixth lens (206) may have a meniscus shape that is convex on both surfaces. At least one or both of the eleventh surface (S11) and the twelfth surface (S12) may be aspherical. The asphericity coefficients of the eleventh and twelfth surfaces (S11,S12) may be provided as L1 and L2 of L6 in FIG. 18.

The eleventh surface (S11) of the sixth lens (206) may be provided without a critical point from the optical axis (OA) to the distal end of the effective region. The twelfth surface (S12) may be provided without at least one critical point from the optical axis (OA) to the distal end of the effective region.

The seventh lens (207) may be disposed closest to the sensor side. The seventh lens (207) may be disposed furthest from the object side. The seventh lens (207) may have a positive (+) or negative (−) refractive power in the optical axis (OA). The seventh lens (207) may have a negative (−) refractive power. The seventh lens (207) may include a plastic or glass material. For example, the seventh lens (207) may be made of plastic.

In the optical axis, the object-side 13th surface (S13) of the seventh lens 207 may be convex and the sensor-side 14th surface (S14) may be concave. The seventh lens (207) may have an object-side convex meniscus shape. At least one of the thirteenth surface (S13) and the fourteenth surface (S14) may be aspherical. For example, both the thirteenth surface (S13) and the fourteenth surface (S14) may be aspherical. The asphericity coefficients of the 13th and 14th surfaces (S13, S14) may be provided as S1,S2 of L7 in FIG. 18.

The thirteenth surface (S13) of the seventh lens (207) may have a critical point from the optical axis OA to the distal end of the effective region. If the thirteenth surface (S13) has a critical point, it may be located at least 50% of the effective radius (r71) from the optical axis (OA), or in the range of 52% to 70%, or in the range of 53% to 60%. If the 14th surface (S14) has a critical point, it may be located at least 70% of the effective radius (r72) in the optical axis (OA), or in a range of 70% to 90%, or in a range of 75% to 85%.

The seventh lens (207) may be a plastic lens that is closest to the image sensor (300). Also, by placing two or more plastic lenses adjacent to the image sensor (300), aberrations such as spherical aberration and chromatic aberration can be improved by the lens surfaces having aspherical surfaces, and the effect on resolution can be controlled. Furthermore, by disposing a plastic lens as the lens adjacent to the image sensor (300), the lens may be insensitive to assembly tolerances compared to a lens made of glass, meaning that even if the lens is assembled with a slight deviation from the design at assembly, the optical performance may not be significantly affected. Furthermore, by providing the two lenses (206, 207) adjacent to the image sensor (300) in plastic, the optical performance can be improved by the aspherical lens faces, such as by improving aberration characteristics and avoiding resolution degradation.

The sixth and seventh lenses (206) and (207) may be spaced apart but may include features of a cemented lens. The sixth lens (206) and seventh lens (207) may have opposing refractive powers. The product of the refractive power of the sixth lens (206) and the refractive power of the seventh lens (207) may be less than zero. The product of the focal length of the sixth lens (206) and the focal length of the seventh lens (207) may be less than zero. Accordingly, the aberration characteristics of the optical system may be improved. If the refractive power of the two lenses having the characteristics of a cemented lens is the same, the aberration improvement is limited.

The sixth lens (206) and the seventh lens (207) may be made of the same material. The sixth lens (206) and seventh lens (207) may be made of plastic. The sixth lens (206) and seventh lens (207) may be made of a different material than the cemented lens (245). While the cemented lens (245) is made of glass to improve spherical aberrations, it is less effective in improving aspherical aberrations caused by plastic lenses. Therefore, two additional lenses comprising features of the cemented lens (245) and a cemented lens made of a different material may be disposed to improve aberrations that are not improved by the cemented lens (245).

At least one or both of the thirteenth surface (S13) and the fourteenth surface (S14) of the seventh lens (207) may have critical points. The thirteenth surface (S13) of the seventh lens (207) may have a first critical point (P1) from the optical axis (OA) to the distal end of the effective region. The first critical point (P1) of the thirteenth surface (S13) may be at least 55% of the effective radius from the optical axis (OA), or may be in the range of 55% to 75%, or may be in the range of 60% to 70%. The first critical point of the 13th surface (S13) may be located at a distance of at least 2 mm from the optical axis (OA), such as a distance in the range of 2.1 mm to 2.5 mm, or a distance in the range of 2.2 mm to 2.3 mm. As another example, the thirteenth surface (S13) may be provided without a critical point. The thirteenth surface (S13) having such a first critical point (P1) can refract incident light to the center and periphery, and can improve aberrations. The first and second critical points (P1,P2) are points where the sign of the slope value with respect to the optical axis (OA) and the direction perpendicular to the optical axis (OA) changes from positive (+) to negative (−) or from negative (−) to positive (+), which may mean a point where the slope value is zero. Furthermore, the first and second critical points (P1,P2) may be points at which the slope value of the tangent line passing through the lens surface decreases from large to small or decreases from small to large.

The fourteenth surface (S14) of the seventh lens (207) may have at least one second critical point (P2) extending from the optical axis (OA) to the distal end of the effective region. The second critical point (P2) of the 14th surface (S14) may be located at a distance of at least 60% of the effective radius (r72) from the optical axis (OA), or in the range of 60% to 80%, or in the range of 65% to 75%. The second critical point (P2) of the 14th surface (S14) may be located at a distance of more than 2.9 mm from the optical axis (OA), such as in a range of 2.9 mm to 3.9 mm, or in a range of 3.1 mm to 3.7 mm. Thus, by positioning the second critical point (P2) closer to the edge than the first critical point (P1), the seventh lens (207) can refract the incident light to the periphery of the image sensor (300).

The average effective radius of the 13th and 14th surfaces (S13,S14) of the seventh lens (207) is disposed to be less than Imgh, which is ½ of the diagonal length of the image sensor (300), so that light can be refracted to the periphery of the image sensor (300) by the 14th surface (S14) having the second critical point (P2).

As shown in FIGS. 16 and 20, Sag41 represents a height from the center of the seventh surface (S7) of the fourth lens (204) to the lens surface in the direction (X,Y) orthogonal to the optical axis (OA), and the maximum value of Sag41 may be a height at the edge of the seventh surface (S7).

Sag42 indicates the height from the center of the eighth surface (S8) of the fourth lens (204) to the lens surface in the direction (X,Y) orthogonal to the optical axis (OA), and the maximum value of Sag42 may be the height at the edge of the eighth surface (S8). Sag52 indicates a height from the center of the ninth surface (S9) of the fifth lens (205) to the lens surface in the direction (X,Y) orthogonal to the optical axis (OA), and the maximum value of Sag52 may be a height at the edge of the ninth surface (S9).

Sag61 indicates a height from the center of the eleventh surface (S11) of the sixth lens (206) to the lens surface in the direction (X,Y) orthogonal to the optical axis (OA), and the maximum value of Sag61 may be a height at the edge of the eleventh surface (S11). Sag62 is the height from the center of the 12th surface (S12) of the 6th lens (206) to the lens surface in the direction (X,Y) orthogonal to the optical axis (OA), with the maximum Sag value being the height at the edge.

The maximum Sag values can satisfy the following conditions

Max_Sag51<Max_Sag52<Max_Sag41 can be satisfied.

The difference between Max_Sag52 and Max_Sag61 can be 0.8 or less. By setting the Sag value between these adjacent glass and plastic lenses, the light loss between the glass and plastic lenses can be reduced.

In FIG. 20, if the Sag value is a positive value, the lens surface is located on the sensor side with respect to a straight line orthogonal to the optical axis (OA), and if the Sag value is a negative value, the lens face is located on the object side with respect to a straight line orthogonal to the optical axis (OA). Further, when comparing the object side surface and the sensor side surface of each lens, the object side surface and the sensor side surface of the seventh lens (207) may be the sides with the smallest difference between the maximum and minimum Sag values. This may be because the distance between the object side surface and the sensor side of the seventh lens (207) is constant, and the average of the radii of curvature may be larger than the average of the radii of curvature of the other lenses.

As shown in FIGS. 15 and 16, the center thicknesses of the first to seventh lenses (201 to 207) are denoted by CT1 to CT7, the edge thicknesses at the distal end of the effective region of each lens are denoted by ET1 to ET7, the center gaps between two adjacent lenses are denoted by CG1 to CG6, and the edge gaps between the edges of each lens are denoted by EG1 to EG6. Here, the center thickness of the cemented lens (245) is represented by CT45 and the edge thickness is represented by ET45.

Referring to FIG. 16, the back focal length (BFL) is the optical axis distance from the image sensor (300) to the center of the last lens. In FIG. 15, TTL is the optical axis distance from the center of the first surface (S1) of the first lens (201) to the top surface of the image sensor (300).

FIG. 17 is an example of lens data of the optical system of the second exemplary embodiment of FIG. 15. As shown in FIG. 17, a radius of curvature in the optical axis (OA) of the first to seventh lenses (201, 202, 203, 204, 205, 206, 207), a thickness of the lens, a distance between the centers of the lenses, a refractive index in the d-line, an Abbe's number, and a size of the clear aperture (CA) can be set.

As shown in FIG. 18, the lens surfaces of the first, second, sixth, and seventh lenses (201, 202, 206, 207) of the lenses of the lens part (200) in the second embodiment may include an aspherical surface with a 30th order aspheric coefficient. For example, the first, second, sixth, and seventh lenses (201,202,206,207) may include a lens surface having a 30th order aspheric coefficient. As noted above, an aspheric surface with a 30th order asphericity factor (a value other than ‘0’) can provide good correction of optical performance in the peripheral regions of the field of view (FOV) because the aspheric shape of the periphery can be varied particularly significantly.

As shown in FIG. 19, the thickness (T1-T7) of the first to seventh lens (201,202,203,204,205,206,207) and the spacing (gap) (G1-G6) between two adjacent lenses can be set. As shown in FIG. 19, every 0.1 mm or 0.2 mm or greater gap may be indicated for the thicknesses (T1-T7) of each lens in the y-axis direction, and every 0.1 mm or 0.2 mm or greater gap may be indicated for the spacing (G1-G6) between each lens.

Referring to FIGS. 17 and 19, when comparing the absolute values of the radii of curvature of each lens, the radius of curvature of the twelfth surface (S12) of the sixth lens (206) in the optical axis (OA) may be the largest among the lenses, and the radius of curvature of the tenth surface (S10) of the fifth lens (205) may be the smallest among the lenses. The difference between the maximum and minimum radius of curvature may be in the range of 10 times or more, such as 15 times to 38 times.

Describing the center thicknesses of the lenses along the optical axis, the center thickness (CT4) of the fourth lens (204) is the maximum among the lenses, and the center thickness (CT1) of the first lens (201) is the minimum among the lenses. The difference between the maximum and minimum center thicknesses of the lenses may range from 1.5 mm to 2.5 mm or less.

Describing the center gap (spacing) (CG) between the lenses, the center gap (CG6) between the sixth lens (206) and the seventh lens (207) may be maximum, and the center gap between the second and third lenses (202,203) may be minimum. Here, the minimum center gap excludes the cemented surface of the cemented lens (245). The difference between the maximum center gap and the minimum center gap of the spaced apart lenses may be at least 1.5 mm, such as in the range of 2 mm to 3.5 mm. Further, by providing the maximum center gap between the lenses to be less than or equal to 70% of the maximum center thickness, such as in the range of 30% to 70%, the thickness of the camera module with the plastic lenses having a thin thickness may not be increased without increasing the center gap relative to the center thickness of each lens.

With respect to the effective diameter, a lens having a maximum effective diameter may be disposed between the first lens (201) closest to the object and the seventh lens (207) closest to the image sensor (300). The lens with the maximum effective diameter may be a lens made of glass. The lens with the maximum effective diameter may be disposed between the first lens (201) and the cemented lens (245). The lens having the maximum effective diameter may be the third lens (203). Here, the effective diameter is the average of the effective diameter of the object side surface of each lens and the effective diameter of the sensor side surface. The lens surface with the maximum effective diameter may be the sixth surface (S6) of the third lens (203) or the object side surface of the cemented lens (245).

The lens having the minimum effective diameter may be any of the plastic lenses, such as the seventh lens (207) adjacent to the image sensor (300). For example, the effective diameter of the seventh lens (207) may be the minimum within the lens part (200). The lens surface having the minimum effective diameter may be the thirteenth surface (S13) of the seventh lens (207).

The effective diameter of each of the first to fourth lenses (201-204) adjacent the object side may be larger than the effective diameter of the fifth, sixth, and seventh lenses (205,206,207) adjacent the sensor side. The effective diameters of the first to fourth lenses (201-204) may be larger than the diagonal length of the image sensor (300). The average effective diameter of the seventh lens (207) may be less than the diagonal length of the image sensor (300). Accordingly, light incident through the plurality of lenses aligned along the optical axis can be guided to the image sensor (300).

In terms of refractive index, the refractive index of the fifth lens (205) is the largest of the lenses, and may be greater than 1.7, such as greater than 1.75. Any one or both of the second lens (202) and the sixth lens (206) may have a minimum refractive index among the lenses. For example, it may be less than 1.6, such as less than 1.55. The difference between the maximum refractive index and the minimum refractive index may be greater than or equal to 0.2. By providing one of the lenses adjacent to the sensor as a high refractive index lens made of glass, and the lens adjacent to the glass lens and the lens adjacent to the image sensor (300) as a low refractive index lens made of plastic, the incident efficiency can be increased, and the refractive force between the glass and plastic lenses can be adjusted to guide the light to the image sensor (300).

Comparing the Abbe numbers, the Abbe number of the third lens (203) is the largest among the lenses, and may be greater than 60. The first lens (201) and seventh lens (207) have the lowest Abbe numbers of the lenses, which may be 25 or less. The difference between the maximum refractive index and the minimum Abbe number may be 40 or more. By providing the largest Abbe number for the third lens (203) adjacent to the cemented lens (245), and the smallest Abbe number for the first lens (201) closest to the object side and the low refractive index seventh lens (207) adjacent to the image sensor (300), the chromatic dispersion of light passing between the glass lenses can be controlled and guided to the image sensor (300) by increasing the chromatic dispersion between the glass and plastic lenses.

The focal lengths (F1,F5,F7) of the first, fifth, and seventh lenses (201,205,207) may have a negative (−) sign. The first, fifth, and seventh lenses (201,205,207) may have a negative (−) refractive power. The focal lengths (F2,F3,F4,F6) of the second, third, fourth, and sixth lenses (202,203,204,206) may have a positive (+) sign. The second, third, fourth, and sixth lenses (202,203,204,206) may have a positive (+) refractive power. On the sensor side of the first lens (201) having a negative (−) refractive power, the second, third, and fourth lenses (202,203,204) having a positive (+) refractive power may be disposed. By this, light incident from the object side can be diverted away from the optical axis direction and gathered back towards the optical axis direction, thus forming a stable light path.

Further, the adjacent lenses, the sixth lens (206) and the seventh lens (207), may satisfy the following conditions.
Condition 1: Refractive index of the lens with positive refractive power <refractive index of the lens with negative refractive power
Condition 2: the variance of the lens with positive refractive power > the variance of the lens with negative refractive power

Here, among the plastic lenses, the sixth lens (206) has a positive refractive power and the seventh lens (207) has a negative refractive power, so that according to conditions 1 and 2, the refractive index of the sixth lens is smaller than the refractive index of the seventh lens, and the variance of the sixth lens is larger than the variance of the seventh lens. The chromatic aberration generated by the plastic lenses can be corrected by the plastic lenses. Furthermore, the chromatic aberration generated by the plastic lens can be compensated by the plastic lens by satisfying the refractive index difference of the sixth lens (206) and the seventh lens (207), which are plastic lenses arranged in succession, of 0.1 or more than 0.15 or less, and the Abbe number difference of 20 or more than 60 or less.

Optical systems suffer from chromatic aberration, which is compensated for by using a cemented lens or two lenses placed back to back. As the temperature changes from low to high, the lens contracts and expands. Since lenses of the same material have the same amount of change in lens properties as the temperature changes, it is effective to correct chromatic aberration between lenses of the same material even when the temperature changes.

Therefore, in the second embodiment of the present invention, the fourth lens (204) and the fifth lens (205) are used to correct the chromatic aberration of a lens made of glass, and the sixth lens (206) and the seventh lens (207) are used to correct the chromatic aberration of a plastic lens.

The chromatic aberration caused by the glass lens can be compensated by the glass lens by satisfying the refractive index difference of the fourth lens (204) and the fifth lens (205), which are the lenses to be cemented, of at least 0.1 but not more than 0.15 and at least 20 but not more than 60 of the Abbe number. The refractive index difference is rounded to three decimal places, and the Abbe number difference is rounded to one decimal place to compare the values.

Furthermore, by placing glass lenses with a relatively high Abbe number on the object side of the plastic lenses, the color dispersion can be reduced by the glass lenses and increased by the plastic lenses.

Comparing the focal lengths in absolute value, the focal length of the second lens (202) is the largest among the lenses, and may be greater than 55 or greater than 100. Among the lenses, the second lens (202), which is made of plastic, may have the largest focal length and the smallest refractive power. The focal lengths of the first, second, sixth, and seventh lenses (201, 202, 206, 207), which are made of plastic, may be larger than the focal lengths of the third, fourth, and fifth lenses (203, 204, 205), which are made of glass. The focal length of the fifth lens (205) may be the smallest among the lenses, such as 15 or less, or 10 or less. The fifth lens (205), which is made of glass, may have the smallest focal length and the largest refractive power among the lenses. On the sensor side of the fifth lens (205), a lens made of a plastic material with a small refractive power may be disposed, so that the refractive power of the fifth lens (205) may be large.

Among the lenses other than the cemented lens (245), the lens having the minimum focal length may be the third lens (203). The difference between the maximum focal length and the minimum focal length may be 50 or more or 80 or more. Accordingly, the optical system may have improved MTF characteristics, aberration control characteristics, resolution characteristics, and the like in a set field of view range, and may have good optical performance at the periphery of the field of view.

There is a critical point on the sensor side surface of the seventh lens (207). The critical point is a point at which the trend of the sag value changes, i.e., the critical point is a point at which the sag value increases and then decreases, or a point at which the sag value decreases and then increases.

Referring to FIG. 20, it can be seen that the critical point exists between a point spaced 1.9 mm apart and a point spaced 2.1 mm apart in a direction perpendicular to the optical axis on the object side of the seventh lens (207). The objective side surface of the seventh lens (207) shows an increase in SAG value to a point 2.0 mm apart in a direction perpendicular to the optical axis, and then a decrease in SAG value from a point 2.0 mm apart in a direction perpendicular to the optical axis to a point 4.2 mm apart in a direction perpendicular to the optical axis.

The sensor side surface of the seventh lens (207) shows that a critical point exists between a point 3.3 mm apart in a direction perpendicular to the optical axis and a point 3.5 mm apart in a direction perpendicular to the optical axis. On the sensor side surface of the seventh lens (207), the sag value increases to a point 3.4 mm apart in a direction perpendicular to the optical axis, and then the sag value decreases from a point 3.4 mm apart in a direction perpendicular to the optical axis to a point 4.6 mm apart in a direction perpendicular to the optical axis. The presence of a critical point on the sensor side surface of the seventh lens (207), that is, the sensor side surface of the last lens, that is, the lens surface closest to the sensor, enables the TTL to be reduced, thereby facilitating miniaturization and light-weighting of the optical system.

The thickness (T1) of the first lens (201) may be in the range of 1 to 1.1 times, such as a difference between the maximum thickness and the minimum thickness of more than 1 times, with the center thickness (CT1) being the maximum and the edge thickness (ET1) being the minimum. The thickness (T2) of the second lens (202) may range from a maximum thickness of 1 to 1.2 times the minimum thickness. The second lens (202) may have a maximum center thickness (CT2) and a minimum edge thickness (ET2). The third lens (203) may have a thickness (T3) that is maximum at the center and minimum at the edges, with the maximum thickness ranging from 1.5 times to 2 times the minimum thickness. The thickness (T4) of the fourth lens (204) may be maximum at the center and minimum at the edges, with the maximum thickness ranging from 1.9 times to 2.2 times the minimum thickness. The thickness (T5) of the fifth lens (205) may be minimum at the center and maximum at the edges, with the maximum thickness ranging from 1.7 times to 1.9 times the minimum thickness. The thickness (T6) of the sixth lens (206) may be maximum at the center and minimum at the edges, with the maximum thickness ranging from 1.4 times to 1.6 times the minimum thickness. The thickness (T7) of the seventh lens (207) may be minimum at the center and maximum at the edges, with the maximum thickness ranging from 1 to 1.2 times the minimum thickness.

The center thickness (CT45) of the cemented lens (245) may be larger than the edge thickness (ET45). The center thickness (CT45) of the cemented lens (245) is the distance from the center of the seventh surface (S7) of the object side of the fourth lens (204) to the center of the tenth surface (S10) of the fifth lens (205), and the edge thickness (ET45) is the distance from the distal end of the effective region of the seventh surface (S7) to the tenth surface (S10) in the optical axis direction. The maximum thickness of the cemented lens (245) is at the center, the minimum thickness is at the edges, and the maximum thickness may range from 1 to 1.2 times the minimum thickness.

Of the gaps (G1-G6) between the lenses, the first gap (G1) between the first and second lenses (201,202) may be maximum at the center and minimum at the edges. The second gap (G2) between the second and third lenses (202,203) may have a maximum at the edges and a minimum at the center. The third gap (G3) between the third and fourth lenses (203,204) may be maximum at the edges and minimum at the center. The fifth gap (G5) between the fifth and sixth lenses (205,206) may be maximum at the center and minimum at the edges. The sixth gap (G6) between the sixth and seventh lenses (206,207) may have maximum at the center and minimum at the edges.

As shown in FIG. 21, in the optical system and camera module of FIG. 15, the chief ray angle (CRA) may be in the range of 10 degrees or more, such as in the range of 10 degrees to 35 degrees, or in the range of 10 degrees to 25 degrees, at the 1-field, which is the distal end of the diagonal length of the image sensor. Further, the difference in the chief ray angle from a low temperature (−40 degrees C.) to a high temperature (95 degrees C.) may be 1 degree or less. Accordingly, even if the temperature changes from a low temperature to a high temperature, the angular difference of the chief ray angle is not large and stable optical performance can be achieved.

In the optical system according to the second embodiment, as shown in FIG. 28, a graph showing the ambient illuminance ratio or relative illumination according to the image height, it can be seen that the ambient illuminance ratio is 70% or more, such as 75% or more, from the center of the image sensor to the distal end of the diagonal. In other words, it can be seen that the difference between the ambient illuminance (Zoom position 1, 2, 3) according to the temperature at normal temperature, low temperature, and high temperature is almost no difference up to 4.5 mm or more from the optical axis.

FIGS. 22 to 24 are graphs of the modulation transfer function (MTF) of diffraction at room temperature, low temperature, and high temperature in the optical system of FIG. 15, plotting the luminance ratio (modulation) as a function of spatial frequency. As shown in FIGS. 22 to 24, in the exemplary embodiments of the present invention, the deviation of the MTF from room temperature to low or high temperature may be less than 10%, such as 7% or less.

FIGS. 25 to 27 are graphs depicting aberration characteristics at room temperature, low temperature, and high temperature for the optical system of FIG. 15. In the aberration graphs of FIGS. 25 to 27, from left to right, Longitudinal Spherical Aberration, Astigmatic Field Curves, and Distortion are measured. In FIGS. 25 to 27, the X-axis may represent the focal length (mm) and distortion (%), and the Y-axis may represent the height of the image. Further, the graphs for spherical aberration are graphs for light in the wavelength band of about 435 nm, about 486 nm, about 546 nm, about 587 nm, and about 656 nm, and the graphs for astigmatism and distortion aberration are graphs for light in the wavelength band of about 546 nm. From the aberration diagrams of FIGS. 25 to 27, it can be interpreted that the closer each curve is to the Y-axis at room temperature, low temperature, and high temperature, the better the aberration correction function, and it can be seen that an optical system (2000) according to the embodiment has measured values close to the Y-axis in almost all areas, which means that the optical system (2000) according to the embodiment has improved resolution and can have good optical performance not only in the center of the field of view (FOV) but also in the periphery. Here, the low temperature may be below −20 degrees Celsius, such as in the range of −20 to −40 degrees Celsius, the room temperature may be in the range of 22 degrees Celsius ±5 degrees Celsius or in the range of 18 degrees Celsius to 27 degrees Celsius, and the high temperature may be above 85 degrees Celsius, such as in the range of 85 degrees Celsius to 205 degrees Celsius. Accordingly, it can be seen that the degradation of the luminance ratio modulation from the low temperature to the high temperature of FIGS. 25 to 27 is less than 10%, such as 5% or less, or is virtually unchanged.

Table 2 compares the changes of optical properties such as EFL, BFL, F number (F #), TTL, and field of view (FOV) at room temperature, low temperature, and high temperature in the optical system according to the exemplary second embodiment, and it can be seen that the change rate of the optical properties at low temperature is 5% or less, such as 3% or less, relative to room temperature, and the change rate of the optical properties at high temperature is 5% or less, such as 3% or less, relative to room temperature.

TABLE 2

| | | | | Low | High |
|---|---|---|---|---|---|
| | | | | temper- | temper- |
| | Room | Low | High | ature/Room | ature/Room |
| | temper- | temper- | temper- | temper- | temper- |
| | ature | ature | ature | ature | ature |
| EFL(F) | 15.1000 | 15.0319 | 15.1820 | 99.54% | 100.44% |
| BFL | 2.5000 | 2.4971 | 2.5035 | 99.87% | 100.14% |
| F# | 1.6000 | 1.5938 | 1.6076 | 99.61% | 100.47% |
| TTL | 33.2904 | 33.2217 | 33.3712 | 99.79% | 100.24% |
| FOV | 34.0400 | 34.1857 | 33.8684 | 100.42% | 99.49% |

Thus, as shown in Table 2, it can be seen that the change in optical properties, such as the change in effective focal length (EFL), TTL, BFL, F number, and field of view (FOV), due to a change in temperature from low to high temperature, is in the range of 0 to 5%, such as 5% or less. This enables the design of a temperature compensation for the plastic lens, even when at least one or more sheets (layers) of plastic lenses are used, to prevent deterioration in the reliability of the optical properties.

The optical system of the second embodiment disclosed above can effectively control aberration characteristics such as chromatic aberration and distortion aberration, and can have good optical performance not only in the center of the field of view (FOV) but also in the periphery.

The optical systems (1000, 2000) according to the first and second embodiments disclosed above may satisfy at least one or two of the mathematical expressions described below. Accordingly, the optical systems (1000, 2000) according to embodiments may have improved optical properties. For example, when the optical systems (1000, 2000) satisfy at least one of the mathematical expressions, the optical systems (1000, 2000) can effectively control aberration characteristics such as chromatic aberration, distortion aberration, and the like, and can have good optical performance in the periphery as well as in the center of the field of view (FOV). Further, the optical systems (1000, 2000) may have improved resolution. Furthermore, the thickness at the optical axis (OA) of the lens and the gap (spacing) at the optical axis (OA) of the adjacent lenses described in the mathematical expressions can be understood with reference to the first and second embodiments disclosed above.

$$0.5 < CT 1 / ET 1 < 1.5 \qquad [ Mathematical Expression 1 ]$$

In Mathematical Expression 1, CT1 is the center thickness of the first lens (101,201) and ET1 is the edge thickness of the first lens (101,201). Thus, a factor affecting the field of view of the optical system can be set, and a factor affecting the effective focal length (EFL) can be set, preferably satisfying 0.6≤CT1/ET1<1 in the first embodiment, and preferably satisfying 0.6≤CT1/ET1<1.2 in the second embodiment.

$$0.1 < CT 1 / CA\_L1S1 < 0.5 \qquad [ Mathematical Expression 2 ]$$

In Mathematical Expression 2, CT1 is the center thickness of the first lens (101,201), and CA_L1S1 is the effective diameter of the object side surface (S1) of the first lens (101,201). If Mathematical Expression 2 is satisfied, deterioration of the strength and optical properties of the injection-molded lens made of glass can be prevented. If lower than the range of Mathematical Expression 2, the lens may break or be difficult to injection mold, and if higher than the range, the TTL may increase and the weight of the optical system may become heavy. Preferably, in the first and second embodiments, 0.12<CT1/CA_L1S1<0.2 may be satisfied.

$$Po 1 < 0 \qquad [ Mathematical Expression 3 ]$$

In Mathematical Expression 3, Po1 is the sign of the refractive power of the first lens (101,201). For the performance of the optical system, it may be set to have a short effective focal length relative to the TTL in the optical system. If Mathematical Expression 3 is satisfied, the light incident on the first lens (101,201) from the object side can be spread in a direction away from the optical axis. The entire optical system may have a stable structure for spreading and gathering light.

$$F 6 * F 7 < 0 \qquad [ Mathematical Expression 3 - 1 ]$$

In Mathematical Expression 3-1, F6 is the focal length of the sixth lens (106,206) and F7 is the focal length of the seventh lens (107,207). The conditions in Mathematical Expression 3-1 allow the product of the focal lengths of the plastic lenses to be arranged with a mixture of negative (−) and positive (+) refractive forces so that they compensate for each other. This allows the aberrations generated by the plastic lenses to be cancelled out.

$$1.6 < n 1 < 2.2 \qquad [ Mathematical Expression 4 ]$$

In Mathematical Expression 4, n1 is the refractive index at the d-line of the first lens (101,201). Mathematical Expression 4 sets the refractive index of the first lens to be high, which can control the factors that affect the reduction of the third-order aberration (Zeidel aberration) of the optical system, and can reduce the aberration that may be caused by a somewhat longer TTL. Mathematical Expression 4 may preferably satisfy 1.75<n1<2.1 in a first embodiment, and may preferably satisfy 1.65<n1<1.8 in a second embodiment. If the design is lower than the lower limit of Mathematical Expression 4, it may be ineffective in reducing aberrations, and the first lens 101,201 may be underpowered and not collect light efficiently, resulting in poor performance of the optical system. If the design is higher than the upper limit of Mathematical Expression 4, it may be difficult to obtain materials. In addition, if the refractive index of the first lens (101,201) is designed to be lower than the lower limit of Mathematical Expression 4, the radius of curvature of the first and second lenses (101,102) must be increased to increase the refractive power of the first and second lenses (101,102), which may make lens manufacturing more difficult, increase the rate of lens defects, and decrease the yield.

$$1.6 \leq Aver ( n 1 : n 7 ) \leq 1.7 \qquad [ Mathematical Expression 4 - 1 ]$$

In Mathematical Expression 4-1, Aver(n1:n7) is the average of the refractive index values at the d-line of the first to seventh lenses (101 to 107). If the optical systems (1000, 2000) according to the embodiments satisfy the Mathematical Expression 4-1, the optical systems (1000, 2000) can set the resolution power and suppress the effect on the TTL.

$$27 < FOV\_H < 33 \qquad [ Mathematical Expression 5 ]$$

In Mathematical Expression 5, FOV_H denotes a horizontal field of view, which may set the range of the automotive optical system. In the first and second embodiments, Mathematical Expression 5 may preferably satisfy 28≤FOV_H≤31, or may satisfy a range of 29.9 degrees ±3 degrees, wherein the sensor length in the horizontal direction is based on 8.064 mm±0.5 mm. Furthermore, if Mathematical Expression 5 is satisfied, the change rate of the effective focal length and the change rate of the field of view when the temperature changes from normal temperature to high temperature may be set to 5% or less, such as 0 to 5%. Furthermore, even if two or more plastic lenses, such as three or more, are mixed in the optical systems (1000, 2000), the temperature compensation of the plastic lenses can prevent deterioration of the optical properties.

$$L 3 R 1 > 0 \qquad [ Mathematical Expression 6 ]$$

$$L 3 R 2 < 0$$

$$\vert L 3 R 1 \vert > \vert L 3 R 2 \vert$$

In Mathematical Expression 6, L3R1 is the radius of curvature of the object side surface of the third lens (103,203) and L3R2 is the radius of curvature of the sensor side surface of the third lens (103,203). The third lens (103,203) may have a convex shape on both surfaces. Since the third lens (103,203) has a convex shape on both surfaces, light can be refracted so that the effective diameters of the fourth to seventh lenses (104-107,204-207) disposed on the sensor side surface of the third lens (103,203) do not become large, and the number of lenses can be reduced. Furthermore, since the condition of |L3R1|>|L3R2| is obtained, the light can be adjusted so that the effective diameter of the sensor-side lens of the third lens (103,203), i.e., the fourth to seventh lenses (104-107,204-207), is not large, and the TTL can be reduced. If the conditions of |L3R1|<|L3R2| are present, there is a problem that the object side surface of the third lens (103,203) has a large amount of aberration, and the sensor side surface of the third lens (103,203) does not refract light well, resulting in an increase in the effective diameter or an increase in the TTL.

$$1 < L7S2\_max \_sag to Sensor < 3 \qquad [ Mathematical Expression 7 ]$$

In Mathematical Expression 7, L7S2_max_sag to Sensor means the straight line distance from the maximum Sag value of the 7th lens (107,207) to the image sensor (300). If it is satisfied, the TTL can be reduced and the conditions for building the camera module can be set. In addition, L7S2_max_sag to Sensor can set a space for placing the filter (500) and the cover glass (400) located between the image sensor (300) and the seventh lens (107,207). If the range of Mathematical Expression 7 is less than the lower limit, the space for placing circuit structures such as filters and image sensors may be limited and the process of assembling circuit structures such as filters and image sensors into an optical system may become difficult. If the range of Mathematical Expression 7 is larger than the upper limit, the process of assembling circuit structures such as filters and image sensors into an optical system is easier, but the TTL becomes longer, making it difficult to miniaturize the optical system.

In other words, Mathematical Expression 7 can set a minimum distance between the image sensor (300) and the last lens, preferably satisfying 1<L7S2_max_sag to Sensor≤BFL. Further, if the last lens does not have a point (P2) that protrudes further towards the image sensor than the center of the sensor side surface, the value of Mathematical Expression 7 may be equal to the back focal length (BFL). BFL is the optical axis distance from the image sensor (300) to the center of the sensor side surface of the last lens. Specifically, satisfying 1.5<L7S2_max_sag to Sensor<2.0 is preferred for ease of manufacture and TTL reduction.

$$1 < CT 1 / CT 7 < 3 \qquad [ Mathematical Expression 8 ]$$

In Mathematical Expression 8, CT1 is the center thickness of the 1st lens (101,201) and CT7 is the center thickness of the 7th lens (107,207). If Mathematical Expression 8 is satisfied, the aberration characteristics can be improved and the effect on the shrinkage of the optical system can be established. Mathematical Expression 8 may preferably satisfy 1<CT1/CT7<2 in a first embodiment, and preferably satisfy 1<CT1/CT7<1.8 in a second embodiment. Mathematical Expression 8 may set the object-side lens and the sensor-side lens of the optical system to be made of glass and the plastic lens, respectively, and may limit the difference between their center thicknesses. Accordingly, the chromatic aberration of the optical system can be improved, and the total track length (TTL) can be controlled with good optical performance at the set field of view.

$$1 < CT 45 / CT 6 < 5 \qquad [ Mathematical Expression 9 ]$$

In Mathematical Expression 9, CT45 is the center thickness of the fourth and fifth lenses (104,105), for example the center thickness of the cemented lens (145), and CT6 is the center thickness of the sixth lens (106,206). If the optical system satisfies Mathematical Expression 9, the thickness of the cemented lens and the adjacent sixth lens (106,206) can be set to improve the aberration characteristics, preferably satisfying 1<CT45/CT6<3 or 1.5<CT45/CT6<2.5 in the first and second embodiments. CT45 may be greater than a center thickness (CT1-CT7) of each of the first to seventh lenses. Here, the condition CT45>ET45 may be satisfied.

$$0.2 < CT 45 - ET 45 < 0.5 \qquad [ Mathematical Expression 10 ]$$

In Mathematical Expression 10, CT45 is the center thickness of the fourth and fifth lenses (104-105,204-205), for example the center thickness of the cemented lens (145,245), and ET45 is the optical axis distance from the distal end of the effective region on the object side surface of the fourth lens (104,204) to the distal end of the effective region on the sensor side surface of the fifth lens (105,205). If the optical system satisfies Mathematical Expression 10, the center thickness and edge thickness of the cemented lens can be set to improve the aberration characteristics, preferably satisfying 0.3≤CT45/ET45<0.5 in the first and second embodiments. ET45 may be greater than an edge thickness (ET1-ET7) of each of the first to seventh lenses.

$$0 < CA\_L1S1 / CA\_L4S1 < 2 \qquad [ Mathematical Expression 11 ]$$

In Mathematical Expression 11, CA_L1S1 means the effective diameter of the first surface (S1) of the first lens (101,201), and CA_L4S1 means the effective diameter of the seventh surface (S7) of the fourth lens (104,204). If Mathematical Expression 11 is satisfied, the optical system (1000, 2000) can control the incident light and can set a factor affecting the aberration, preferably 0.5<CA_L1S1/CA_L4S1<1 in the first and second embodiments.

$$0 < CA\_L7S2 / CA\_L5S2 < 2 \qquad [ Mathematical Expression 12 ]$$

In Mathematical Expression 12, CA_L5S2 refers to the effective diameter of the tenth surface (S10) of the fifth lens (105,205), and CA_L7S2 refers to the effective diameter of the fourteenth surface (S14) of the seventh lens (107,207). If Mathematical Expression 12 is satisfied, the optical system (1000, 2000) can control the incident light path and can set a factor for CRA and temperature dependent performance variation. Preferably, the Mathematical Expression 12 may satisfy 0.5<CA_L7S2/CA_L5S2<1 in the first and second embodiments.

$$0 < CA\_L1S2 / CA\_L2S1 < 2 \qquad [ Mathematical Expression 13 ]$$

In Mathematical Expression 13, CA_L1S2 refers to the effective diameter of the second surface (S2) of the first lens (101,201) and CA_L2S1 refers to the effective diameter of the third surface (S3) of the second lens (102,202). If Mathematical Expression 13 is satisfied, the optical systems (1000, 2000) can control the light proceeding to the first lens group (LG1) and the second lens group (LG2), and can set a factor affecting the reduction of the lens sensitivity. The Mathematical Expression 15 may preferably satisfy 0.5<CA_L1S2/CA_L2S1<1.5 in the first and second embodiments.

$$0.5 < CA\_L4S1 / CA\_L5S2 < 2.5 \qquad [ Mathematical Expression 14 ]$$

In Mathematical Expression 14, CA_L4S1 refers to the effective diameter of the seventh surface (S7) of the fourth lens (104,204), and CA_L5S2 refers to the effective diameter of the tenth surface (S10) of the fifth lens (105,205). If the optical systems (1000, 2000) satisfy Mathematical Expression 14, the size of the cemented lens disposed on the object side of the plastic lens(es) can be set. The Mathematical Expression 14 may preferably satisfy 0.8≤CA_L4S1/CA_L5S2<1.5 in a first embodiment, and preferably 1≤CA_L4S1/CA_L5S2<1.5 in a second embodiment.

$$2 < L 3 R 1 / ( CA\_L3S1 / 2 ) < 5 \qquad [ Mathematical Expression 15 ]$$

In Mathematical Expression 15, L3R1 is the radius of curvature of the object side surface of the third lens (103,203), and CA_L3S1 is the effective diameter of the fifth surface (S5) of the object side of the third lens (103,203). If the convex third lens (103,203) on both surfaces satisfies Mathematical Expression 15, the optical systems (1000, 2000) can improve the chromatic aberration. If the lower limit value of Mathematical Expression 15 is less than the upper limit value, the aberration caused by the fifth surface (S5) will increase, and if the upper limit value is greater than the lower limit value, the aberration caused by the fifth surface (S5) will decrease, but the radius of curvature of the sixth surface (S6) will need to be smaller, which will increase the aberration caused by the sixth surface (S6) and affect the aberration of the fourth to seventh lenses (104-107,204-207). In the first embodiment, if the range of 4<L3R1/(CA_L3S1/2)<5 is preferably satisfied, and in the second embodiment, if the range of 3<L3R1/(CA_L3S1/2)<4 is preferably satisfied, it is possible to design a large radius of curvature of the sixth surface (S6) while reducing the aberration generated on the fifth surface (S5), thereby facilitating the manufacture of the third lens (103,203). By reducing aberrations in the optical system and making it easier to manufacture the third lens (103,203), the yield can be increased.

$$CA\_L4 > CA\_L5 > CA\_L6 > CA\_L7 \qquad [ Mathematical Expression 15 - 1 ]$$

$$CA\_L7S1 < ( Imgh * 2 ) \qquad [ Mathematical Expression 15 - 2 ]$$

In Mathematical Expressions 15-1 to 15-2, CA_L4, CA_L5, CA_L6, CA_L7 are the effective diameters (average effective diameters) of the fourth to seventh lenses (104-107,204-207), and Imgh is ½ of the diagonal length of the image sensor (300). Accordingly, the light path from the fourth lens (104,204) to the seventh lens (107,207) can be directed to a region of the image sensor (300) by the effective diameter of the fourth lens (104,204) to the seventh lens (107,207). Since the sixth and seventh lenses (106-107,206-207) are plastic lenses with an aspherical surface and the fourth and fifth lenses (104,105) are glass lenses with a spherical surface, the aberrations between the lenses can be mutually compensated.

$$1 < CA\_GL \_AVER / CA\_PL \_AVER < 1.5 \qquad [ Mathematical Expression 16 ]$$

In Mathematical Expression 16, CA_GL_AVER is the average effective diameter of the glass lenses and CA_PL_AVER is the average effective diameter of the plastic lenses. By setting the effective diameter size of the glass lens and the effective diameter size of the plastic lens in Mathematical Expression 16, the path of the incident light can be effectively guided. Mathematical Expression 16 may preferably satisfy 1.1<CA_GL_AVER/CA_PL_AVER<1.3 in the first and second embodiments.

Here, nGL>nPL may be satisfied. Where nGL is the number of glass lenses and nPL is the number of plastic lenses. It can also satisfy the condition nGL−nPL=0 or 1.

$$1.2 \leq GL\_CA1 \_AVER / PL\_CA1 \_AVER \leq 1.5 \qquad [ Mathematical Expression 17 ]$$

In Mathematical Expression 17, GL_CA1_AVER is the average of the effective diameters of the object side surfaces of the glass lenses, e.g., the average of the effective diameters of the object side surfaces of first, third, fourth and fifth lenses {(101,103,104,105), (201,203,204,205)}. PL_CA1_AVER is the average of the effective diameters of the object side surfaces of the plastic lenses, for example, the average of the effective diameters of the object side surfaces of the 2nd, 6th, and 7th lenses ((102,106,107), (202,206,207)). Since the effective diameter size of the plastic lens is designed to be relatively small compared to the glass lens, Mathematical Expression 17 can be satisfied. Mathematical Expression 17 may preferably satisfy 1.3≤GL_CA1_AVER/PL_CA1_AVER≤1.4 in the first embodiment, and preferably 1.2≤GL_CA1_AVER/PL_CA1_AVER≤1.4 in the second embodiment.

$$CG 3 < CG 5 < CG 1 \qquad [ Mathematical Expression 18 ]$$

In Mathematical Expression 18, CG1 may be the center gap (spacing) between the first and second lenses 101-102,201-202, CG3 may be the center spacing between the third and fourth lenses 103-104,203-204, and CG5 may be the center spacing between the fifth and sixth lenses 105-106,205-206. If Mathematical Expression 18 is satisfied, the center spacing between the relatively thicker glass lenses can be reduced, which can reduce TTL and improve optical performance in the peripheral part of the field of view (FOV).

$$1 < CT 7 / CG 6 < 3 \qquad [ Mathematical Expression 19 ]$$

In Mathematical Expression 19, CG6 is the center spacing or optical axis distance between the 6th and 7th lenses (106-107,206-207). In Mathematical Expression 19, the center thickness (CT7) of the seventh lens (107,207) and the center spacing between the sixth and seventh lenses (6,7) can be set to improve optical performance at the periphery of the field of view. Mathematical Expression 19 may preferably satisfy 1.1<CT7/CG6<1.5 in a first embodiment, and preferably satisfy 1.5<CT7/CG6<2 in a second embodiment.

$$1 < CT 2 / CT 1 < 2 \qquad [ Mathematical Expression 20 ]$$

$$1 < CT 1 / CT 2 < 2$$

In Mathematical Expression 20, CT1 is the center thickness of the first lens (101,201) and CT2 is the center thickness of the second lens (102,202). By setting the center thickness CT2 of the second lens in Mathematical Expression 20 to be greater than the center thickness CT1 of the first lens, the factors affecting aberration can be controlled. In a first embodiment, the Mathematical Expression 20 may preferably satisfy 1.1<CT2/CT1<2, and in a second embodiment, the Mathematical Expression 20 may preferably satisfy 1.1<CT1/CT2<2.

$$1 < L 7 R 1 / CT 7 < 20 \qquad [ Mathematical Expression 21 ]$$

In Mathematical Expression 21, L7R1 is the radius of curvature of the 13th surface (S13) of lens 7 (107,207), and CT7 is the center thickness of lens 7 (107,207). By setting the radius of curvature L7R1 of the object side surface of the seventh lens (107,207) and the center thickness of the seventh lens (107,207) in Mathematical Expression 21, the refractive force of the seventh lens (107,207) can be controlled. Accordingly, good optical performance can be achieved in the center and periphery of the field of view. Preferably in the first and second embodiments, the Mathematical Expression 21 may satisfy 1<L7R1/CT7<16.

$$0 < CT\_Max / CG\_Max < 3 \qquad [ Mathematical Expression 22 ]$$

In Mathematical Expression 22, CT_Max is the maximum center thickness of the lenses and CG_Max is the maximum spacing between adjacent lenses. If Mathematical Expression 22 is satisfied, the optical system may have good optical performance at the focal length at the set field of view and may reduce the TTL. In a first embodiment, the Mathematical Expression 22 may preferably satisfy 1<CT_Max/CG_Max<1.5, and in a second embodiment, the Mathematical Expression 22 may preferably satisfy 2<CT_Max/CG_Max<3.

$$2 < \sum CT / \sum CG < 3 \qquad [ Mathematical Expression 23 ]$$

In Mathematical Expression 23, ΣCT is the sum of the center thicknesses of the lenses and ΣCG is the sum of the spacing between adjacent lenses. If Mathematical Expression 23 is satisfied, the optical system can have good optical performance at the focal length at a given field of view and can reduce the TTL. In the first and second embodiments, Mathematical Expression 23 may preferably satisfy 2<ΣCT/ΣCG<2.9.

$$10 < \sum Index < 20 \qquad [ Mathematical Expression 24 ]$$

In Mathematical Expression 24, ΣIndex is the sum of the refractive indices at the d-line of each of the plurality of lenses. If Mathematical Expression 24 is satisfied, the TTL can be controlled in the optical systems (1000, 2000) comprising a mixture of plastic and glass lenses, and the resolution can be improved. Also, when the number of glass lenses is greater than the number of plastic lenses, the sum of the TTL and the refractive index can be set when the number of glass lenses having a relatively large thickness is greater than the number of plastic lenses. In the first and second embodiments, the Mathematical Expression 24 may preferably satisfy 10<ΣIndex<15.

$$10 < \sum Abb / \sum Index < 35 \qquad [ Mathematical Expression 25 ]$$

In Mathematical Expression 25, ΣAbb means the sum of the Abbe's numbers of each of the plurality of lenses. If Mathematical Expression 25 is satisfied, the optical systems (1000, 2000) may have improved aberration characteristics and resolution. By setting Mathematical Expression 25 to the sum of the Abbe's numbers and the refractive indices of the lenses, the optical properties can be controlled, and in a first embodiment, Mathematical Expression 24 can preferably satisfy 10<ΣAbb/ΣIndex<30, and in a second embodiment, Mathematical Expression 24 can preferably satisfy 10<ΣIndex<15.

$$1 < \sum CT / \sum ET < 2 \qquad [ Mathematical Expression 26 ]$$

In Mathematical Expression 26, ΣCT is the sum of the center thicknesses of the lenses and ΣET is the sum of the edge thicknesses, i.e. the ends of the effective region of the lenses. If Mathematical Expression 26 is satisfied, the optical system may have good optical performance at the focal length at the set field of view, and may reduce the TTL. In the first and second embodiments, Mathematical Expression 26 may preferably satisfy 1<ΣCT/ΣET<1.5.

$$0.5 < CA\_L3S 1 / CA\_min < 5 \qquad [ Mathematical Expression 27 ]$$

In Mathematical Expression 27, CA_L3S1 is the effective diameter of the objective side fifth surface (S5) of the third lens (103,203), and CA_Min is the minimum effective diameter of the objective and sensor side surfaces of the lens. By satisfying Mathematical Expression 27, the optical system can control incident light, maintain optical performance, and provide a slimmer module. In the first and second embodiments, Mathematical Expression 27 may preferably satisfy 1<CA_L3 S1/CA_min<2.

$$1 < CA\_max / CA\_min < 3 \qquad [ Mathematical Expression 28 ]$$

In Mathematical Expression 28, CA_max represents the maximum effective diameter between the object and sensor side surfaces of the lens, and CA_Min represents the minimum effective diameter between the object and sensor side surfaces of the lens. If Mathematical Expression 28 is satisfied, the optical system can be sized for a slim and compact structure while maintaining optical performance. In the first and second embodiments, Mathematical Expression 28 may preferably satisfy 1<CA_max/CA_min<2.

$$1 < CA\_max / CA\_Aver < 3 \qquad [ Mathematical Expression 29 ]$$

In Mathematical Expression 29, CA_max represents the maximum effective diameter of the objective and sensor side surfaces of the lens, and CA_Aver represents the average of the effective diameters of the objective and sensor side surfaces of the lens. If Mathematical Expression 29 is satisfied, the optical system can be sized for a slim and compact structure while maintaining optical performance. In the first and second embodiments, Mathematical Expression 29 may preferably satisfy 1<CA_max/CA_Aver<1.5.

$$0.5 < CA\_min / CA\_Aver < 2 \qquad [ Mathematical Expression 30 ]$$

In Mathematical Expression 30, CA_Min represents the minimum effective diameter of the objective side and sensor side surfaces of the lens, and CA_Aver represents the average of the effective diameters of the objective side and sensor side surfaces of the lens. If Mathematical Expression 30 is satisfied, the optical system can be sized for a slim and compact structure while maintaining optical performance. In the first and second embodiments, Mathematical Expression 30 may preferably satisfy 0.5<CA_min CA_Aver<1.

$$1 < CA\_max / ( 2 * ImgH ) < 3 \qquad [ Mathematical Expression 31 ]$$

Mathematical Expression 31 shows that CA_max represents the maximum effective diameter of the object side and sensor side surfaces of the lenses, and Imgh is ½ of the length diagonally from the optical axis of the image sensor (300). If Mathematical Expression 31 is satisfied, the optical system can maintain good optical performance and can be sized for a slim and compact structure. In the first and second embodiments, the Mathematical Expression 31 may preferably satisfy 1<CA_max/(2*ImgH)<2.

$$1 < TD / CA\_max < 4 \qquad [ Mathematical Expression 32 ]$$

In Mathematical Expression 32, TD is the optical axis distance from the center of the object side surface of the first lens (101,201) to the center of the sensor side surface of the last lens, and CA_max is the maximum effective diameter of the object side surface and sensor side surface of the lenses. If Mathematical Expression 32 is satisfied, the total optical axis distance and the maximum effective diameter of the lenses can be set, and thus the lenses can be sized for good optical performance. In the first and second embodiments, Mathematical Expression 32 may preferably satisfy 2<TD/CA_max<3.

$$0 < F / L 1 R 1 < 1 \qquad [ Mathematical Expression 33 ]$$

In Mathematical Expression 33, F is the effective focal length of the optical system and L1R1 is the radius of curvature of the object side surface of the first lens (101,201). If Mathematical Expression 33 is satisfied, the incident light and its effect on the TTL can be controlled. In the first and second embodiments, Mathematical Expression 33 may preferably satisfy 0.5≤F/L1R1<1.

$$1 < Max\_th / Min\_th < 3 \qquad [ Mathematical Expression 34 ]$$

In Mathematical Expression 34, Max_th is the thickness of the thickest region of the lens, and Min_th is the thickness of the thinnest region of the lens. The thickest thickness of the lens, Max_th, can be the center thickness (CT) of the lens, and the thinnest thickness of the lens, Min_th, can be the edge thickness (ET) of the lens, but the reverse is also possible. The thickest thickness of the lens, Max_th, can be the edge thickness (ET) of the lens, and the thinnest thickness of the lens, Min_th, can be the center thickness (CT) of the lens. The edge thickness (ET) is the thickness at the distal end of the effective diameter. If Mathematical Expression 34 is satisfied, the optical system may adjust the effect on the effective focal length. In a first embodiment, Mathematical Expression 34 may preferably satisfy the condition of 1<MAX_th/MIN_th≤1.5, and in a second embodiment, Mathematical Expression 34 may preferably satisfy the condition of 2<MAX_th/MIN_th≤2.5.

Here, the ratio of the maximum thickness and the minimum thickness of the plastic lens can satisfy the following conditions. Max_PL_th is the thickness value of the thickest region of the plastic lens, and Min_PL_th is the thickness value of the thinnest region of the plastic lens. Max_PL_th can be the center thickness (CT) of the plastic lens, and Min_PL_th can be the edge thickness (ET) of the plastic lens. The edge thickness (ET) is the thickness at the distal end of the effective diameter. The reverse is also possible. Max_PL_th can be the edge thickness (ET) of the plastic lens and Min_PL_th can be the center thickness (CT) of the plastic lens. Edge thickness (ET) means the thickness at the distal end of the effective diameter.

$$1 < Max\_PL \_th / Min\_PL \_th < 2.5 \qquad Condition 1$$

When the lower limit of condition 1 is less than the range, it is difficult to manufacture plastic lenses, i.e., they are made by injecting high-temperature resin and curing it at low temperatures, and if the thickness difference is large, the shrinkage may not be uniform as the lens cools at low temperatures, resulting in a high surface defect rate. In addition, if the range of condition 1 is larger than the range of condition 2, the plastic lens expands and contracts as the temperature changes from −40 degrees C. to 105 degrees C., and the rate of change in the shape of the lens is large, which may result in a deterioration of the optical system performance.

Preferably, the conditions of 1.0<Max_PL_th/Min_PL_th<1.8 and 1.0<Max_PL_th/Min_PL_th<1.5 can be satisfied.

$$0 < EPD / \vert L 1 R 1 \vert < 1 \qquad [ Mathematical Expression 35 ]$$

In Mathematical Expression 35, EPD means the size (mm) of the entrance pupil of the optical systems (1000, 2000), and L1R1 means the radius of curvature of the first surface (S1) of the first lens (101,201). If the optical systems (1000, 2000) according to the embodiments satisfy Mathematical Expression 35, the optical systems (1000, 2000) can control the incident light. In the first and second embodiments, the Mathematical Expression 35 may preferably satisfy the condition of 0.3<EPD/|L1R1|≤0.9.

$$Po 4 * Po 5 < 0 \qquad [ Mathematical Expression 36 ]$$

In Mathematical Expression 36, Po4 is the value of the refractive power of the fourth lens (104,204) and Po5 is the value of the refractive power of the fifth lens (105,205). In other words, the refractive powers of the fourth and fifth lenses (104,105) have opposite refractive powers, which can improve the aberration and effectively guide the light to the plastic lens. Under the condition of Po4*Po5>0, the improvement effect of chromatic aberration in the cemented lens is not significant.

$$15 < v 5 - v 4 < 30 \qquad [ Mathematical Expression 37 ]$$

In Mathematical Expression 37, v4 is the Abbe number of the fourth lens (104,204) and V5 is the Abbe number of the fifth lens (105,205). If Mathematical Expression 37 is satisfied, the difference between the Abbe numbers of the at least two lenses forming the cemented lens can be maintained above a certain value, and chromatic aberration can be improved. In the first and second embodiments, the Mathematical Expression 37 may preferably satisfy 20≤v5-v4≤28. If the cemented lens is less than the lower limit of Mathematical Expression 37, it may have little effect on improving the aberration characteristics of the optical system. Accordingly, an Abbe number difference between the object-side lens and the sensor-side lens in the cemented lens that is greater than 20 and less than or equal to 28 may improve the aberration characteristics.

$$0 < \vert F 1 \vert / F < 10 \qquad [ Mathematical Expression 38 ]$$

Mathematical Expression 38 is where F is the effective focal length of the optical system and F1 is the focal length of the first lens (101,201). If Mathematical Expression 38 is satisfied, the TTL applied to the vehicle optical system can be set. In the first embodiment, the Mathematical Expression 38 may preferably satisfy 1<|F1|/F<7, and in the second embodiment, the Mathematical Expression 38 may preferably satisfy 1<|F1|/F<8.

$$F\_LG1 / F\_LG2 < 0 \qquad [ Mathematical Expression 39 ]$$

In Mathematical Expression 39, F_LG1 is the focal length of the first lens group (LG1) and F_LG2 is the focal length of the second lens group (F_LG2). The focal length of the first lens group may have a negative value and the focal length of the second lens group may have a positive value. If Mathematical Expression 39 is satisfied, the optical systems (1000, 2000) may improve aberration characteristics such as chromatic aberration and distortion aberration. Mathematical Expression 39 may preferably satisfy 5<|F_LG1/F_LG2|<8 in a first embodiment, and may preferably satisfy 5<|F_LG1/F_LG2|<9 in a second embodiment.

$$1 < n G L / n P L < 2 \qquad [ Mathematical Expression 40 ]$$

In Mathematical Expression 40, nGL is the number (sheets) of glass material lenses and nPL is the number of plastic material lenses. By arranging the number of glass lenses in Mathematical Expression 40 to be more than one and less than two times the number of plastic lenses, the thickness of the optical system can be reduced and the aspherical surface can provide more variable refractive power. In the first and second embodiments, the Mathematical Expression 40 may preferably satisfy 1<nGL/nPL<1.5.

$$CA\_L7 \leq CA\_L1 < CA\_L3 \qquad [ Mathematical Expression 41 ]$$

In Mathematical Expression 41, CA_L1 is the average effective diameter of the object side surface and the sensor side surface of the first lens (101,201), CA_L3 is the average effective diameter of the object side surface and the sensor side surface of the third lens (103,203), and CA_L7 is the average effective diameter of the object side surface and the sensor side surface of the seventh lens (107,207). If Mathematical Expression 41 is satisfied, the first and second lens groups can be set, and the aberration can be improved by the first lens of the second lens group (LG2). CA_L3 can have the maximum effective diameter in the optical system.

$$0 < \sum PL\_CT / \sum L\_CT < 2 \qquad [ Mathematical Expression 42 ]$$

In Mathematical Expression 42, ΣPL_CT is the sum of the center thicknesses of the plastic lens(es) and ΣGL_CT is the sum of the center thicknesses of the glass lenses. If Mathematical Expression 42 is satisfied, the overall TTL can be controlled by establishing a relationship between the thickness of the plastic lens(es) and the thickness of the glass lens(es) with respect to the TTL. Mathematical Expression 42 may preferably satisfy 0.3<ΣPL_CT/ΣGL_CT<0.8 in a first embodiment, and may preferably satisfy 1<ΣPL_CT/ΣGL_CT<1.5 in a second embodiment.

$$0 < \sum PL\_Index \sum GL\_Index < 2 \qquad [ Mathematical Expression 43 ]$$

In Mathematical Expression 43, ΣPL_Index is the sum of the refractive index thicknesses at the d-line of the plastic lens(es), and ΣGL_Index is the sum of the refractive indices at the d-line of the glass lenses. If Mathematical Expression 43 is satisfied, the relationship between the refractive indices of the plastic and glass lenses can be set to control the overall resolution power. In the first embodiment, Mathematical Expression 43 may preferably satisfy 0.5<ΣPL_Index/ΣGL_Index<1, and in the second embodiment, Mathematical Expression 43 may preferably satisfy 1<ΣPL_Index/ΣGL_Index<1.5.

$$10 < T T L < 44 \qquad [ Mathematical Expression 44 ]$$

In Mathematical Expression 44, TTL (total track length) means the distance (mm) along the optical axis (OA) from the center of the first surface (S1) of the first lens (101,201) to the top surface of the image sensor (300). By making the TTL in Mathematical Expression 44 greater than 10 or greater than 20, an automotive optical system can be provided. In the first and second embodiments, the Mathematical Expression 44 may preferably satisfy the condition of 30<TTL≤40 or TD<TTL.

$$2 < ImgH < 10 \qquad [ Mathematical Expression 45 ]$$

Mathematical Expression 45 may set a diagonal size (2*ImgH) of the image sensor 300, and may provide an optical system having an automotive sensor size. In the first and second embodiments, the Mathematical Expression 45 may preferably satisfy 4≤ImgH<6.

$$1 < B F L < 3.5 \qquad [ Mathematical Expression 46 ]$$

In Mathematical Expression 46, BFL is the optical axis distance from the image sensor (300) to the center of the sensor side surface of the last lens. Satisfying Mathematical Expression 46 allows for a set space for the filter (500) and cover glass (400), and the spacing between the image sensor (300) and the last lens allows for improved assembly of the components and improved coupling reliability. In the first and second embodiments, the Mathematical Expression 46 may preferably satisfy 1.5≤BFL≤3. If the BFL is less than the range of Mathematical Expression 46, some of the light proceeding to the image sensor may not be transmitted to the image sensor, which may cause resolution degradation. If the BFL exceeds the range in Mathematical Expression 46, noise light may be introduced, which may degrade the aberration characteristics of the optical system.

$$3 < F < 40 \qquad [ Mathematical Expression 47 ]$$

Mathematical Expression 47 may set the total focal length F to match the automotive optical system. In the first and second embodiments, Mathematical Expression 47 may satisfy 5<F<20.

$$F O V < 45 \qquad [ Mathematical Expression 48 ]$$

In Mathematical Expression 48, the field of view (FOV) refers to the field of view in degrees of the optical systems (1000,2000), which can provide an automotive optical system with a field of view of less than 45 degrees. In the first and second embodiments, the FOV may preferably satisfy 20≤FOV≤40.

$$1 < T T L / CA\_max < 5 \qquad [ Mathematical Expression 49 ]$$

In Mathematical Expression 49, CA_max means the largest effective diameter (mm) of the object side surface and sensor side surface of the plurality of lenses, and TTL (total track length) means the distance (mm) on the optical axis (OA) from the apex of the first surface (S1) of the first lens to the top surface of the image sensor (300). Mathematical Expression 49 establishes a relationship between the total optical axis length of the optical system and the maximum effective diameter, which may provide an improved automotive optical system. In a first embodiment, the Mathematical Expression 49 may preferably satisfy 1.5<TTL/CA_max≤3, and in a second embodiment, the Mathematical Expression 49 may preferably satisfy 2<TTL/CA_max≤3.

$$2 < T T L / ImgH < 10 \qquad [ Mathematical Expression 50 ]$$

Mathematical Expression 50 defines TTL (Total track length) as the distance (mm) on the optical axis (OA) from the apex of the first surface (S1) of the first lens to the top surface of the image sensor (300), where ImgH is ½ the diagonal size of the image sensor (300). If Mathematical Expression 50 is satisfied, the optical systems (1000, 2000) may have a TTL for application of the automotive image sensor (300), which may provide improved image quality. In a first embodiment, the Mathematical Expression 50 may preferably satisfy 4<TTL/ImgH<10, and in a second embodiment, the Mathematical Expression 50 may preferably satisfy 5<TTL/ImgH<10.

$$0.1 < B F L / ImgH < 1 \qquad [ Mathematical Expression 51 ]$$

Mathematical Expression 50 defines BFL as the optical axis distance from the image sensor (300) to the center of the sensor side surface of the last lens, and ImgH as ½ of the diagonal size of the image sensor (300). If Mathematical Expression 51 is satisfied, the optical systems (1000, 2000) can obtain a back focal length (BFL) for sizing the image sensor (300) for the vehicle, can set a spacing between the last lens and the image sensor (300), and can have good optical properties in the center and periphery of the field of view (FOV). In the first and second embodiments, the Mathematical Expression 51 may preferably satisfy 0.2<BFL/ImgH<0.8.

$$5 < T T L / B F L < 20 \qquad [ Mathematical Expression 52 ]$$

Mathematical Expression 52 defines TTL (total track length) as the distance in mm along the optical axis (OA) from the apex of the first surface (S1) of the first lens to the top surface of the image sensor (300), and BFL as the optical axis distance from the image sensor (300) to the center of the sensor side surface of the last lens. If Mathematical Expression 52 is satisfied, the optical systems (1000, 2000) can obtain the BFL. In the first and second embodiments, the Mathematical Expression 52 may preferably satisfy 10<TTL/BFL<15.

$$1 < T T L / F < 3 \qquad [ Mathematical Expression 53 ]$$

Mathematical Expression 53 shows that TTL (Total track length) is the distance (mm) on the optical axis (OA) from the apex of the first surface (S1) of the first lens to the upper surface of the image sensor (300), and F is the effective focal length of the optical system. Accordingly, an optical system for a driver assistance system can be provided. In the first and second embodiments, the Mathematical Expression 53 may preferably satisfy 1.5≤TTL/F≤2.5 or 2≤TTL/F≤2.5. When the optical systems (1000, 2000) according to the embodiments satisfies the Mathematical Expression 53, the optical systems (1000, 2000) provides an optical system that can have an appropriate focal length in the set TTL range and can be image-formed while maintaining an appropriate focal length as the temperature changes from low to high. Below the lower limit of Mathematical Expression 53, the refractive power of the lenses may need to be increased, making it difficult to correct spherical or distortion aberrations, and above the upper limit of Mathematical Expression 53, the lenses may have a longer effective diameter or TTL, resulting in an oversized acquisition lens system.

$$3 < F / B F L < 10 \qquad [ Mathematical Expression 54 ]$$

Mathematical Expression 54 shows that F is the effective focal length of the optical system and BFL is the optical axis distance from the image sensor (300) to the center of the sensor side surface of the last lens. If Mathematical Expression 54 is satisfied, the optical system (1000, 2000) may have a set field of view and an appropriate focal length, and a vehicle optical system may be provided. Furthermore, the optical systems (1000, 2000) may minimize the gap (spacing) between the last lens and the image sensor (300), and thus may have good optical properties at the periphery of the field of view (FOV). In the first and second embodiments, the Mathematical Expression 54 may preferably satisfy 3<F/BFL<6.

$$1 < F / ImgH < 5 \qquad [ Mathematical Expression 55 ]$$

Mathematical Expression 55 indicates that F is the effective focal length of the optical system and ImgH is ½ the diagonal size of the image sensor (300). Such optical systems (1000, 2000) may have improved aberration characteristics at the size of the automotive image sensor (300). In the first and second embodiments, the Mathematical Expression 55 may preferably satisfy 2<F/ImgH<4.

$$1 < F / EPD < 5 \qquad [ Mathematical Expression 56 ]$$

Mathematical Expression 56 shows that F is the effective focal length of the optical system and EPD is the incident pupil size. Thus, the overall brightness of the optical system can be controlled. Mathematical Expression 56 can preferably be set such that 1<F/EPD<2.

$$0 < B F L / TD < 0.3 \qquad [ Mathematical Expression 57 ]$$

Mathematical Expression 57 shows that TD is the optical axis distance of the lenses of the optical systems (1000, 2000) and BFL is the optical axis distance from the image sensor (300) to the center of the sensor side surface of the last lens. Thus, the overall size of the optical system can be controlled while maintaining the resolution of the optical system. In the first and second embodiments, the Mathematical Expression 57 may preferably satisfy 0<BFL/TD<0.1. If the condition value of BFL/TD is greater than or equal to 0.1, the BFL is designed to be large relative to TD, resulting in a large size of the overall optical system, which makes it difficult to miniaturize the optical system, and the distance between the seventh lens (107,207) and the image sensor is increased, which may increase the amount of unnecessary light through the seventh lens (107,207) and the image sensor, which may result in a decrease in aberration characteristics, and thus lower resolution power.

$$0 < EPD / Imgh / F O V < 0.2 \qquad [ Mathematical Expression 58 ]$$

Mathematical Expression 58 can establish a relationship between the size of the entrance pupil (EPD), the length of ½ of the maximum diagonal length of the image sensor (Imgh), and the field of view. Accordingly, the overall size and brightness of the optical system can be controlled. The Mathematical Expression 58 may preferably satisfy 0<EPD/Imgh/FOV<0.1.

$$5 < F O V / F \# < 30 \qquad [ Mathematical Expression 59 ]$$

Mathematical Expression 59 may establish a relationship between the field of view of the optical system and the F number (F #). Mathematical Expression 59 may preferably satisfy 10<FOV/F #<25. Here, F #can be provided to be 1.6 or less to provide a bright image.

$$10 < \vert F 2 / F 5 \vert < 220 \qquad [ Mathematical Expression 60 ]$$

Mathematical Expression 60 shows that F2 is the focal length of the second lens (102,202) and F5 is the focal length of the fifth lens (105,205). Mathematical Expression 60 may establish a relationship between the focal lengths of the second lens (102,202) and the fifth lens (105,205). In the optical systems (1000, 2000), the absolute value of the focal length of the second lens (102,202), which is plastic, is formed to be the largest, and the absolute value of the focal length of the fifth lens (105,205), which is glass, is formed to be the smallest, to increase the incidence efficiency, and to adjust the refractive force between the glass and plastic lenses to guide them to the image sensor (300). In the first embodiment, the Mathematical Expression 60 may preferably satisfy 210<F2/F5|<215, and in the second embodiment, the Mathematical Expression 60 may preferably satisfy 10<|F2/F5|<15.

$$5 < \vert F 2 / F 3 \vert < 110 \qquad [ Mathematical Expression 61 ]$$

In Mathematical Expression 61, F2 is the focal length of the second lens (102,202) and F3 is the focal length of the third lens (103,203). In the optical systems (1000, 2000), the absolute value of the focal length of the second lens (102,202), which is made of plastic, is formed to be the largest, and the absolute value of the focal length of the third lens (103,203), which is made of glass, is formed to be the smallest in the optical systems (1000, 2000), in addition to the cemented lens (145), to increase the incidence efficiency and to adjust the refractive force between the glass and plastic lenses to guide them to the image sensor (300). In the first embodiment, the Mathematical Expression 61 may preferably satisfy 102<|F2/F3|<108, and in the second embodiment, the Mathematical Expression 61 may preferably satisfy 5<F2/F3|<8.

$$0.05 < \vert Sag\_i / ( CA\_i / 2 ) \vert < 0.2 ( i = S 1 , S 2 , S 3 , S 4 ) \qquad [ Mathematical Expression 62 ]$$

Mathematical Expression 62 may establish a relationship between the Sag values of the first to fourth surfaces (S1,S2,S3,S4) of the first and second lenses (101,102) and the effective diameter (CA), which, if satisfied, may improve the refractive power of the lenses. Here, Mathematical Expression 62 further satisfies the condition of n1>1.7, so that the first and second lenses (101,102) can collect light with sufficient power without designing the radius of curvature of the first and second lenses 101,102 within the effective diameter to be sharp.

$$z = \frac{{cY}^{2}}{1 + \sqrt{1 - ( i + K ) {c}^{2} {Y}^{2}}} + {AY}^{4} + {BY}^{5} + {CY}^{4} + {DY}^{5} + {EY}^{4} + … \qquad [ Mathematical Expression 63 ]$$

In Mathematical Expression 63, Z is Sag, which can mean the distance in the direction of the optical axis from any location on the aspheric surface to the apex of the aspheric surface. Y may mean the distance in the direction perpendicular to the optical axis from any position on the aspheric surface to the optical axis. c may mean the curvature of the lens, and K may mean the Kohnig constant. Further, A, B, C, D, E, F may mean an aspheric constant.

The optical systems (1000, 2000) according to embodiments may satisfy at least one or more of the Mathematical Expressions from Mathematical Expression 1 to Mathematical Expression 63. In this case, the optical systems (1000, 2000) may have improved optical properties. More specifically, when the optical systems (1000, 2000) satisfy at least one or more of the Mathematical Expressions from Mathematical Expression 1 to Mathematical Expression 63, the optical systems (1000, 2000) may have improved resolution, and may have improved aberration and distortion characteristics. Furthermore, the optical systems (1000, 2000) can have a back focal length (BFL) for applying the automotive image sensor (300), can compensate for degradation of optical properties due to temperature changes, and can minimize the gap between the last lens and the image sensor (300) to have good optical performance in the center and periphery of the field of view (FOV).

Table 3 shows the entries of the above-mentioned Mathematical Expressions in the optical system (1000,2000) of the first and second exemplary embodiments, which relate to the total track length (TTL) (mm), back focal length (BFL), effective focal length (F) (mm), ImgH (mm), effective diameter (CA) (mm), thickness (mm), TTL (mm), and TD (mm), which is the optical axis distance from the first surface (S1) to the 14th surface (S14), of the optical system (1000,2000), focal length (F1,F2,F3,F4,F5,F6,F7) (mm) of each of the first to seventh lens elements (F1,F2,F3,F4,F5,F6,F7) (mm), sum of refractive indices, sum of Abbe numbers, sum of thicknesses (mm), sum of gaps between adjacent lenses, effective diameter characteristics, sum of refractive indices of glass lenses, sum of refractive indices of plastic materials, field of view (FOV) (Degree), edge thickness (ET), focal lengths of the first and second lens elements, F number, etc.

TABLE 3

| | first | second |
|---|---|---|
| | exemplary | exemplary |
| items | embodiment | embodiment |
| F | 15.1 | 15.1 |
| F1 | −93.0567 | −110.347 |
| F2 | −1975.0800 | 132.907 |
| F3 | 18.5943 | 21.041 |
| F4 | 14.7844 | 15.609 |
| F5 | −9.2437 | −8.946 |
| F6 | 33.3444 | 30.140 |
| F7 | −30.3679 | −39.267 |
| F_LG1 | −93.0567 | −110.347 |
| F_LG2 | 12.5636 | 12.507 |
| ΣIndex | 11.6913 | 11.4988 |
| ΣAbbe | 321.3207 | 302.4300 |
| ΣCT | 21.591 | 22.620 |
| ΣCG | 7.854 | 7.824 |
| CA_max | 12.832 | 13.399 |
| CA_min | 8.653 | 8.342 |
| CA_Aver | 10.819 | 10.731 |
| CT_max | 4.191 | 4.296 |
| CT_min | 2.000 | 2.000 |
| ET1 | 2.1875 | 4.0834 |
| ET2 | 3.1160 | 2.8882 |
| ET3 | 1.9979 | 2.0201 |
| ET4 | 1.9979 | 2.0915 |
| ET5 | 4.2773 | 3.7172 |
| ET6 | 2.2540 | 2.0223 |
| ET7 | 3.3068 | 2.9040 |
| F-number | 1.600 | 1.600 |
| FOV | 34.0396 | 34.0400 |
| EPD | 9.4375 | 9.4375 |
| BFL | 2.8694 | 2.8464 |
| TD | 29.1757 | 30.4439 |
| ImgH | 4.630 | 4.630 |
| SD | 20.7730 | 20.7301 |
| TTL | 32.0451 | 33.2904 |
| GLca_Aver | 11.922 | 12.03059 |
| PLca_Aver | 9.347 | 9.756 |
| Image sensor | 3840*2160 | 3840*2160 |
| CT_Aver | 3.084 | 3.231 |

Table 4 shows the resultant values for Mathematical Expression 1 to Mathematical Expression 64 described above for the optical systems (1000, 2000) of the first and second embodiments. Referring to Table 4, it can be seen that the optical systems (1000, 2000) satisfy at least one, at least two, or at least three of Mathematical Expressions 1 to 64. More specifically, it can be seen that the optical systems (1000, 2000) according to an embodiment satisfy all the Mathematical Expression 1 to Mathematical Expression 64. Accordingly, the optical systems (1000, 2000) may have good optical performance in the center and periphery of the field of view (FOV) and may have excellent optical properties.

TABLE 4

| | | first | second |
|---|---|---|---|
| | | exemplary | exemplary |
| | | embodi- | embodi- |
| Mathematical Expression | | ment | ment |
| 1 | 0.5 < CT1/ET1 < 1.5 | 0.914 | 1.0035 |
| 2 | 0.1 < CT1/CA_L1S1 < 0.5 | 0.160 | 0.3178 |
| 3 | Pol < 0 | −0.0107 | −0.0091 |
| 4 | 1.6 < n1 < 2.2 | 1.8564 | 1.6640 |
| 5 | 27 < FOV_H < 33 | 29.92 | 29.96 |
| 6 | L3R1 > 0, L3S2 < 0 | satisfactory | satisfactory |
| 7 | 1 < L7S2_max_sag | 2.69886 | 2.7 |
| | to Sensor < 3 | | |
| 8 | 1 < CT1/CT7 < 3 | 0.7088 | 1.6126 |
| 9 | 1 < CT45/CT6 < 5 | 2.0919 | 2.1526 |
| 10 | 0.2 < (CT45-ET45) < 0.5 | 0.4055 | 0.4877 |
| 11 | 0 < CA_L1S1/CA_L4S1 < 2 | 0.9635 | 0.9842 |
| 12 | 0 < CA_L7S2/CA_L5S2 < 2 | 0.9522 | 0.9948 |
| 13 | 0 < CA_L1S2/CA_L2S1 < 2 | 1.0704 | 1.0356 |
| 14 | 0.5 < CA_L4S1/CA_L5S2 < 2.5 | 1.3582 | 1.4233 |
| 15 | 2 < L3R1/(CA_L3S1/2) < 5 | 4.0638 | 3.6730 |
| 16 | 1 < CA_GL_AVER/ | 1.275 | 1.233 |
| | CA_PL_AVER < 1.5 | | |
| 17 | 1.2 < GL_CA1_AVER/ | 1.318 | 1.252 |
| | PL_CA1_AVER < 1.5 | | |
| 18 | CG3 < CG5 < CG1 | satisfactory | satisfactory |
| 19 | 1 < CT7/CG6 < 3 | 1.4821 | 1.878 |
| 20 | 1 < CT2/CT1 < 2 (first | 1.5 | 1.365 |
| | exemplary embodiment)1 < | | |
| | CT1/CT2 < 2 (second | | |
| | exemplary embodiment) | | |
| 21 | 1 < L7R1/CT7 < 20 | 15.175 | 11.45055527 |
| 22 | 0 < CT_Max/CG_Max < 3 | 1.231 | 2.148 |
| 23 | 2 < ΣCT/ΣCG < 3 | 2.8432 | 2.8911 |
| 24 | 10 < ΣIndex < 20 | 11.6913 | 11.4988 |
| 25 | 10 < ΣAbb/ΣIndex < 35 | 27.4838 | 26.3028 |
| 26 | 1 < ΣCT/ΣET < 2 | 1.1282 | 1.147 |
| 27 | 0.5 < CA_L3S1/CA_min < 5 | 1.5274 | 2.8878 |
| 28 | 1 < CA_max/CA_min < 3 | 1.5848 | 1.6062 |
| 29 | 1 < CA_max/CA_Aver < 3 | 1.208 | 1.2486 |
| 30 | 0.5 < CA_min/CA_Aver < 2 | 0.762 | 0.7773 |
| 31 | 1 < CA_max/(2*ImgH) < 3 | 1.411 | 1.4469 |
| 32 | 1 < TD/CA_max < 4 | 2.232 | 2.2721 |
| 33 | 0 < F/L1R1 < 1 | 0.615 | 0.6036 |
| 34 | 1 < Max_th/Min_th < 3 | 2.141 | 2.1482 |
| 35 | 0 < EPD/\|L1R1\| < 1 | 0.3845 | 0.3772 |
| 36 | Po4 * Po5 < 0 | satisfactory | satisfactory |
| 37 | 15 < V4-V5 < 30 | 25.7237 | 25.7237 |
| 38 | 0 < \|F1\|/F < 10 | 6.1626 | 7.3077 |
| 39 | F_LG1/F_LG2 < 0 | −7.406 | −8.822 |
| 40 | 1 < nPL/nGL < 2 | 1.333 | 1.333 |
| 41 | CA_L7 < CA_L1 < CA_L3 | satisfactory | satisfactory |
| 42 | 0 < ΣPL_CT/ΣGL_CT < 2 | 0.577 | 1.249 |
| 43 | 0 < ΣPL_Index/ΣGL_Index < 2 | 0.949 | 1.2561 |
| 44 | 10 < TTL < 45 | 32.0451 | 33.2904 |
| 45 | 2 < ImgH < 10 | 4.630 | 4.630 |
| 46 | 1 < BFL < 3.5 | 2.8694 | 2.8464 |
| 47 | 3 < F < 40 | 15.100 | 15.100 |
| 48 | FOV < 45 | 34.01 | 34.040 |
| 49 | 1 < TTL/CA_max < 5 | 2.4520 | 2.484 |
| 50 | 2 < TTL/ImgH < 10 | 6.9211 | 7.190 |
| 51 | 0.1 < BFL/ImgH < 1 | 0.6197 | 0.615 |
| 52 | 5 < TTL/BFL < 20 | 11.1679 | 11.696 |
| 53 | 1 < TTL/F < 3 | 2.1221 | 2.205 |
| 54 | 3 < F/BFL < 10 | 5.2624 | 5.305 |
| 55 | 1 < F/ImgH < 5 | 3.261 | 3.261 |
| 56 | 1 < F/EPD < 5 | 1.600 | 1.600 |
| 57 | 0 < BFL/TD < 0.3 | 0.0983 | 0.093 |
| 58 | 0 < EPD/Imgh/FOV < 0.2 | 0.0598 | 0.060 |
| 59 | 5 < FOV/F# < 30 | 21.2747 | 21.275 |
| 60 | 10 < \|F2/F5\| < 220 | 213.668 | 14.855 |
| 61 | 5 < \|F2/F3\| < 110 | 106.220 | 6.316 |
| 62 | 0.05 < \|Sag_i/(CA_i/2)\| < | satisfactory | satisfactory |
| | 0.2 (i = S1, S2, S3, S4) | | |

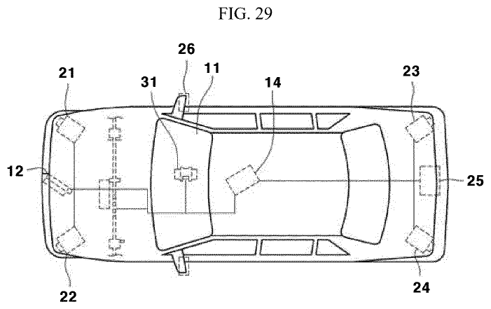

FIG. 29 is an example of a top view of a vehicle with a camera module or optical system according to an exemplary embodiment of the invention. Referring to FIG. 29, a vehicle camera system according to an embodiment of the invention includes an image generating part (11), a first information generating part 12, second information generating parts (21,22,23,24,25,26), and a control part (14). The image generating part (11) may include at least one camera module (31) disposed on the vehicle, which may photograph the front of the vehicle and/or the driver to generate an image of the front of the vehicle or an image of the interior of the vehicle. The image generating part (11) may use the camera module (31) to generate an image of the surroundings of the vehicle in one or more directions as well as the front of the vehicle to generate an image of the surroundings of the vehicle. Here, the front image and the peripheral image may be digital images, and may include color images, black and white images, infrared images, and the like. Further, the front image and the peripheral image may include still images and videos. The image generating part (11) may provide the driver image, the front image, and the peripheral image to the control part (14). Next, the first information generating part (12) may include at least one radar and/or camera disposed on the vehicle, which detects the front of the vehicle and generates the first detection information. Specifically, the first information generating part (12) is may be disposed on the vehicle and generates the first detection information by detecting the position and speed of vehicles located in front of the vehicle, the presence and location of pedestrians, and the like.

The first detection information generated by the first information generating part 12 can be used to control the vehicle to maintain a constant distance between the vehicle and the vehicle in front of it, and to increase the stability of the vehicle operation in certain preset cases, such as when the driver wishes to change the driving lane of the vehicle or when parking in reverse. The first information generating part (12) may provide the first detection information to the control part (14). The second information generating parts (21,22,23,24,25,26) may detect each side of the vehicle and generate the second detection information based on the front image generated by the image generating part (11) and the first detection information generated by the first information generating part (12). Specifically, the second information generating parts (21, 22, 23, 24, 25, 26) may include at least one radar and/or camera disposed on the vehicle, and may detect or image the position and speed of vehicles located on the sides of the vehicle. Here, the second information generating parts (21,22,23,24,25,26) may be disposed at each of the front two corners, the side mirrors, and the rear center and rear two corners of the vehicle.

The information generating part of at least one of these automotive camera systems may comprise a camera module with the optical system described in the embodiments disclosed above, and may use the information acquired through the front, rear, each side or corner areas of the vehicle to provide or process information to the user to protect the vehicle and objects from automated driving or peripheral safety.

The optical system of the camera module according to exemplary embodiments of the present invention may be mounted in a plurality in a vehicle for safety regulations, enhancement of autonomous driving functions, and increased convenience. In addition, the optical system of the camera module is applied in the vehicle as a component for controls such as lane keeping assistance system (LKAS), lane departure warning system (LDWS), and driver monitoring system (DMS). These automotive camera modules are capable of stable optical performance even when the ambient temperature changes, and are competitively priced to ensure the reliability of automotive components.

Although exemplary embodiments of the present invention have been described above with reference to the accompanying drawings, it will be appreciated by those having ordinary skill in the technical field to which the invention belongs that the invention may be embodied in other specific forms without altering its technical ideas or essential features. It should therefore be understood that the embodiments described above are exemplary in all respects and are not intended to be limiting.

1. An optical system, comprising:
a first to a seventh lens arranged along an optical axis,
wherein the first lens has a negative (−) refractive power,
wherein a composite refractive power of the second to seventh lenses is a positive (+) power,
wherein among effective diameters of the first to third lenses, the second lens has the smallest effective diameter,
wherein effective diameters of the sixth and seventh lenses are smaller than an effective diameter of the fifth lens, and
wherein, among the first lens to the seventh lens, the third lens has the largest effective diameter.

2. The optical system of claim 1, wherein the second lens, the sixth lens, and the seventh lens are made of plastic, and at least one of the first lens and the third lens to the fifth lens is made of glass.

3. The optical system of claim 1, wherein, in the optical axis, the fifth lens has a smallest thickness among the first to seventh lenses, and
wherein, in the optical axis, the fourth lens has a largest thickness among the first to seventh lenses.

4. The optical system of claim 1, wherein the second lens has a meniscus shape that is convex towards a sensor.

5. The optical system of claim 1, wherein the lens having a smallest absolute value of focal length among the first lens to the seventh lens is one of the third lens to the fifth lens.

6. The optical system of claim 5, wherein the absolute value of focal lengths of the third lens to the fifth lens satisfies the following Conditional Expression:
$$\vert F 3 \vert \geq \vert F 4 \vert \geq \vert F 5 \vert \qquad < Conditional Expression >$$
(In the above Conditional Expression, F3 is the focal length of the third lens, F4 is the focal length of the fourth lens, and F5 is the focal length of the fifth lens).

7. An optical system, comprising:
a first lens to a seventh lens disposed along an optical axis,
wherein the first lens has a negative (−) refractive power,
wherein a composite refractive power of the second lens to the seventh lens is a positive (+) refractive power,
wherein among the first lens to the seventh lens, an absolute value of focal length of the fifth lens is the smallest and an absolute value of focal length of the second lens is the largest, and
wherein, among the first lens to the seventh lens, the third lens has a largest effective diameter.

8. The optical system of claim 7, wherein the first lens is made of glass, and the sixth lens and the seventh lens are made of plastic.

9. The optical system of claim 7, comprising: a cemented lens in which a lens having a positive (+) refractive power and a lens having a negative (−) refractive power are cemented, wherein at least one of the remaining lenses is disposed on an object side of the cemented lens and disposed closest to the cemented lens, and another remaining lens is disposed closest to the cemented lens on a sensor side of the cemented lens and has a convex shape on both sides.

10. The optical system of claim 9, wherein an absolute value of radius of curvature of a sensor side surface of the cemented lens is less than an absolute value of radius of curvature of an object side surface of the cemented lens.

11. The optical system of claim 9, wherein the object side of the cemented lens has a convex shape and the sensor side of the cemented lens has a concave shape.

12. The optical system of claim 9, wherein the cemented lens comprises two lenses continuously arranged back-to-back of the third lens to the fifth lens.

13. An Optical system comprising:
a first to a seventh lens disposed along an optical axis,
wherein, among the first to seventh lenses, an absolute value of focal length of the second lens is the largest and an absolute value of focal length of the fifth lens is the smallest, and
wherein a ratio of the absolute values of the focal lengths of the second lens and the fifth lens is greater than 210 times and less than 220 times.

14. The optical system of claim 13, wherein a ratio of the absolute values of focal lengths of the second lens and the third lens is greater than 100 times and less than 110 times.

15. The optical system of claim 14, wherein the absolute value of focal lengths of the third lens to the fifth lens satisfies the following Conditional Expression:
$$\vert F 3 \vert \geq \vert F 4 \vert \geq \vert F 5 \vert \qquad < Conditional Expression >$$
(In the above Conditional Expression, F3 is the focal length of the third lens, F4 is the focal length of the fourth lens, and F5 is the focal length of the fifth lens).

16. The optical system of claim 13, wherein in the optical axis, the first lens has a smallest thickness among the first to seventh lenses, and
wherein in the optical axis, one of the third to fifth lenses has a largest thickness among the first to seventh lenses.

17. The optical system of claim 13, wherein a thickness of the second lens in the optical axis is smaller than thicknesses of the third lens and the fourth lens.

18. The optical system of claim 13, wherein among the first to seventh lenses, an absolute value of radius of curvature of a sensor side of the sixth lens is the largest, and an absolute value of radius of curvature of a sensor side of the fifth lens is the smallest.

19. The optical system of claim 13, wherein the third lens has a convex shape on both sides.

20. The optical system of claim 13, wherein the first lens, the second lens, the fifth lens, and the seventh lens have a negative (−) refractive power, and the third lens, the fourth lens, and the sixth lens have a positive (+) refractive power.
